(19) United States
(12) Patent Application Publication
(10) Pub. No.: US 2026/0307777 A1
(43) Pub. Date: Oct. 8, 2026

(54) PERFORMANCE OF AIRFOILS AND HYDROFOILS

(71) Applicant: SJK Energy Solutions, LLC, Ashton, MD (US)

(72) Inventors: Steven J. Kanstoroom, Ashton, MD (US); Maximilian de Arriz, Chestertown, MD (US); Joseph M. Galliera, III, Stamford, VT (US)

(73) Assignee: SJK Energy Solutions, LLC, Ashton, MD (US)

(21) Appl. No.: 19/642,376

(22) Filed: Apr. 8, 2026

Related U.S. Application Data
(60) Provisional application No. 63/785,068, filed on Apr. 8, 2025.

(51) Int. Cl. B64C 3/14; B63H 5/07; F03B 3/12; F03D 1/06; F04D 29/38

(52) U.S. Cl. CPC B64C 3/14; B63H 5/07; F03B 3/121; F03D 1/06495; F04D 29/384

(57) ABSTRACT

A flow transitioner configured so as to define a pressure surface and a suction surface when exposed to relative fluid flow is positioned and oriented with respect to an associated wing, stabilizer, blade or other foil so as to affect fluid flow impacting such foil irrespective of the foil's orientation to the fluid flow or, with respect to a rotor blade, propellor, or other rotating foil, irrespective of the longitudinal axis (axis of rotation) or direction of rotation of the rotating foil, to alter the lift-to-drag ratio of the foil. Embodiments include flow transitioners of variable angle, curvature, thickness, length, and/or leading edge nose circle diameter.

### CROSS REFERENCE TO RELATED APPLICATION

This application claims the benefit under 35 U.S.C. § 119(e) of the filing date of U.S. provisional patent application Ser. No. 63/785,068 filed Apr. 8, 2025, the disclosure of which is incorporated herein by reference.

### FIELD OF DISCLOSURE

This disclosure relates to improvements in the performance of airfoils and hydrofoils for aircraft, watercraft, blades including, without limitation, propellor blades and turbine blades by the addition of a flow transitioner forward of the leading edge of the airfoil or hydrofoil. In particular, it relates to any airfoil, hydrofoil or airfoil-like structure (generally, a “foil”) where it is advantageous to reduce the drag and related noise, and/or increase the lift-to-drag ratio of the foil or structure to which the flow transitioner is coupled.

This disclosure relates to wing, turbine blade, propellor blade and other foils including one or more flow transitioners, which may be arranged as a single or multi-component transitioner assembly, either fixedly linked or operably (adjustably) coupled to an associated foil, positioned with respect to a leading edge of the foil to transition fluid flow over the foil, and configured to improve the lift-to-drag ratio of the foil and/or alter the fluid flow and resulting pressure distributions adjacent to the surfaces of the foil. The transitioner may have a fixed or variable angle of attack. Its pressure and suction surfaces may be fixed or adjustable. A flow transitioner may be added to an existing foil or integrated into the construction of new foils. Each transitioner is arranged with its leading edge forward of the leading edge of an existing foil to which it is attached, and with respect to new construction, would comprise the leading edge of the foil of which it is embodied. A transitioner may span the entire length of the associated foil, or any portion thereof and be constructed as a single component or comprised of multiple sections that when assembled function and appear as a single component.

### BACKGROUND

A foil with a greater lift-to-drag ratio is beneficial because it has a higher aerodynamic efficiency, or with respect to watercraft, higher hydrodynamic efficiency, meaning an aircraft (or any object propelled through a fluid) can produce more lift with less drag. This results in reduced energy usage, longer range, increased carrying capacity, reduced fluid flow induced stress on surfaces and related structures, and with respect to fluid powered foils, increased energy output.

The most common leading-edge high-lift devices for large aircraft are moveable slats, and fixed slots, each invented more than 100 years ago, and Krueger flaps that were invented during WWII. These devices create high lift at high angles of attack during takeoff and landing conditions. They work by channeling high-energy air from under the wing to the upper surface and re-energizing the boundary layer to prevent stall. Kruger flaps also increase the wing camber. Slats are airfoil-shaped panels on the leading edge that extend to create an air gap (slot). They increase the maximum lift coefficient and allow for a higher stall angle. Slots are permanent passageways within the leading edge that allow air to flow from the high-pressure underside to the low-pressure upper surface. Krueger Flaps are panels that hinge out from under the leading edge, typically used on the inboard wing to increase camber and drag, often found on older or very large airliners and benefit from a large nose circle. These high lift devices cannot be used at cruise speed due to high drag, drastically reduced fuel efficiency, and structural limitations.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

Aspects of the disclosure may be embodied in a transitioner configured so as to define a pressure surface and a suction surface when exposed to relative fluid flow and which is positioned and oriented with respect to an associated wing, stabilizer, blade or other foil as to affect fluid flow impacting such foil irrespective of the foil's orientation to the fluid flow or, with respect to a rotor blade, propellor, or other rotating foil, irrespective of the longitudinal axis (axis of rotation) or direction of rotation of the rotating foil to alter the lift-to-drag ratio of the foil.

The transitioner may be embodied within an aircraft, watercraft, wind turbine blade, water turbine blade, or other airfoil, hydrofoil or foil.

According to other aspects, the transitioner may be embodied within a wing, stabilizer, turbine blade, propellor or other foil that may be part of an aircraft or watercraft.

According to other aspects, the transitioner may be located nearer the oncoming fluid flow than the wing, stabilizer, turbine blade, propellor or other foil to which it is attached.

According to other aspects, the transitioner may be embodied near the leading edge, of a wing, stabilizer, turbine blade, rotor blade, propellor blade or other foil to which it is attached.

According to other aspects, the transitioner may be configured to direct additional fluid flow over one of the suction surface and the pressure surface of the wing, stabilizer, turbine blade, propellor blade or other foil to which it is attached.

According to other aspects, the transitioner may be configured to span the entire wing, stabilizer, rotor blade, propellor, or other foil, including any respective part of the span.

According to other aspects, the transitioner may be configured to affect an entire airfoil or hydrofoil portion of an associated wing, stabilizer, rotor blade, propellor or other foil.

According to other aspects, the transitioner may be configured to affect a portion of the airfoil or hydrofoil portion of an associated wing, stabilizer, rotor blade, propellor or other foil.

According to other aspects, the transitioner may be fixedly linked to a wing, stabilizer, rotor blade, propellor or any other foil.

According to other aspects, the transitioner may be adjustably connected to a wing, stabilizer, rotor blade, propellor or other foil whereby the transitioner's angle of attack may be varied.

According to other aspects, the transitioner may include a leading edge and upper and lower trailing edges forming a trailing end between the upper and lower trailing edges. Depending on the curvature of the leading edge of the foil to which the transitioner is attached, the trailing end of the transitioner could be asymmetrical or symmetrical with respect to upper and lower surfaces of the transitioner. The transitioner leading edge geometry could be uniform or variable along the span of the transitioner, and the transitioner trailing end geometry could be uniform or variable along the span of the transitioner.

According to other aspects, the transitioner's thickness may be generally uniform along its spanwise length.

According to other aspects, the transitioner may have a varying thickness along its spanwise length.

According to other aspects, the transitioner may twist along its spanwise length.

According to other aspects, the transitioner may have a generally flat pressure surface.

According to other aspects, the transitioner may have a generally flat suction surface.

According to other aspects, the transitioner pressure surface may have at least a portion that is convex, at least one portion that is concave, or both convex and concave portions.

According to other aspects, the transitioner suction surface may have at least a portion that is convex, at least one portion that is concave, or both convex and concave portions.

According to other aspects, the transitioner geometry, including but not limited to, its chord length, angle of attack, leading edge curvature, thickness between the upper trailing edge and lower trailing edge, pressure and suction surface convexity, and thickness between the pressure and suction surfaces, may vary along its spanwise length.

According to other aspects, the transitioner leading edge may have a geometry that generally follows the leading edge of the respective wing, stabilizer, rotor blade, propellor or other foil in which it is embodied or to which it is fixedly or adjustably coupled.

According to other aspects, the transitioner leading edge has geometry that generally differs from the leading edge of the respective wing, stabilizer, rotor blade, propellor or other foil in which it is embodied or to which it is fixedly or adjustably coupled.

According to other aspects, the transitioner is positioned with its leading edge forward of the leading edge of the associated wing, turbine blade, propellor blade or other foil to which it is linked.

According to other aspects, the transitioner may be skewed whereby the transitioner chord length as a percentage of the chord length of the foil to which is linked varies nonlinearly along the foil span.

According to other aspects, a transitioner may be comprised of multiple sections that, when assembled, mirror a transitioner that is manufactured as a monolithic structure.

According to other aspects, a transitioner may be connected to wing or other foil by adhesives and/or mechanical fasteners.

According to other aspects, a transitioner may have a fixed angle of attack.

According to other aspects, a transitioner may have a variable angle of attack.

According to other aspects, a transitioner with a variable angle of attack may have a pivot point that is generally near the center of the leading edge of the foil to which it is attached.

According to other aspects, the transitioner may be sealed whereby a transitioner-to-foil connection is airtight and watertight, and the connection prevents flow from passing between the transitioner and foil to which it is attached.

According to other aspects, a transitioner may share the heat within the foil to which it is attached.

According to other aspects, a transitioner may contain heating elements.

According to other aspects, a transitioner may have active suction and/or pressure surfaces that may change their curvature.

According to other aspects, a transitioner may have an active nose circle diameter whereby its diameter may change.

According to other aspects, a transitioner may have a computer to control aspects of its operable functions including its variable angle of attack, variable pressure and suction surfaces, variable chord length, independent pressure and suction surfaces, and variable diameter nose circle.

### EMBODIMENTS

Implementations of the disclosure can be described in view of the following embodiments, the features of which can be combined in any reasonable manner.

A1. A wing assembly comprising: a primary wing, wherein the primary wing has a primary suction surface, a primary pressure surface, a primary leading edge defined by a primary leading edge circle, a primary trailing edge, and a primary chord line extending from the primary leading edge to the primary trailing edge; and a flow transitioner positioned over the primary leading edge, wherein the flow transitioner comprises: a transitioner leading edge defined by a transitioner leading edge circle; a transitioner chord line extending from the transitioner leading edge to the primary leading edge, wherein the primary chord line and the transitioner chord line are oriented at different angles, such that the transitioner chord line has a lower angle of attack than the primary chord line; a transitioner suction surface extending from the transitioner leading edge to a suction surface trailing edge defining a transition at which the transitioner suction surface is attached to the primary suction surface; and a transitioner pressure surface extending from the transitioner leading edge to a pressure surface trailing edge defining a transition at which the transitioner pressure surface is attached to the primary pressure surface, wherein the transitioner leading edge is positioned forward of the primary leading edge, and wherein, at a particular spanwise position of the assembly: (1) a diameter of the transitioner leading edge circle is 1% to 70% of a diameter of the primary leading edge circle, or (2) the diameter of the transitioner leading edge circle is 5% to 55% of a maximum thickness between the primary suction surface and the primary pressure surface, or (3) a length of the transitioner chord line is 5% to 18% of a length of the primary chord line.

A2 The wing assembly of embodiment A1, wherein the particular spanwise position is a root of the assembly.

A3. The wing assembly of embodiment A1 or A2, wherein the flow transitioner has a trailing end extending between the suction surface trailing edge and the pressure surface trailing edge, wherein a curvature of the trailing end conforms to a curvature of the primary leading edge.

A4. The wing assembly of any one of embodiments A1 to A3, wherein the primary wing comprises one of an airfoil and a hydrofoil.

A5. The wing assembly of any one of embodiments A1 to A3, wherein the primary wing comprises one of a wing, a stabilizer, and a tail.

A6. The wing assembly of any one of embodiments A1 to A5, wherein an angle of the transitioner chord line with respect to the primary chord line is fixed, or the angle of the transitioner chord line with respect to the primary chord line is variable.

A7. The wing assembly of any one of embodiments A1 to A6, wherein the flow transitioner is configured to direct additional fluid flow over the primary suction surface or to direct additional fluid flow over the primary pressure surface compared to a primary wing without the flow transitioner.

A8. The wing assembly of any one of embodiments A1 to A7, wherein the flow transitioner comprises a transitioner skin attached to the primary suction surface aft of the primary leading edge and attached to the primary pressure surface aft of the primary leading edge.

A9. The wing assembly of embodiment A8, further comprising a seal to provide a water tight and air tight seal between the transitioner skin and the primary suction surface and between the transitioner skin and the primary pressure surface, wherein the seal comprises: an upper seal located between the transitioner skin and an upper wing rib flange and between a wing skin of the primary suction surface and the upper wing rib flange; an upper seal plate, wherein the upper seal is captured between the upper seal plate and the transitioner skin and the wing skin of the primary suction surface; a lower seal located between the transitioner skin and a lower wing rib flange and between a wing skin of the primary pressure surface and the lower wing rib flange; and a lower seal plate, wherein the lower seal is captured between the lower seal plate and the transitioner skin and the wing skin of the primary pressure surface.

B1. A flow transitioner configured to be coupled with a primary wing, wherein the primary wing has a primary suction surface, a primary pressure surface, a primary leading edge defined by a primary leading edge circle, a primary trailing edge, and a primary chord line extending from the primary leading edge to the primary trailing edge, wherein the flow transitioner comprises: a transitioner leading edge defined by a transitioner leading edge circle; a transitioner chord line extending from the transitioner leading edge to the primary leading edge, wherein the primary chord line and the transitioner chord line are oriented at different angles, such that the transitioner chord line has a lower angle of attack than the primary chord line; a transitioner suction surface extending from the transitioner leading edge to a suction surface trailing edge defining a transition at which the transitioner suction surface is attached to the primary suction surface; and a transitioner pressure surface extending from the transitioner leading edge to a pressure surface trailing edge defining a transition at which the transitioner pressure surface is attached to the primary pressure surface, wherein the transitioner leading edge is positioned forward of the primary leading edge, and wherein, at a particular spanwise position of the flow transitioner: (1) a diameter of the transitioner leading edge circle is 1% to 70% of a diameter of the primary leading edge circle, or (2) the diameter of the transitioner leading edge circle is 5% to 55% of a maximum thickness between the primary suction surface and the primary pressure surface, or (3) a length of the transitioner chord line is 5% to 18% of a length of the primary chord line.

B2 The flow transitioner of embodiment B1, wherein the particular spanwise position is a root of the flow transitioner.

B3. The flow transitioner of embodiment B1 or B2, wherein the flow transitioner has a concave trailing end extending between the suction surface trailing edge and the pressure surface trailing edge, wherein a curvature of the trailing end conforms to a curvature of the primary leading edge.

B4. The flow transitioner of any one of embodiments B1 to B3, wherein the primary wing comprises one of an airfoil and a hydrofoil.

B5. The flow transitioner of any one of embodiments B1 to B3, wherein the primary wing comprises one of a wing, a stabilizer, a tail, an aircraft propellor blade, a watercraft propellor blade, a wind turbine blade, a hydro turbine blade, a fan blade, and a compressor blade.

B6. The flow transitioner of any one of embodiments B1 to B5, wherein an angle of the transitioner chord line with respect to the primary chord line is fixed, or the angle of the transitioner chord line with respect to the primary chord line is variable.

B7. The flow transitioner of any one of embodiments B1 to B6, wherein the flow transitioner is configured to direct additional fluid flow over the primary suction surface or direct additional fluid flow over the primary pressure surface compared to a primary wing without the flow transitioner.

B8. The flow transitioner of any one of embodiments B1 to B7, further comprising a transitioner skin attached to the primary suction surface aft of the primary leading edge and attached to the primary pressure surface aft of the primary leading edge.

B9. The flow transitioner of embodiment B8, further comprising a seal to provide a water tight and air tight seal between the transitioner skin and the primary suction surface and between the transitioner skin and the primary pressure surface, wherein the seal comprises: an upper seal located between the transitioner skin and an upper wing rib flange and between a wing skin of the primary suction surface and the upper wing rib flange; an upper seal plate, wherein the upper seal is captured between the upper seal plate and the transitioner skin and the wing skin of the primary suction surface; a lower seal located between the transitioner skin and a lower wing rib flange and between a wing skin of the primary pressure surface and the lower wing rib flange; and a lower seal plate, wherein the lower seal is captured between the lower seal plate and the transitioner skin and the wing skin of the primary pressure surface.

C1 A variable angle flow transitioner configured to be coupled with a primary foil, wherein the primary foil has a primary suction surface, a primary pressure surface, a primary leading edge, a primary trailing edge, and a primary chord line extending from the primary leading edge to the primary trailing edge, wherein the variable angle flow transitioner comprises: a transitioner skin attached to the primary suction surface aft of the primary leading edge and to the primary pressure surface aft of the primary leading edge; a transitioner support mounted to the primary foil so as to be pivotable about a support pivot axis and extending forward of the primary leading edge; a nose roller that is rotatable about a roller axis and extending from a leading end of the transitioner support, wherein the transitioner skin extends over the transitioner support and the nose roller to define a transitioner suction surface, a transitioner pressure surface, and transitioner leading edge, and wherein a line from the roller axis to the support pivot axis defines a transitioner chord line; and a motor operably coupled to the transitioner support for selective motorized pivoting of the transitioner support to vary an angle between the transitioner chord line and the primary chord line.

C2 The variable angle flow transitioner of embodiment C1, further comprising a motor gear driven by the motor and a gear section on an end of the transitioner support, wherein the gear section is operatively engaged by the motor gear.

C3 The variable angle flow transitioner of embodiment C1 or C2, further comprising a reinforcement mounted internally to the primary foil and attached to a rib of the primary foil, wherein the reinforcement includes an integral flange supporting the primary suction surface and the primary pressure surface near the primary leading edge, wherein the transitioner support is pivotably mounted to the reinforcement, and the motor is mounted to the reinforcement.

C4 The variable angle flow transitioner of any one of embodiments C1-C3, wherein the nose roller is mounted to a tensioner for maintaining a desired tension in the transitioner skin.

C5 The variable angle flow transitioner of any one of embodiments C1-C4, further comprising a transitioner curvature actuator system configured to selectively alter one or both of a curvature of the transitioner suction surface and a curvature of the transitioner pressure surface.

C6 The variable angle flow transitioner of embodiment C5, wherein the transitioner curvature actuator system comprises: an upper skin support supporting an inner surface portion of the transitioner suction surface; an upper skin support actuator for selectively moving the upper skin support in a direction generally toward or away from the transitioner leading edge; a lower skin support supporting an inner surface portion of the transitioner pressure surface; and a lower skin support actuator for selectively moving the lower skin support in a direction generally toward or away from the transitioner leading edge.

C7 The variable angle flow transitioner of embodiment C6, wherein the upper skin support actuator comprises an upper rack coupled to a gear, and wherein the lower skin support actuator comprises a lower rack coupled to the gear.

C8 The variable angle flow transitioner of embodiment C7, wherein the upper skin support is pivotable about an upper skin support pivot point, and the lower skin support is pivotable about a lower skin support pivot point.

C9 The variable angle flow transitioner of embodiment C8, further comprising: one or more first upper skin support springs between the upper rack and the upper skin support; one or more second upper skin support springs between the upper rack and the upper skin support, wherein the upper skin support pivot point is located between the first and second upper skin support springs; one or more first lower skin support springs between the lower rack and the lower skin support; and one or more second lower skin support springs between the lower rack and the lower skin support, wherein the lower skin support pivot point is located between the first and second lower skin support springs.

C10 The variable angle flow transitioner of embodiment C9, further comprising: an upper I beam support fixed with respect to the transitioner support; an upper I beam slide to which the upper rack is fixed and which extends through the upper I beam support; an upper support coupling the upper skin support to the upper I beam slide; a lower I beam support fixed with respect to the transitioner support; a lower I beam slide to which the lower rack is fixed and which extends through the lower I beam support; and a lower support coupling the lower skin support to the lower I beam slide.

C11 The variable angle flow transitioner of embodiment C6, wherein the upper skin support actuator comprises an upper ball screw assembly coupled to the upper skin support, and wherein the lower skin support actuator comprises a lower ball screw assembly coupled to the lower skin support.

C12 The variable angle flow transitioner of embodiment C11, wherein the upper ball screw assembly comprises: an upper ball screw motor; an upper ball screw coupled to the upper ball screw motor; an upper carriage operatively coupled to the upper ball screw; and an extension extending from the upper carriage to the upper skin support, and wherein the lower ball screw assembly comprises: a lower ball screw motor; a lower ball screw coupled to the lower ball screw motor; a lower carriage operatively coupled to the lower ball screw; and an extension extending from the lower carriage to the lower skin support.

C13 The variable angle flow transitioner of embodiment C11 or embodiment C12, wherein the transitioner support comprises an extension and the nose roller extends from a leading end of the extension, and wherein the extension is moveable in a direction parallel to the transitioner chord line.

C14 The variable angle flow transitioner of embodiment C13, further comprising an actuator coupled to the extension and configured to selectively move the extension toward or away from the primary leading edge to vary a length of the transitioner chord.

C15 The variable angle flow transitioner of embodiment C13 or C14, further comprising at least two rods slidably supported in a guide block, and wherein the extension is attached to the at least two rods.

C16 The variable angle flow transitioner of any one of embodiments C6 to C15, wherein the transitioner curvature actuator system is configured to synchronize movements of the upper skin support and the lower skin support so that a surface curvature of one of the suction surface and the pressure surface of the transitioner becomes steeper closer to the transitioner leading edge and a surface curvature of another of the suction surface and the pressure surface of the transitioner becomes less steep closer to the transitioner leading edge.

C17 The variable angle flow transitioner of embodiment C14, wherein the transitioner curvature actuator system is configured to synchronize movements of the upper skin support, the lower skin support, and the extension so that as a thickness of the transitioner changes due to movements of the upper skin support and/or the lower skin support, the extension is moved toward or away from the primary leading edge to vary the transitioner chord length to accommodate a fixed length of the transitioner skin.

C18 The variable angle flow transitioner of any one of embodiments C1 to C17, further comprising a seal to provide a water tight and air tight seal between the transitioner skin and the primary suction surface and the primary pressure surface, wherein the seal comprises: an upper seal located between the transitioner skin and an upper wing rib flange and between a wing skin of the primary suction surface and the upper wing rib flange; an upper seal plate, wherein the upper seal is captured between the upper seal plate and the transitioner skin and the wing skin of the primary suction surface; a lower seal located between the transitioner skin and a lower wing rib flange and between a wing skin of the primary pressure surface and the lower wing rib flange; and a lower seal plate, wherein the lower seal is captured between the lower seal plate and the transitioner skin and the wing skin of the primary pressure surface.

D1 A flow transitioner configured to be coupled with a primary foil, wherein the primary foil has a primary suction surface, a primary pressure surface, a primary leading edge, a primary trailing edge, and a primary chord line extending from the primary leading edge to the primary trailing edge, wherein the flow transitioner comprises: a transitioner skin attached to the primary suction surface aft of the primary leading edge and to the primary pressure surface aft of the primary leading edge; a transitioner support mounted to the primary foil and extending forward of the primary leading edge, and a variable nose circle assembly supported on an end of the transitioner support, wherein the transitioner skin extends over the transitioner support and the variable nose circle assembly to form a transitioner suction surface, a transitioner pressure surface, and a transitioner leading edge defined by a transitioner leading edge circle, and wherein the variable nose circle assembly is configured to selectively change a diameter of the transitioner leading edge circle.

D2 The flow transitioner of embodiment D1, wherein the variable nose circle assembly comprises: a motor configured to rotate a threaded shaft; one or more skin supports; one of more threaded followers coupled to the threaded shaft; and linkages coupling each of the one or more skin supports to the one or more threaded followers so that rotation of the threaded shaft in a first direction expands the one or more skin supports outwardly to increase the diameter of the transitioner leading edge circle and rotation of the threaded shaft in a second direction retracts the one or more skin supports inwardly to decrease the diameter of the transitioner leading edge circle.

D3 The flow transitioner of embodiment D1 or D2, wherein the transitioner support is mounted so as to be pivotable about a support pivot axis, wherein a line from an axis of the transitioner leading edge circle to the support pivot axis defines a transitioner chord line; and wherein the flow transitioner further comprises a motor operably coupled to the transitioner support for selective motorized pivoting of the transitioner support to vary an angle between the transitioner chord line and the primary chord line.

D4 The flow transitioner of embodiment D3, further comprising a motor gear driven by the motor and a gear section on an end of the transitioner support, wherein the gear section is operatively engaged by the motor gear.

D5 The flow transitioner of any one of embodiments D1 to D4, further comprising a reinforcement mounted internally to the primary foil and attached to a rib of the primary foil, wherein the reinforcement includes an integral flange supporting the primary suction surface and the primary pressure surface near the primary leading edge, wherein the transitioner support is mounted to the reinforcement.

D6 The flow transitioner of any one of embodiments D1 to D5, further comprising a transitioner curvature actuator system configured to selectively alter one or both of a curvature of the transitioner suction surface and a curvature of the transitioner pressure surface.

D7 The flow transitioner of embodiment D6, wherein the transitioner curvature actuator system comprises: an upper skin support supporting an inner surface portion of the transitioner suction surface; an upper skin support actuator for selectively moving the upper skin support in a direction toward or away from the transitioner leading edge; a lower skin support supporting an inner surface portion of the transitioner pressure surface; and a lower skin support actuator for selectively moving the lower skin support in a direction toward or away from the transitioner leading edge.

D8 The flow transitioner of embodiment D7, wherein the upper skin support actuator comprises an upper rack coupled to a gear, and wherein the lower skin support actuator comprises a lower rack coupled to the gear.

D9 The flow transitioner of embodiment D8, wherein the upper skin support is pivotable about an upper skin support pivot point, and the lower skin support is pivotable about a lower skin support pivot point.

D10 The flow transitioner of embodiment D9, further comprising: one or more first upper skin support springs between the upper rack and the upper skin support; one or more second upper skin support springs between the upper rack and the upper skin support, wherein the upper skin support pivot point is located between the first and second upper skin support springs; one or more first lower skin support springs between the lower rack and the lower skin support; and one or more second lower skin support springs between the lower rack and the lower skin support, wherein the lower skin support pivot point is located between the first and second lower skin support springs.

D11 The flow transitioner of embodiment D10, further comprising: an upper I beam support fixed with respect to the transitioner support; an upper I beam slide to which the upper rack is fixed and which extends through the upper I beam support; an upper support coupling the upper skin support to the upper I beam slide; a lower I beam support fixed with respect to the transitioner support; a lower I beam slide to which the lower rack is fixed and which extends through the lower I beam support; and a lower support coupling the lower skin support to the lower I beam slide.

D12 The flow transitioner of embodiment D7, wherein the upper skin support actuator comprises an upper ball screw assembly coupled to the upper skin support, and wherein the lower skin support actuator comprises a lower ball screw assembly coupled to the lower skin support.

D13 The flow transitioner of embodiment D12, wherein the upper ball screw assembly comprises: an upper ball screw motor; an upper ball screw coupled to the upper ball screw motor; an upper carriage operatively coupled to the upper ball screw; and an extension extending from the upper carriage to the upper skin support, and wherein the lower ball screw assembly comprises: a lower ball screw motor; a lower ball screw coupled to the lower ball screw motor; a lower carriage operatively coupled to the lower ball screw; and an extension extending from the lower carriage to the lower skin support.

D14 The flow transitioner of embodiment D12 or embodiment D13, wherein the transitioner support comprises an extension and the variable nose circle assembly extends from a leading end of the extension, and wherein the extension is moveable in a direction toward or away from the primary leading edge.

D15 The flow transitioner of embodiment D14, further comprising an actuator coupled to the extension and configured to selectively move the extension toward or away from the primary leading edge to vary a chord length of the transitioner.

D16 The flow transitioner of embodiment D14 or D15, further comprising at least two rods slidably supported in a guide block, and wherein the extension is attached to the at least two rods.

D17 The flow transitioner of any one of embodiments D7 to D16, wherein the transitioner curvature actuator system is configured to synchronize movements of the upper skin support and the lower skin support so that a surface curvature of one of the suction surface and the pressure surface of the transitioner becomes steeper closer to the transitioner leading edge and a surface curvature of another of the suction surface and the pressure surface of the transitioner becomes less steep closer to the transitioner leading edge.

D18 The flow transitioner of embodiment D15, wherein the transitioner curvature actuator system is configured to synchronize movements of the upper skin support, the lower skin support, and the extension so that as a thickness of the transitioner changes due to movements of the upper skin support and/or the lower skin support, the extension is moved toward or away from the primary leading edge to vary the chord length of the transitioner to accommodate a fixed length of the transitioner skin.

D19 The flow transitioner of any one of embodiments D1 to D18, further comprising a seal to provide a water tight and air tight seal between the transitioner skin and the primary suction surface and the primary pressure surface, wherein the seal comprises: an upper seal located between the transitioner skin, a wing skin of the primary suction surface, and an upper wing rib flange; an upper seal plate, wherein the upper seal is captured between the upper seal plate and the transitioner skin and the wing skin of the primary suction surface; a lower seal located between the transitioner skin, a wing skin of the primary pressure surface, and a lower wing rib flange; and a lower seal plate, wherein the lower seal is captured between the lower seal plate and the transitioner skin and the wing skin of the primary pressure surface.

E1 A wing assembly comprising a suction surface, a pressure surface, and a leading edge, wherein a profile of the wing assembly is defined by one or more reference measurements, wherein the one or more reference measurements comprise: a leading edge diameter (219) of 5% to 55% of a maximum thickness (281) of the wing assembly between the suction surface and the pressure surface; or a first length measurement from a datum line to the suction surface at a first measurement location, wherein the datum line is perpendicular to and bisects a maximum thickness line defining the maximum thickness of the wing assembly and the first measurement location (291) is measured from the maximum thickness line and is 22% to 98% % of the maximum thickness of the wing assembly, and wherein the first length measurement (284) is 34-143% of the maximum thickness of the wing assembly; a second length measurement from the datum line to the suction surface at a second measurement location, wherein the second measurement location (290) is measured from the maximum thickness line and is 74% to 310% of the maximum thickness of the wing assembly and is greater than the first measurement location (291), and wherein the second length measurement (282) is 20-89% of the maximum thickness of the wing assembly; a third length measurement from the datum line to the pressure surface at the first measurement location (291), wherein the third length measurement (285) is 20-93% of the maximum thickness of the wing assembly; and a fourth length measurement from the datum line to the pressure surface at the second measurement location (290), wherein the fourth length measurement (283) is 18-78% of the maximum thickness of the wing assembly.

E2. The wing assembly of embodiment E1, comprising one of an airfoil and a hydrofoil.

E3. The wing assembly of embodiment E1 or E2, wherein the wing assembly comprises one of a wing, a stabilizer, and a tail.

F1 A turbine blade assembly comprising a suction surface, a pressure surface, and a leading edge, wherein a profile of the turbine blade assembly is defined by one or more reference measurements, wherein the one or more reference measurements comprise: a leading edge diameter (419) of 1% to 35% of a maximum thickness of the turbine blade assembly between the suction surface and the pressure surface; or a first length measurement from a datum line to the suction surface at a first measurement location, wherein the datum line is perpendicular to and bisects a maximum thickness line defining the maximum thickness of the turbine blade assembly and the first measurement location (491) is measured from the maximum thickness line and is 25% to 165% of the maximum thickness of the turbine blade assembly, and wherein the first length measurement (483) is 10% to 80% of the maximum thickness of the foil assembly; a second length measurement from the datum line to the suction surface at a second measurement location, wherein the second measurement location (490) is measured from the maximum thickness line and is 55% to 330% of the maximum thickness of the turbine blade assembly and is greater than the first measurement location (491), and wherein the second length measurement (485) is 4% to 35% of the maximum thickness of the turbine blade assembly; a third length measurement from the datum line to the pressure surface at the first measurement location (491), wherein the third length measurement (482) is 10-80% of the maximum thickness of the turbine blade assembly; and a fourth length measurement from the datum line to the pressure surface at the second measurement location (490), wherein the fourth length measurement (484) is 10% to 70% of the maximum thickness of the turbine blade assembly.

F2. The turbine blade assembly of embodiment D1 or D2, wherein the turbine blade assembly comprises one of a wind turbine blade, a hydro turbine blade, a fan blade, and a compressor blade.

G1. A turbine blade assembly comprising: a primary turbine blade, wherein the primary turbine blade has a primary suction surface, a primary pressure surface, a primary leading edge defined by a primary leading edge circle, a primary trailing edge, and a primary chord line extending from the primary leading edge to the primary trailing edge; and a flow transitioner positioned over the primary leading edge, wherein the flow transitioner comprises: a transitioner leading edge defined by a transitioner leading edge circle; a transitioner chord line extending from the transitioner leading edge to the primary leading edge, wherein the primary chord line and the transitioner chord line are oriented at different angles, such that the transitioner chord line has a lower angle of attack than the primary chord line; a transitioner suction surface extending from the transitioner leading edge to a suction surface trailing edge defining a transition at which the transitioner suction surface is attached to the primary suction surface; and a transitioner pressure surface extending from the transitioner leading edge to a pressure surface trailing edge defining a transition at which the transitioner pressure surface is attached to the primary pressure surface, wherein the transitioner leading edge is positioned forward of the primary leading edge, and wherein, at a particular spanwise position of the assembly: (1) a diameter of the transitioner leading edge circle is 1% to 50% of a diameter of the primary leading edge circle, or (2) the diameter of the transitioner leading edge circle is 5% to 55% of a maximum thickness between the primary suction surface and the primary pressure surface, or (3) a length of the transitioner chord line is 2% to 18% of a length of the primary chord line.

G2 The turbine blade assembly of embodiment G1, wherein the particular spanwise position is a root of the turbine blade assembly.

G3. The turbine blade assembly of embodiment G1 or G2, wherein the flow transitioner has a trailing end extending between the suction surface trailing edge and the pressure surface trailing edge, wherein a curvature of the trailing end conforms to a curvature of the primary leading edge.

G4. The turbine blade assembly of any one of embodiments G1 to G3, wherein the turbine blade assembly comprises one of a wind turbine blade, a hydro turbine blade, a fan blade, and a compressor blade.

I1 A propellor blade assembly comprising a suction surface, a pressure surface, and a leading edge, wherein a profile of the propellor blade assembly is defined by one or more reference measurements, wherein the one or more reference measurements comprise: a leading edge diameter (719) of 1% to 50% of a maximum thickness (781) of the propellor blade assembly between the suction surface and the pressure surface; or a first length measurement from a datum line to the suction surface at a first measurement location, wherein the datum line is perpendicular to and bisects a maximum thickness line defining the maximum thickness of the propellor blade assembly and the first measurement location (791) is measured from the maximum thickness line and is 20% to 200% of the maximum thickness of the propellor blade assembly, and wherein the first length measurement (784) is 30-150% of the maximum thickness of the propellor blade assembly; a second length measurement from the datum line to the suction surface at a second measurement location, wherein the second measurement location (790) is measured from the maximum thickness line and is 50% to 300% of the maximum thickness of the propellor blade assembly and is greater than the first measurement location (791), and wherein the second length measurement (782) is 15-85% of the maximum thickness of the propellor blade assembly; a third length measurement from the datum line to the pressure surface at the first measurement location (791), wherein the third length measurement (785) is 20-90% of the maximum thickness of the propellor blade assembly; and a fourth length measurement from the datum line to the pressure surface at the second measurement location (790), wherein the fourth length measurement (783) is 15-80% of the maximum thickness of the propellor blade assembly.

I2. The propellor blade assembly of embodiment G1, wherein the propellor blade assembly comprises one of a an aircraft propellor blade, a watercraft propellor blade, a wind turbine blade, a hydro turbine blade, a fan blade, and a compressor blade.

J1. A propellor blade assembly comprising: a primary propellor blade, wherein the primary propellor blade has a primary suction surface, a primary pressure surface, a primary leading edge defined by a primary leading edge circle, a primary trailing edge, and a primary chord line extending from the primary leading edge to the primary trailing edge; and a flow transitioner positioned over the primary leading edge, wherein the flow transitioner comprises: a transitioner leading edge defined by a transitioner leading edge circle; a transitioner chord line extending from the transitioner leading edge to the primary leading edge, wherein the primary chord line and the transitioner chord line are oriented at different angles, such that the transitioner chord line has a lower angle of attack than the primary chord line; a transitioner suction surface extending from the transitioner leading edge to a suction surface trailing edge defining a transition at which the transitioner suction surface is attached to the primary suction surface; and a transitioner pressure surface extending from the transitioner leading edge to a pressure surface trailing edge defining a transition at which the transitioner pressure surface is attached to the primary pressure surface, wherein the transitioner leading edge is positioned forward of the primary leading edge, and wherein, at a particular spanwise position of the assembly: (1) a diameter of the transitioner leading edge circle is 1% to 50% of a diameter of the primary leading edge circle, or (2) the diameter of the transitioner leading edge circle is 5% to 55% of a maximum thickness between the primary suction surface and the primary pressure surface, or (3) a length of the transitioner chord line is 2% to 18% of a length of the primary chord line.

J2 The propellor blade assembly of embodiment J1, wherein the particular spanwise position is a root of the propellor blade assembly.

J3. The propellor blade assembly of embodiment J1 or J2, wherein the flow transitioner has a trailing end extending between the suction surface trailing edge and the pressure surface trailing edge, wherein a curvature of the trailing end conforms to a curvature of the primary leading edge.

J4. The propellor blade assembly of any one of embodiments J1 to J3, wherein the primary propellor blade comprises one of an aircraft propellor blade, a watercraft propellor blade, a fan blade, and a compressor blade.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements. Unless otherwise noted, the drawings are not to scale.

FIG. 1 is a top isometric view of a jet powered airplane.

FIG. 2A is a top isometric view of an airplane wing with magnified detail cross-sectional views near the tip end, center section, and root end.

FIG. 2B is a bottom isometric view of an airplane wing.

FIG. 2C is a schematic profile view of a wing showing relative air flows, lift and drag forces, chord line and angle of attack.

FIG. 2D is a cropped isometric view of an airplane wing showing rib and skin with a magnified detail view showing rib flange and skin.

FIG. 2E is a profile view of a section of a typical airplane wing near the root showing beneficial areas on pressure and suction surfaces.

FIG. 2F is a schematic profile view of a section of a typical airplane wing showing the slope angles and types of forces on the beneficial areas on the pressure and suction surfaces, with magnified detail views of leading and trailing edge slope angles.

FIG. 3A is a top cropped isometric view of a jet powered airplane with an embodiment of transitioners.

FIG. 3B is a front isometric view of a transitioner, with magnified detail cross-sectional views near the tip end, center of the span, and root end.

FIG. 3C is a top isometric view of a transitioner/wing assembly with section planes near the tip end, center of the span, and root.

FIG. 3D is a profile view of a transitioner/wing assembly located near the tip.

FIG. 3E is a profile view of a transitioner/wing assembly located near the center of the span of the wing.

FIG. 3F is a profile view of a transitioner/wing assembly located near the root.

FIG. 3G is magnified profile view of a cropped transitioner/wing assembly near the root with chord angle detail.

FIG. 3H is magnified profile view of a cropped transitioner/wing assembly near the center of the span with chord angle detail.

FIG. 3I is magnified profile view of a cropped transitioner/wing assembly near the tip with chord angle detail.

FIG. 3J is a profile view of a transitioner/wing assembly near the root with nose circle detail and a magnified detail view of the transitioner leading edge area and nose circle.

FIG. 3K is a cropped isometric top view of a transitioner and wing assembly with a cut-away section revealing a wing skin seal and seal plate.

FIG. 3L is a cropped side view of a wing skin seal and seal plate. For visibility, seal is shown as not compressed.

FIG. 4A is view of flow trajectory lines around the wing profile without the benefit of a transitioner.

FIG. 4B is a view of flow trajectory lines around the wing assembly shown in FIG. 4A, with the benefit of a transitioner.

FIG. 4C is a profile view of a wing located near the root, without the benefit of a transitioner, showing delineated beneficial areas.

FIG. 4D is a profile view of a wing located near the root, with a transitioner, showing delineated beneficial areas.

FIG. 4E is a table of lift and drag force values measured on the delineated beneficial areas of profiles depicted in FIGS. 4C and 4D while flying at Mach 0.7.

FIG. 5A is a side view of a cropped transitioner/wing assembly with a variable angle embodiment, with the transitioner in the fully retracted position (with its leading edge positioned above the wing angle of attack), including powered components and transitioner to wing connections.

FIG. 5B is a side view of a cropped transitioner/wing assembly with a variable angle embodiment, with the transitioner in the fully extended position (with its leading edge positioned below the wing angle of attack), including powered components and transitioner to wing connections.

FIG. 5C is a magnified cropped and broken side view of a transitioner to wing connection point of a variable angle transitioner embodiment, with the transitioner shown in the fully retracted position (with its leading edge positioned above the wing angle of attack), with internal components removed for clarity.

FIG. 5D is a magnified cropped and broken side view of a transitioner to wing connection point of a variable angle transitioner embodiment, with the transitioner shown in the fully extended position (with its leading edge positioned below the wing angle of attack), with internal components removed for clarity.

FIG. 5E is a cropped isometric exploded magnified view of a wing rib and flange with an embodiment of left and right rib supports for a variable angle transitioner embodiment.

FIG. 5F is a cropped and broken top isometric view of a wing and transitioner with a cut-away section revealing wing ribs and variable angle components, with a cut-away section revealing a motor, and with a magnified cropped detail view of drivetrain components for a variable angle transitioner.

FIG. 5G is a broken rear view of the motor and related major drivetrain components of the variable angle connector assemblies located within a wing. The wing is not shown to reduce the complexity of the illustration.

FIG. 6A is a root-side isometric view of a cropped transitioner/wing assembly with an embodiment of spring tensioned variable pressure and suction surfaces, with a upper skin support in a retracted position, away from the transitioner leading edge and a lower skin support in an extended position, toward the transitioner leading edge and with (i) two detail cross-sectional magnified views of the upper and lower rack slide beams within their respective I beam supports, and (ii) detail magnified cross-sectional views of the upper and lower supports and respective support slots.

FIG. 6B is a root-side isometric view of a cropped transitioner/wing assembly with an embodiment of spring tensioned variable pressure and suction surfaces, with the upper skin support in an extended position toward the transitioner leading edge and the lower skin surface support in a retracted position away from the transitioner leading edge and with (i) two detail cross-sectional magnified views of the upper and lower rack slide beams within their respective I beam supports, and (ii) detail magnified cross-sectional views of the upper and lower supports and respective support slots.

FIG. 6C is a side view of a cropped transitioner/wing assembly, as seen from the root-side, with an embodiment of variable angle of attack components with actuator tensioned variable pressure and suction surfaces, with an upper skin support in a mid-way position and a lower skin support in a fully extended position toward the transitioner leading edge.

FIG. 6D is a side view of a cropped transitioner/wing assembly, as seen from the root-side, with an embodiment of variable angle of attack components with actuator-tensioned variable pressure and suction surfaces, with the upper skin support in a fully extended position toward the transitioner leading edge and the lower skin support in a mid-way retracted position.

FIG. 6E is a side view of a cropped transitioner/wing assembly, as seen from the wing tip-side, with an embodiment of variable angle of attack components with actuator-tensioned variable pressure and suction surfaces, with the upper skin support in the mid-way extended position and the lower skin support in the fully extended position toward the transitioner leading edge.

FIG. 6F is a side view of a cropped transitioner/wing assembly, as seen from the wing tip-side, with an embodiment variable angle of attack components with actuator-tensioned variable pressure and suction surfaces, with the upper skin support in the fully extended position toward the transitioner leading edge and the lower skin support in the mid-way position.

FIG. 6G is a side view of a cropped transitioner/wing assembly, as seen from the wing-tip-side, showing the variable chord length function of an embodiment of actuator-tensioned pressure and suction surfaces, with the upper skin and lower skin supports in their fully extended positions toward the transitioner leading edge, a nose roller in its fully retracted position away from the transitioner leading edge, and a transitioner chord at its minimum length.

FIG. 6H is a side view of a cropped transitioner/wing assembly, as seen from the wing-tip-side, showing the variable chord function of an embodiment of actuator-tensioned variable pressure and suction surfaces, with both the upper skin and lower skin supports in their fully retracted positions away from the transitioner leading edge, the nose roller in its fully extended position, and the transitioner chord at its maximum length.

FIG. 7A is a wing root-side view a variable diameter nose circle assembly, in its fully retracted position, configured on a cropped tensioner extension.

FIG. 7B is a wing root-side view a variable diameter nose circle assembly, in its fully expanded position, configured on a cropped tensioner extension.

FIG. 7C is a wing tip-side view a variable diameter nose circle assembly, in its fully retracted position, with its drive motor shown.

FIG. 7D is a wing root-side isometric view of a variable diameter nose circle assembly, in its fully retracted position, configured within a cropped transitioner with the tensioner extension not shown for clarity.

FIG. 7E is a wing root-side isometric view of a variable diameter nose circle assembly, in its fully expanded position, configured within a cropped transitioner with the tensioner extension not shown for clarity.

FIG. 7F is a cropped and broken isometric top view of multiple variable nose circle assemblies, with a detail magnified isometric view of a variable nose circle assembly, with coupled and adjacent parts not shown for clarity.

FIG. 7G is a broken rear view of the major drivetrain components located within a wing and transitioner, connecting multiple variable diameter nose circle assemblies.

FIG. 8A is a side profile view of an embodiment of a wing with an integrated transitioner, with reference and dimension lines.

FIG. 8B is a table of reference dimensions of the wing with an integrated transitioner of FIG. 8A.

FIG. 9 is an isometric view of a three-bladed wind turbine.

FIG. 10A is a front isometric view of a wind turbine blade with magnified detail profile views near the tip end, center of the span, and root end.

FIG. 10B is a rear isometric view of a wind turbine blade.

FIG. 10C is a cross-sectional view of a wind turbine blade, near the root end, revealing internal components and reference lines.

FIG. 10D is a schematic profile view of a wind turbine blade showing relative air flows and lift, drag and thrust forces on the blade.

FIG. 11A is a front view of a wind turbine with transitioners coupled to the blades with couplings not shown.

FIG. 11B is a front isometric view of a turbine blade transitioner with magnified cross-sectional detail views near the tip, center of the span, and root.

FIG. 11C is front isometric view of a turbine blade and transitioner assembly with detail planes near the tip, center of the span, and root.

FIG. 11D is a profile of a turbine blade and transitioner assembly located near the tip end.

FIG. 11E is a profile of a turbine blade and transitioner assembly located near the center section of the span.

FIG. 11F is a profile of a turbine blade and transitioner assembly located near the root.

FIG. 11G is a magnified side view of a transitioner and cropped turbine blade assembly, located near the tip of the assembly, with chord angle detail.

FIG. 11H is a magnified side view of a transitioner and cropped turbine blade assembly, located near the center section of the assembly, with chord angle detail.

FIG. 11I is a magnified side view of a transitioner and cropped turbine blade assembly, located near the root of the assembly, with chord angle detail.

FIG. 11J is a profile view of a turbine blade and transitioner assembly located near the root with nose circle detail and a magnified detail view of the transitioner leading edge area and nose circle.

FIG. 12A is a side profile view of an embodiment of a turbine blade with an integrated transitioner, with reference and dimension lines.

FIG. 12B is table of reference dimensions of the turbine blade with an integrated transitioner of FIG. 12A.

FIG. 13A is a side view of apparent velocity flow trajectory lines around a section of turbine blade surfaces near the tip of a blade rotating in a 3.5 m/s wind, without the benefit of a transitioner.

FIG. 13B is a side view of apparent velocity flow trajectory lines around sections of turbine blade and transitioner surfaces near the tip of a transitioner/blade assembly rotating in a 3.5 m/s wind, with the benefit of a transitioner.

FIG. 13C is a side profile view of decibel regions around a section of the turbine blade tip rotating in a 13 m/s wind, without the benefit of a transitioner.

FIG. 13D is a side profile view of decibel regions around a section of the turbine blade tip rotating in a 13 m/s wind, with the benefit of a transitioner.

FIG. 14 is a front isometric view of a twin engine, propellor powered, airplane.

FIG. 15A is a front isometric view of an aircraft propellor with magnified detail profile views near the root, center of the span, and near the tip.

FIG. 15B is a rear isometric view of an aircraft propellor blade.

FIG. 15C is a profile view of an aircraft propellor blade showing lift, drag and thrust forces on the blade and air flows.

FIG. 16A is a front isometric view of a twin engine, propellor powered, airplane with transitioners coupled to the propellor blades and positioned to affect the entire blade span.

FIG. 16B is a front isometric view of an aircraft propellor assembly with transitioners coupled to the propellor blades and positioned to affect the entire blade spans.

FIG. 16C is a front isometric view of an airplane propellor transitioner with magnified detail views of a profile of the transitioner near the root, at the center section of the span, and near the tip.

FIG. 16D is a front isometric view of an aircraft propellor and transitioner assembly, with magnified detail profile views near the root, center of the span, and near the tip end.

FIG. 16E is a profile view of an aircraft propellor and transitioner assembly located near the root of the assembly.

FIG. 16F is a profile view of an aircraft propellor and transitioner assembly located near the center section of the span of the assembly.

FIG. 16G is a profile view of an aircraft propellor and transitioner assembly located near the tip of the assembly.

FIG. 16H is a profile view of a propellor blade and transitioner assembly located near the tip with nose circle detail and a magnified detail view of the transitioner leading edge area.

FIG. 17A is a side profile view of an embodiment of a propellor blade with an integrated transitioner, with reference and dimension lines.

FIG. 17B is table of reference dimensions of the propellor blade with an integrated transitioner of FIG. 17A.

FIG. 18A is a profile view of a pressure plot around upstream and downstream surfaces of the propellor blade of FIG. 15A Detail C while rotating at 3000 RPM.

FIG. 18B is a profile view of a pressure plot around upstream and downstream surfaces of the propellor blade and transitioner of FIG. 16D Detail C while rotating at 3000 RPM.

### DETAILED DESCRIPTION

Unless defined otherwise, all terms of art, notations and other technical terms or terminology used herein have the same meaning as is commonly understood by one of ordinary skill in the art to which this disclosure belongs. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

References in the specification to “one embodiment,” “an embodiment,” a “further embodiment,” “an exemplary embodiment,” “some aspects,” “a further aspect,” “aspects,” etc., indicate that the embodiment described may include a particular feature, structure, or characteristic, but every embodiment encompassed by this disclosure may not necessarily include the particular feature, structure, or characteristic. Moreover, such phrases are not necessarily referring to the same embodiment. Further, when a particular feature, structure, or characteristic is described in connection with an embodiment, such feature, structure, or characteristic is also a description in connection with other embodiments, whether or not explicitly described.

Unless otherwise indicated or the context suggests otherwise, as used herein, “a” or “an” means “at least one” or “one or more.”

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, root-side, tip-side, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship in which the first component, structure, or portion thereof is in direct contact with the second component, structure, or portion thereof or there are one or more intervening components, structures, or portions thereof between the first component, structure, or portion thereof and the second component, structure, or portion thereof.

Furthermore, unless otherwise stated, any specific dimensions mentioned in this description are merely representative of an exemplary implementation of a device embodying aspects of the disclosure and are not intended to be limiting.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

As used herein, the term “fixedly linked” as used to refer to a physical arrangement between two or more items means that one item is attached or connected to another item in a manner precluding relative movement between the first item and the second item.

As used herein, the term “adjustably coupled” as used to refer to a physical arrangement between two or more items means that one item is attached or otherwise coupled to another item via structure(s) and/or mechanism(s) that enable and/or effect relative movement between the first item and the second item so that the position and/or the orientation of the first item with respect to the second item may be selectively (including automatically) altered.

As used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

As used herein, the term “actuator” means a mechanism that produces force, torque, or displacement in response to an electrical, pneumatic, or hydraulic input supplied to it. Irrespective of how it is shown, its applications can take many forms including, without limitation, linear actuators, rotary actuators, hydraulic actuators, pneumatic actuators, and electromechanical actuators. For example, a linear actuator produces motion along a straight path and may be driven by a piston-cylinder arrangement, a leadscrew, a ball screw, or a roller screw.

As used herein, the term “airfoil section” means a portion of a blade having a shape that generates differential pressures between opposed surfaces (lift) due to relative movement of air with respect to the airfoil section.

As used herein, the term “AoA” means angle of attack.

As used herein, “apparent velocity” or “apparent flow” (or, alternatively, (“effective velocity” or “effective flow”) is the fluid flow, e.g., airflow, water flow, liquid-flow or gas flow, to which a rotor blade or propellor blade is exposed and is the vector sum of oncoming fluid flow and rotational flow induced by the rotation of a blade about a rotor axis of rotation.

As used herein, the term “bearing” refers to a component used to support and/or guide a rotating, oscillating, articulating or sliding shaft, pivot, wheel or assembly. Irrespective of the bearing described or shown, it may take on numerous forms, including, without limitation, sealed, unsealed, roller, ball, angular, needle, and thrust. However, unless otherwise specifically stated, when such term is used, the term indicates that the actual linkage or coupling take a variety of forms, which will be readily apparent to a person of ordinary skill.

As used herein, the term “best fit” with respect to a nose circle refers to a circle that is defined geometrically as one that that minimizes the overall distance (or error) between a set of points on the leading edge of an airfoil or hydrofoil and the circle's circumference.

As used herein, the term “blade,” refers to any embodiment of a blade used (i) on a fluid powered turbine, including without limitation, wind turbines and hydro turbines, (ii) on an aircraft, (iii) on a watercraft, (iv) on a fan or blower, or (iv) to move a or be moved by a fluid.

As used herein, the term “chord line” refers to an imaginary line extending from a leading edge of a foil to a trailing edge of the foil.

As used herein, the term “blade angle of attack” refers to the angle of the blade chord line relative to a rotor plane of rotation at a given point along a blade span.

As used herein, the term “bushing” refers to a component used to serve as a guide for a rotating, sliding, articulating or otherwise moving component within it, and may take on numerous forms, includes without limitation, self-lubricating, metal-polymer composite, bronze wrapped, filament wound, and injection molded. However, unless otherwise specifically stated, when such term is used, the term indicates that the actual linkage or coupling take a variety of forms, which in certain instances will be readily apparent to a person of ordinary skill.

As used herein, the term “CAD model” refers to a virtual model of a part, or assemblage of parts, including without limitation, a rotor, blade, transitioner or blade/transitioner assembly, which was created using Computer-Aided Design (CAD).

As used herein, the term “center line” refers to a line that passes through the center of an object, for example a transitioner.

As used herein, the term “CFD” refers to Computational Fluid Dynamics.

As used herein, the term “chord” or “chord length” means, with respect to (i) any foil other than a transitioner, the length of the chord line, or the distance, between the leading edge and a point where the chord line intersects the trailing edge, and (ii) a transitioner, the length of a line from the leading edge of the transitioner to the leading edge of the foil to which the transitioner is fixedly linked or adjustably coupled. This term may be used when describing such distance in a transitioner, wing, blade or other foil, its angle of attack, or its angle relative to a reference line or plane, including, without limitation, the chord of another foil, plane of rotation or fluid flow.

As used herein, the terms “computer,” “computer-controlled,” and like terms refer computing and control modules (e.g., system controller(s)), such as microprocessors, programmable logic controllers, embedded controllers, application specific integrated circuits (ASICS), and computers, configured to effect computational and/or control steps by receiving one or more input values, executing one or more algorithms stored on non-transitory machine-readable media (e.g., software) that provide instruction for manipulating or otherwise acting on or in response to the input values, and output one or more output values. Such outputs may be displayed or otherwise indicated to a user for providing information to the user, for example information as to the status of the instrument or of a process being performed thereby, or such outputs may comprise inputs to other processes and/or control algorithms and/or computers. Data input components comprise elements by which data is input for use by the control and computing hardware components. Such data inputs may comprise signals generated by computers, sensors or scanners, such as, position sensors, speed sensors, accelerometers, environmental (e.g., temperature and barometric pressure) sensors, motor encoders, barcode scanners, or RFID scanners, pressure sensors, as well as manual input elements, such as keyboards, stylus-based input devices, touch screens, microphones, switches, manually-operated scanners, etc. Data inputs may further include data retrieved from memory. Data output components may comprise hard drives or other storage media, data transmission components (e.g. LAN, WiFi), monitors, printers, indicator lights, or audible signal elements (e.g., chime, buzzer, horn, bell, etc.). A computer may include one or more uninterruptible power supplies.

As used herein, the term “connector assembly” refers to a structure that connects a transitioner to a wing, turbine blade, propellor or other foil.

As used herein, the term “concavity” refers to a portion of a surface that is concave when shown as part of a profile.

As used herein, the term “convexity” refers to a portion of a surface that is convex when shown as part of a profile.

As used herein, the term “edge” means any intersection at which a pressure surface and a suction surface of a transitioner meet, and includes, but is not limited to, arcs, decreasing and increasing radii, and decreasing and increasing curvatures.

As used herein, the term “engine” means a machine that converts fuel into mechanical energy, e.g. rotational energy.

As used herein, the term “expander” means any device that embodies elements of expanders commonly used in commercial and industrial applications, including without limitation automotive and piping, for expanding the diameter of a pipe or tube by increasing an outer diameter of an assembly of curved dies. Commonly used expanders include but are not limited to those a driven by a screw for (i) actuating a lever and die arrangement, (ii) drawing together mated cones attached to a die arrangement, and (iii) turning a gear and cam arrangement attached to dies. Expander screws may be driven by motor or in some cases hand.

As used herein, the term “foil” refers to a solid object with a shape such that when placed in a moving fluid at a suitable angle of attack the lift force generated perpendicular to the fluid flow is larger than the drag force generated parallel to the fluid flow, and includes without limitation, aircraft and watercraft bodies, transitioners, wings, stabilizers, tails, aircraft propellors, watercraft propellors, wind turbine blades and hydro turbine blades.

As used herein, the term “flow simulation” means computational fluid dynamic (CFD) simulation, also referred to herein as “flow analysis.”

As used herein, the term “fluid” refers to a liquid, gas, or plasma, including, without limitation, air and water.

As used herein, the term “global lift-to-drag ratio” refers to the combination of lift and drag from all foil and transitioner surfaces within a transitioner/foil assembly.

As used herein, the term “hub end” refers to the portion of a blade and/or transitioner nearest the hub of an associated rotor as defined herein.

As used herein, the term “hydrofoil section” means a portion of a blade having a shape that generates differential pressures between opposed surfaces (lift) due to relative movement of water or other liquid with respect to the hydrofoil section.

As used herein, the term “hydro turbine” refers to a system that is intended to convert kinetic fluid energy from a moving liquid, or liquid mixture, including without limitation, water, to mechanical energy, also referred to as a “water turbine.”

As used herein, the term “L/D ratio” means lift-to-drag ratio.

As used herein, the term “leading edge area” refers to an area adjacent to the leading edge of a foil, and with respect to all foils other than transitioners, which nests with and/or is adjacent to the trailing end of the transitioner to which the foil is attached.

As used herein, the term “motor” refers to a machine that converts electricity, or pressure, including, without limitation, hydraulic and pneumatic, into mechanical energy, e.g. rotational energy.

As used herein, the term “nose circle” means the circle that best fits the rounded leading edge (or “nose”) of an airfoil or hydrofoil. Its radius describes the curvature whereby a larger radius means a rounder, blunter nose, while a smaller radius indicates a sharper, more acute edge.

As used herein, the term “pressure” with respect to fluid pressure is relative to atmospheric pressure. It is expressed as a positive number when greater than atmospheric pressure and expressed as a negative number when less than atmospheric pressure. Positive pressure values are commonly referred to as pressure, or positive pressure, and negative pressure values are commonly referred to as suction.

As used herein, the term “pressure surface” with respect to (i) non-rotating foils including, without limitation, wings, transitioners and stabilizers, means the surface or surfaces, or area adjacent to the surface or surfaces, of the foil with positive pressure due to differential air flow over the surface as compared to the opposite surface of the foil, also known as the lower side, (ii) rotating foils driven by fluids, including, without limitation, wind and hydro turbine blades, means surfaces, or area adjacent to the surfaces, that are nearer to the oncoming fluid flow, also referred to as the “upwind” or “upstream” side, and (iii) rotating foils driven by motors or engines including, without limitation, aircraft and watercraft propellor blades, fan blades, impellers and compressor blades means surfaces, or area adjacent to the surfaces, that are further from the oncoming fluid flow, also referred to as the “downwind” or “downstream” side.

As used herein, the term “right angle drive” means a mechanism with a gear train that can transmit an input torque and rotary motion transversely (e.g., 90 degrees). A right angle drive may be configured with (i) an input shaft that when powered rotates an output shaft at a 90° angle, and (ii) an optional additional output shaft that is colinear with the input shaft and rotated and powered by it (commonly known as a three-way right angle drive or three-way right angle gearbox).

As used herein, the term “profile” when referring to a foil or transitioner refers to a chordwise slice of a foil or transitioner (i.e., from leading edge to trailing edge) showing a shape of the foil or transitioner between opposed upstream (pressure) and downstream (suction) surfaces.

As used herein, the term “propellor” means any blade used to propel an aircraft, watercraft, or fluid.

As used herein, the term “rotational flow” means fluid flow induced by the rotation of a blade about a rotor axis of rotation and which is a component of apparent velocity.

As used herein, the term “rotor” means an assemblage of wind or hydro or rotorcraft blades.

As used herein, the term “rotor blade” is synonymous with the term “turbine blade” and means a wind or hydro turbine blade that is part of a rotor.

As used herein, the term “screw shaft” means any screw or ball screw that is used to enable a threaded component of the same screw diameter and thread count, including without limitation a mated threaded collar or nut, to move linearly.

As used herein, the term “seal” refers to a device or substance used to serve as a fluid barrier preventing the exchange of fluids in static, low/high pressure, or vacuum environments. Irrespective of how it is shown, its applications can take many forms including, without limitation, media/environmental physical seals, coatings to prevent exchange of media or fluids through porous surface, gaskets, o-rings, packings, shaft seals, coatings, and adhesives. However, unless otherwise specifically stated, when such terms are used, the terms indicate that the actual seal may take a variety of forms, which in certain instances will be readily apparent to a person of ordinary skill.

As used herein, the term “span” means the length of the aerodynamic or hydrodynamic section of an object being described.

As used herein, the term “stabilizer” refers to a foil on an aircraft or watercraft that provides stability and control. Stabilizers can be fixed or movable and can be used to control pitch (up and down motion) or yaw (side-to-side motion).

As used herein, the term “suction” with respect to fluid pressure is relative to atmospheric pressure and is expressed as a negative number. It is also commonly known as a negative pressure.

As used herein, the term “suction surface” means the surface or surfaces, or the area near the surface or surfaces, of a foil that are opposite or generally opposite from the pressure surface.

As used herein, the term “tip end” refers to the portion of a foil and/or transitioner nearest its respective tip end.

As used herein, the term “transitioner” means structures as described herein configured so as to define a pressure surface and a suction surface when exposed to relative fluid flow and which is positioned and oriented with respect to an associated wing, stabilizer, blade or other foil as to affect fluid flow impacting such foil irrespective of the foil's orientation to the fluid flow or, with respect to a rotor blade, propellor, or other rotating foil, irrespective of the longitudinal axis (axis of rotation) or direction of rotation of the rotating foil.

As used herein, the term “three-way right-angle drive” means a mechanism with a gear train that can transmit an input torque and rotary motion colinearly with the input shaft and transversely (e.g., 90 degrees). A three-way drive may be configured with an input shaft that when powered rotates (i) an output shaft at a 90° angle, and (ii) a second output shaft that is colinear with the input shaft (commonly known as a three-way right-angle drive or three-way right-angle gearbox).

As used herein, the term “variable transitioner” means a transitioner with functionality to enable varying its angle of attack and/or the curvature of a at least one pressure or suction surface.

As used herein, the term “wind turbine” refers to a system that is intended to convert kinetic fluid energy from a moving gas or gaseous mixture, including, without limitation, air, to mechanical energy.

As used herein, the term “working section” refers to a portion of a blade having a shape that generates differential pressures between opposed surfaces (lift) due to relative movement of fluid, e.g. air, water, or other liquid or gas. The working section may be referred to as the airfoil section on a wind turbine blade and may be referred to as a hydrofoil section on a hydro turbine blade.

All possible combinations of elements and components described in the specification or recited in the claims are contemplated and considered to be part of this disclosure. It should be appreciated that all combinations of the concepts discussed in greater detail below (provided that such concepts are not mutually inconsistent) are contemplated as being part of the subject matter disclosed herein.

The preferred embodiments will now be described with reference to the accompanying figures, wherein like numerals, including those followed by letter or hyphen and letter e.g. “-A” refer to like elements throughout. The terminology used in the descriptions below, including without limitation, the words “upper” and “lower,” are not to be interpreted in any limited or restrictive manner simply because it is used in conjunction with detailed descriptions of certain specific embodiments. Furthermore, many components described herein and shown within the drawings, and which are drawn as solid components, are done so for ease of understanding the drawings. Notwithstanding the crosshatch of such components, all such components may be manufactured using conventional (i) assembly techniques whereby a single component may be split into multiple parts and, when reassembled, embody the characteristics of the component described herein and/or shown in the drawings, and (ii) weight saving methods, including without limitation, designing all such components, in multiple sub-assemblies, which can be assembled with conventional assembly techniques, into the particular component as shown. All components, at the designer's choice, may also have an interior lattice-like, or other non-solid interior design with strengthened and/or thickened areas where required, for example at areas in contact with bearings or supports, and an external skin whereby such components may appear to be solid when in fact they need not be to achieve their desired functionality.

Provided herein and shown on accompanying figures are configurations of transitioners capable of being fixedly linked and/or adjustably coupled to one or more wings, other foils, and blades.

Embodiments disclosed herein permit multiple configurations of size and shape of transitioners, including without limitation, (i) differing aspect ratios (ratio of chordwise width to spanwise length) of transitioners, and (ii) positions relative to the pressure surface and suction surface of the respective wing, blade or other foil to which the transitioner(s) is fixedly linked or adjustably coupled. Moreover, the descriptions and drawings are not intended to be limiting with respect to a transitioner's physical shape, size, installation location or fluid type in which the transitioner is operating.

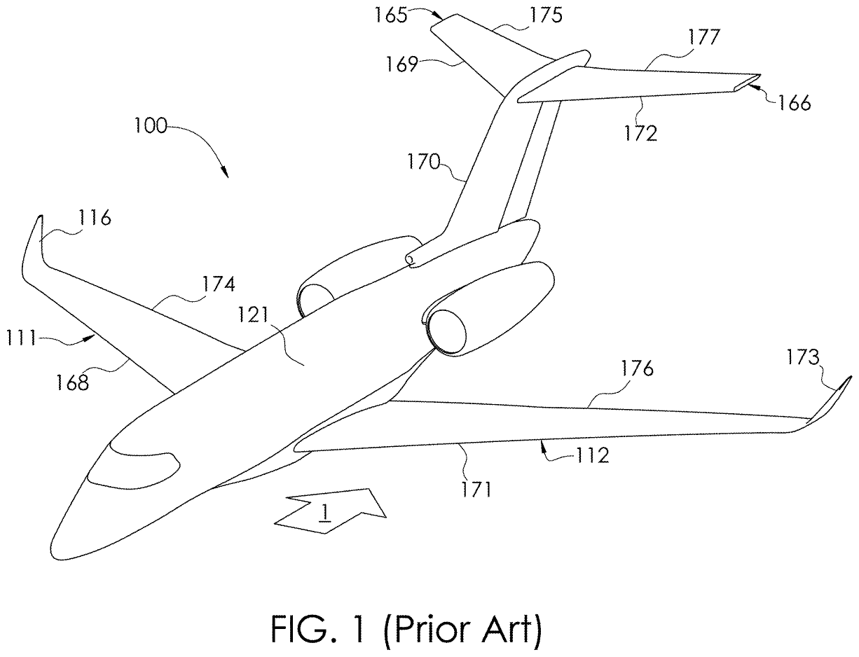

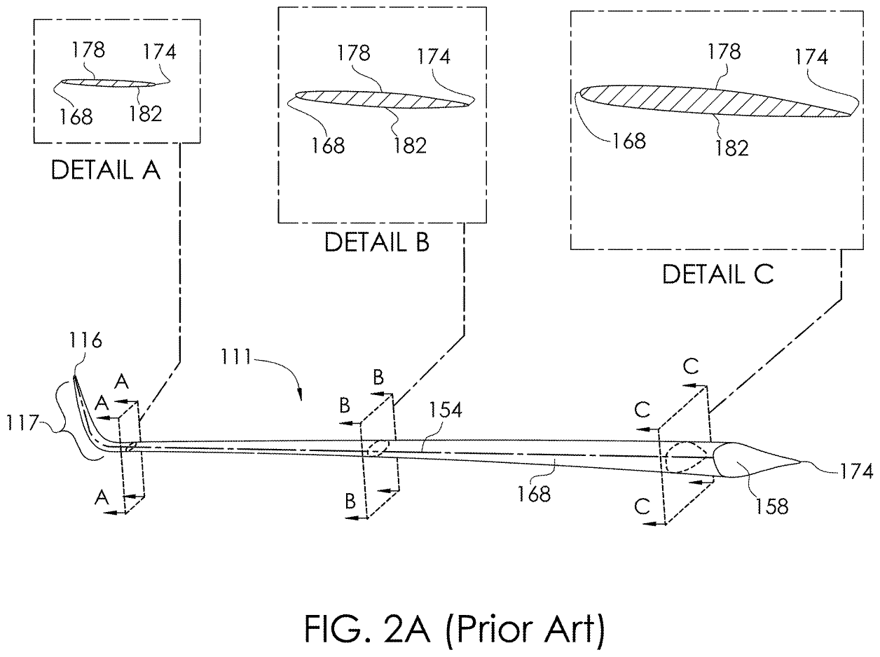

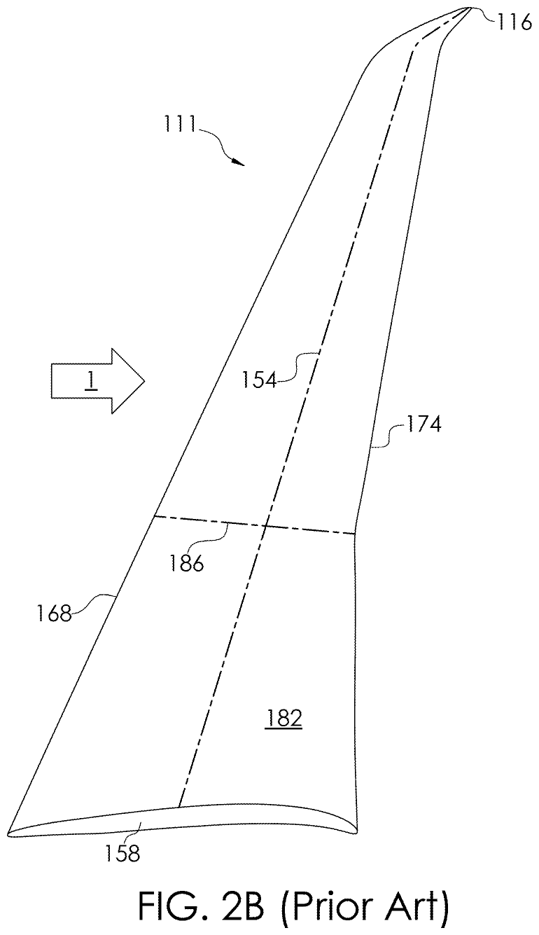

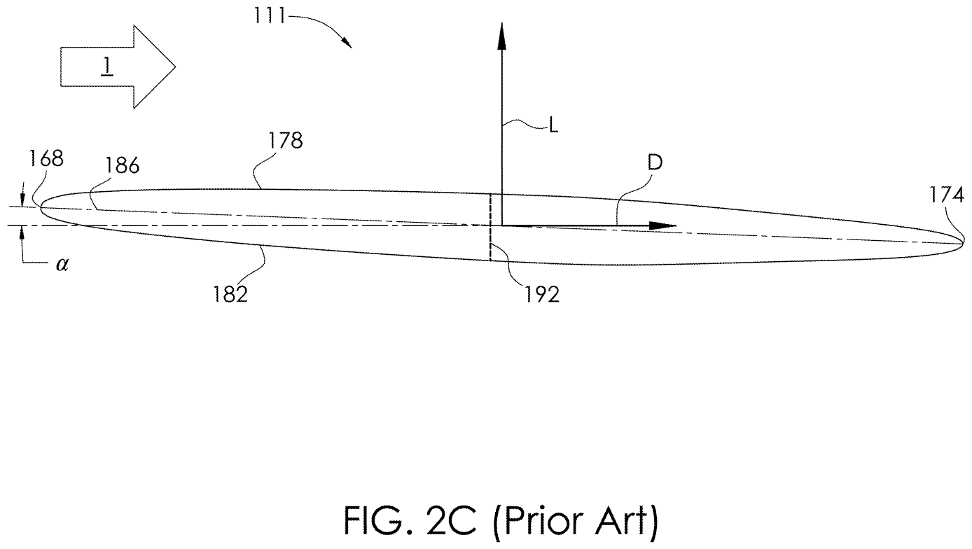

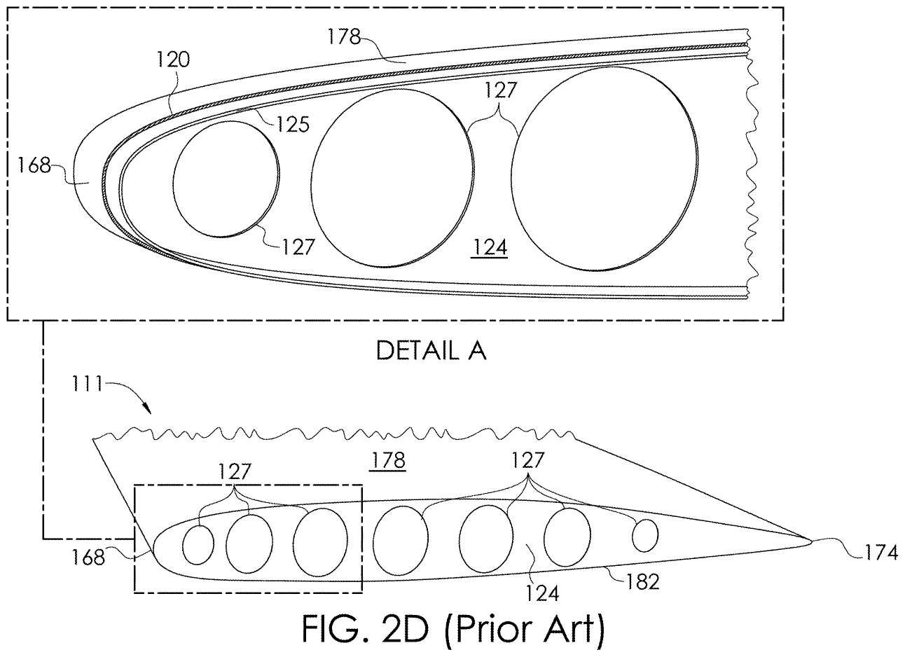

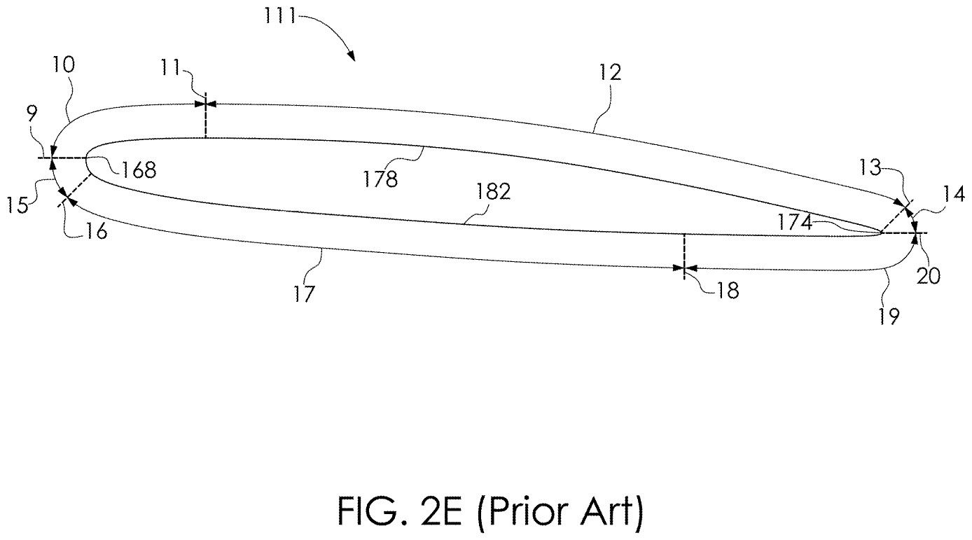

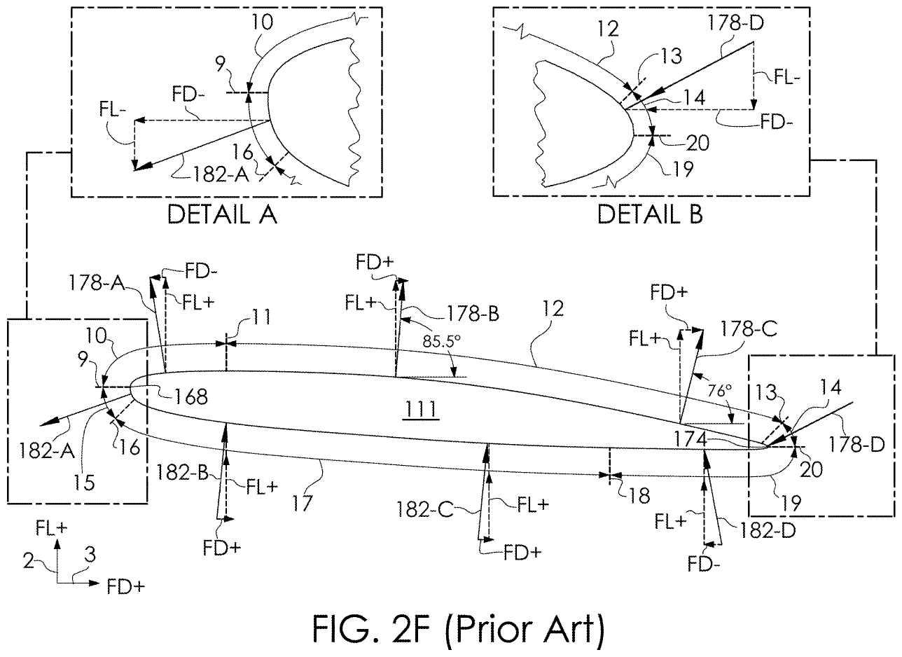

### 1. Airplane Wing—Prior Art—FIGS. 1-2D

Airplane 100 includes a fuselage 121, left wing 111 with leading edge 168 located nearest the oncoming flow 1, trailing edge 174, wing tip 116 and right wing 112 with leading edge 171, trailing edge 176 and wing tip 173. Airplane 100 also includes a tail section comprised of vertical stabilizer 170, left horizontal stabilizer 165 with leading edge 169 and trailing edge 175, and right horizontal stabilizer 166 with leading edge 172 and trailing edge 177.

Wings 111 and 112 are mirror images. Left horizontal stabilizer 165 and right horizontal stabilizer 166 are also mirror images.

Referring now to FIG. 2A, wing 111 includes a wing root 158 located nearest the fuselage 121 (see FIG. 1), and a wing tip 116 at the spanwise outboard end of the wing 111 with respect to the fuselage 121 and defining an airfoil span 154 from the wing root 158 to the wing tip 116.

Wing 111 includes airfoil sections progressing from the wing root end 158, having a leading edge 168 and a trailing edge 174, which are the working sections of the wing 111 and which defines an airfoil profile with a suction surface (or skyward surface) 178 generally running parallel to the oncoming fluid flow 1 (see FIG. 1) and a pressure surface (or groundward surface) 182.

Referring now to FIG. 2B while still referring to FIG. 2A, span 154 is defined as the distance from the wing root 158 to the tip end 116 of the wing 111. Wing 111 includes a chord 186 having a chord length that may be variable along the airfoil span 154 (e.g., with the chord length decreasing with increasing span distance from the wing root 158, as shown), or the length of chord 186 may be constant along some or all of airfoil span 154.

Referring now to FIG. 2C while still referring to FIG. 2B, chord 186 may be arranged at a wing chord angle α (or angle of attack) relative to the oncoming fluid flow 1 over the airplane 100 (see FIG. 1), and the wing chord angle α may also vary with spanwise distance from root 158.

When oncoming flow 1 passes over pressure surface 182 and suction surface 178, positive lift L is generated perpendicularly to fluid flow 1 skyward, and positive drag D is generated by resistance in a horizontal direction opposite the direction of travel of airplane 100 as it moves through the air.

Wing 111 may include a design feature whereby the angle of incidence (or angle of attack) decreases from the root 158 (see FIG. 2B) to the tip 116 resulting in tip 116 being twisted downwards relative to the root 158.

Referring now to FIG. 2D, wing 111 may include internal support structures including multiple ribs 124 with lightening holes 127 and rib flanges 125 to which skin 120 is supported and may be attached with adhesives or mechanical fasteners.

### 1.1 Beneficial Areas—FIG. 2E

For simplicity, this Subsection and the following Subsection describe Beneficial Areas of an embodiment of an airplane wing, however, similar principles apply to all foil types.

A beneficial area, under theoretically ideal conditions (“ideal conditions”) can have a positive or negative pressure that contributes an increase in L/D ratio to a foil, such as wing 111, and is used as a way to quantify how the transitioner improves the lift-to-drag ratio in any given area of a foil. A beneficial area is defined by (i) the beginning and end of an area where the lift force becomes greater than drag force, and vice versa, and (ii) where the drag force or lift force changes direction as compared to an adjacent beneficial area.

Referring now to FIG. 2E, suction surface 178 includes a beneficial area 10 that, under ideal conditions, would have (i) negative pressure (suction) located between transition point 9, which corresponds to leading edge 168, and transition point 11, (ii) negative pressure (suction) in a beneficial area 12, located between transition point 11 and transition point 13, and (iii) positive pressure in a beneficial area 14, located between transition point 13 and transition point 20 (which corresponds to trailing edge 174).

Pressure surface 182 includes a beneficial area 15 that, under ideal conditions, would have a (i) negative pressure (suction) located between transition point 9, which corresponds to leading edge 168, and transition point 16, (ii) positive pressure in a beneficial area 17 between transition point 16 and transition point 18, and (iii) positive pressure in a beneficial area 19 between transition point 18 and transition point 20, which corresponds to wing trailing edge 174.

Beneficial forces are defined as forces that increase the lift-to-drag ratio of the airfoil. Positive lift and negative drag are beneficial forces because they increase the lift-to-drag ratio. Negative lift and positive drag are detrimental forces because they decrease the lift-to-drag ratio.

### 1.2 Beneficial Areas—How They Work—FIG. 2E-2F

Referring now to FIG. 2F while still referring to FIGS. 2C and 2E, any pressure or suction on the wing 111 can be described as a series of forces acting normal (locally perpendicular) to the suction surface 178 and pressure surface 182. Any force applied to wing 111 can be broken into a lift component FL acting along the lift axis “L” in FIG. 2C in a direction that is perpendicular to the oncoming flow 1 (see FIG. 1) and a drag component FD acting along the drag axis “D” in FIG. 2C in a direction that is opposite to fluid flow 1.

The closer to perpendicular the normal force (i.e., force that is normal to the suction surface 178 or pressure surface 182) is to the oncoming flow 1, the greater the lift component of the normal force. Conversely, the smaller the angle between normal force and the oncoming fluid flow 1, the greater the drag component of the normal force.

Greater beneficial lift forces are experienced where normal forces create a lessor angle with the positive lift direction 2.

Greater beneficial drag forces are experienced where normal forces create a lessor angle in the opposite direction of positive drag direction 3.

For example, the angle between normal force 178-B and oncoming flow 1 (see FIG. 2C) is 85.5 degrees and the angle between normal force 178-C and oncoming flow 1 is 76 degrees. Because the angle of normal force 178-B is greater than the angle of normal force 178-C, the same force magnitude (suction) at each location will have a greater lift component FL of normal force 178-B than of normal force 178-C and a smaller drag component FD in the drag direction of normal force 178-B than of normal force 178-C. If the lift component is positive and is greater than the drag component, then the combined force is beneficial.

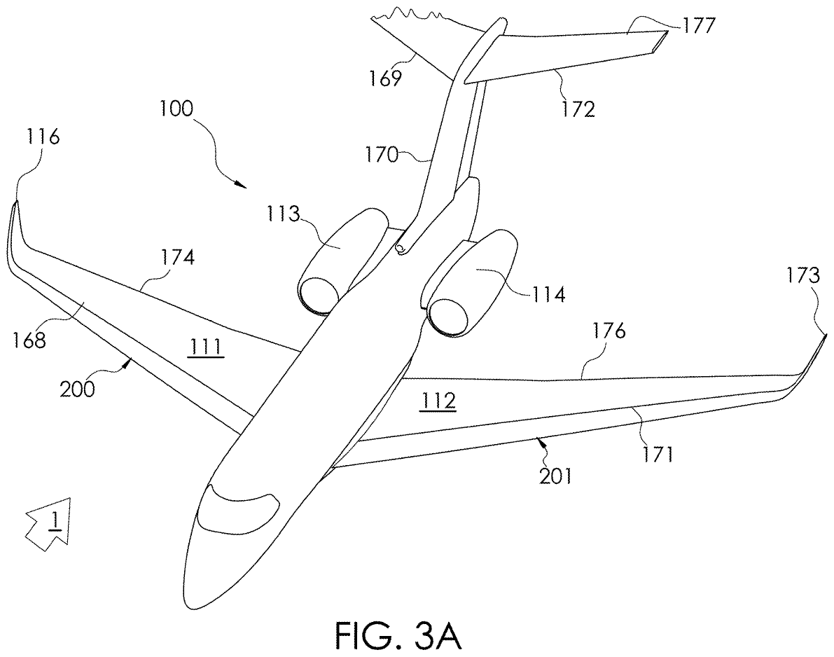

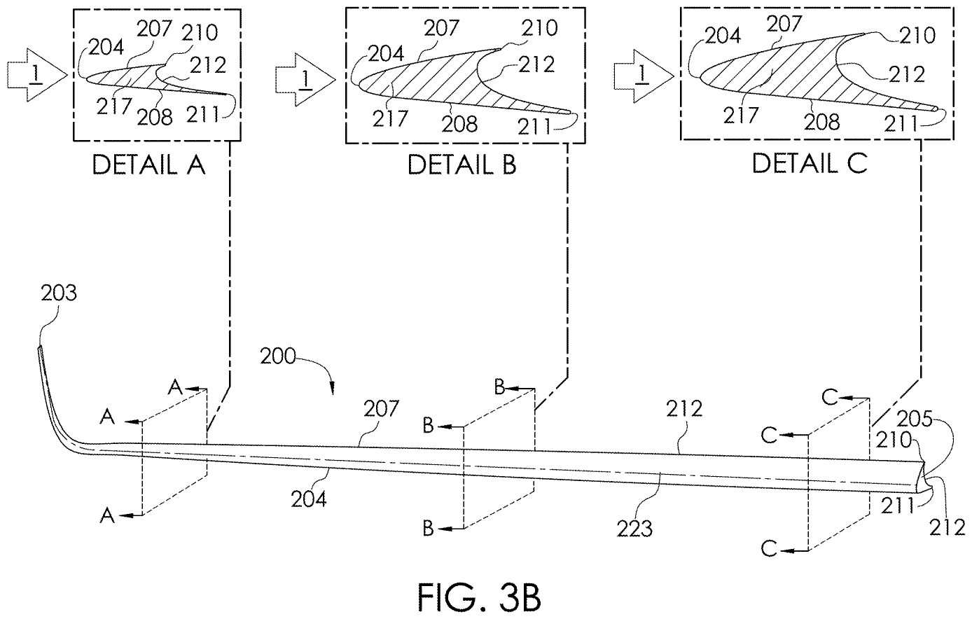

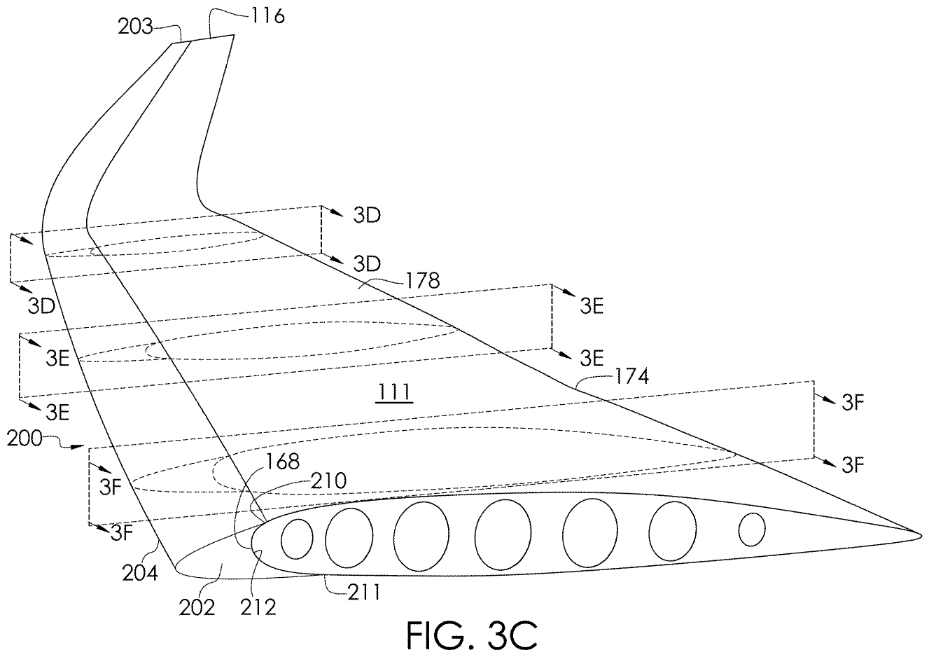

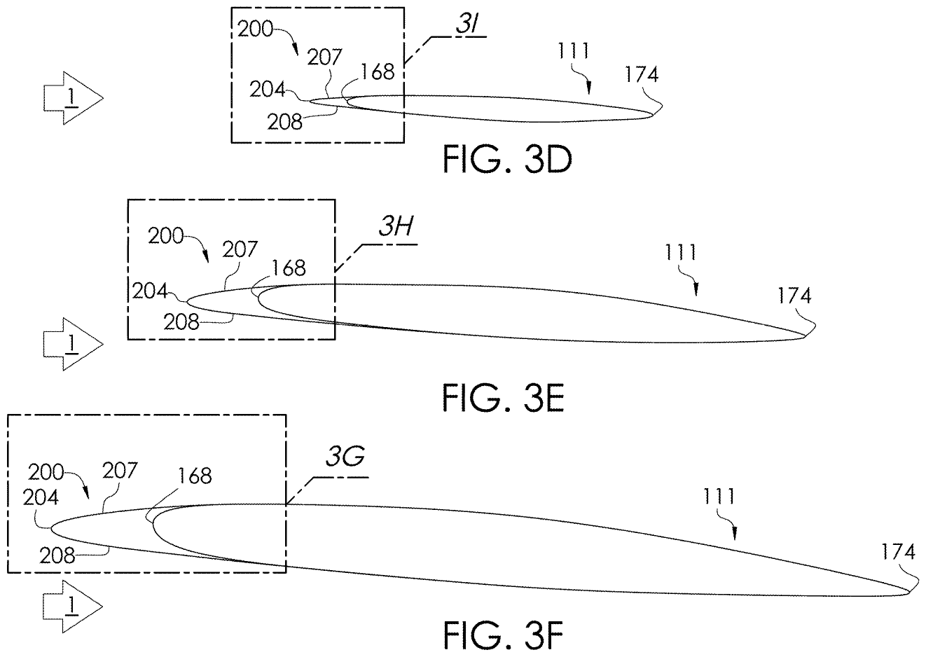

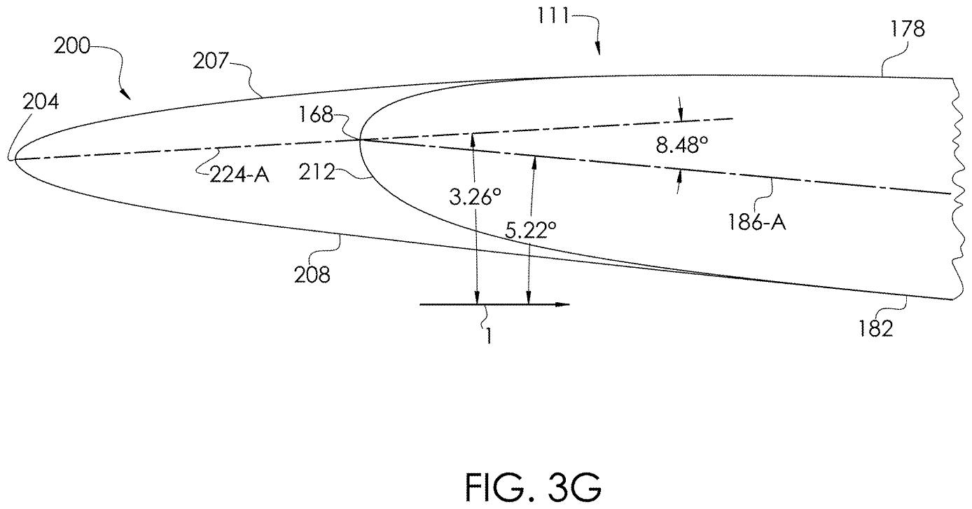

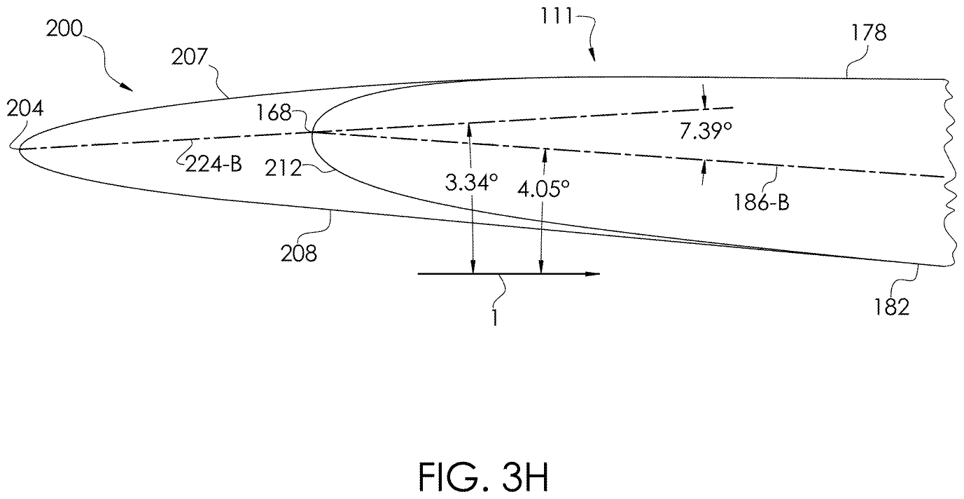

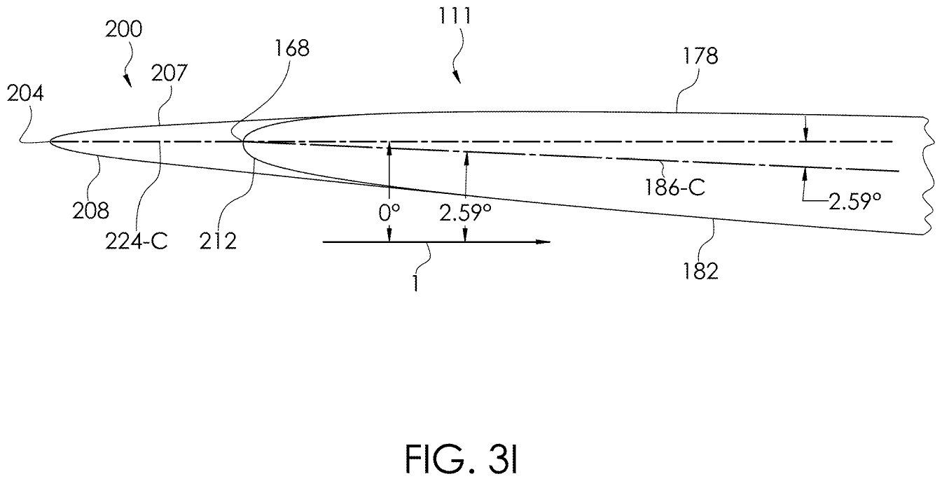

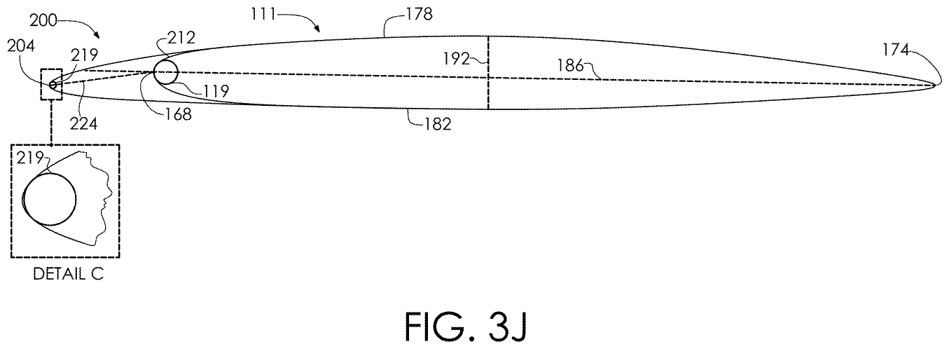

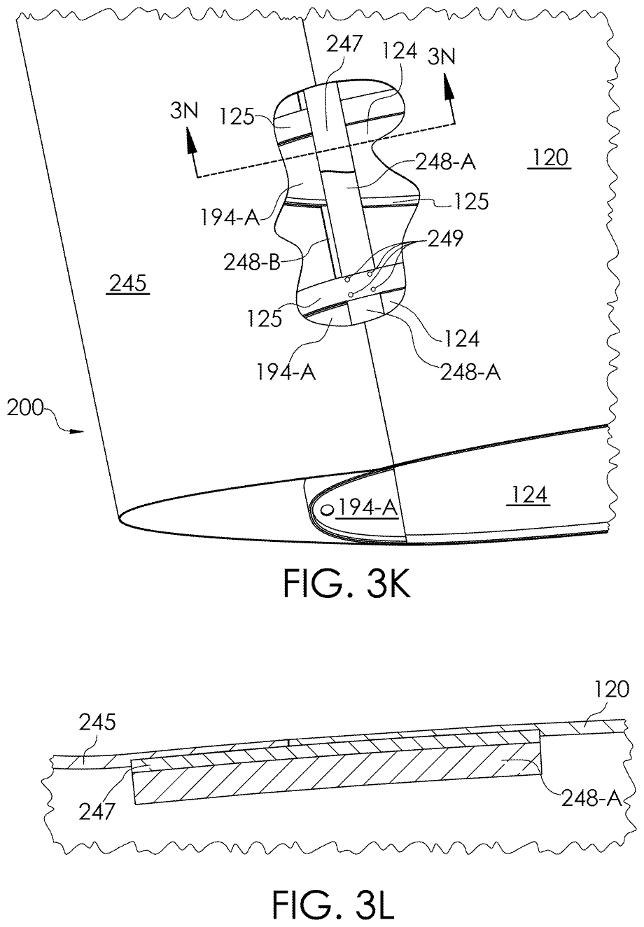

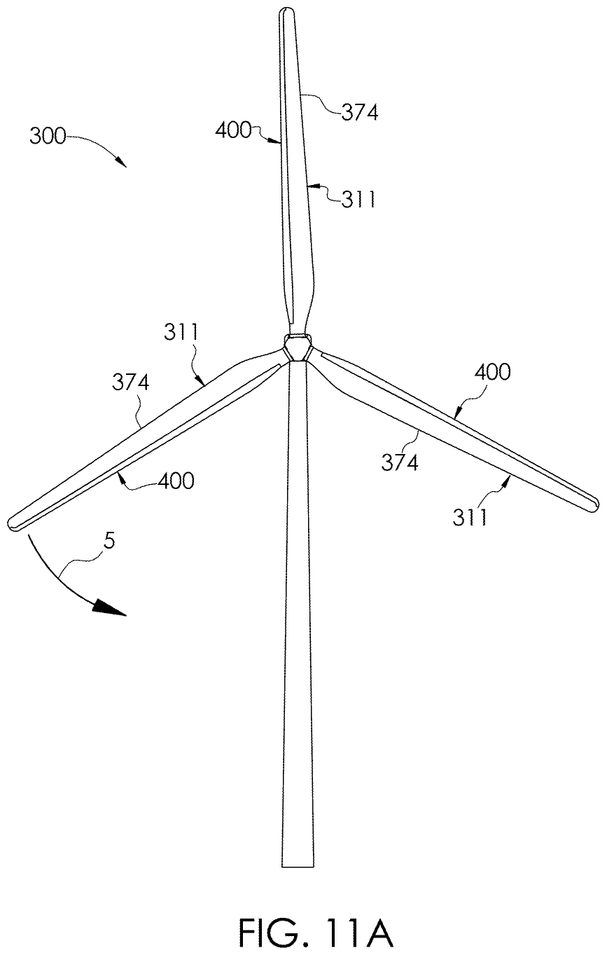

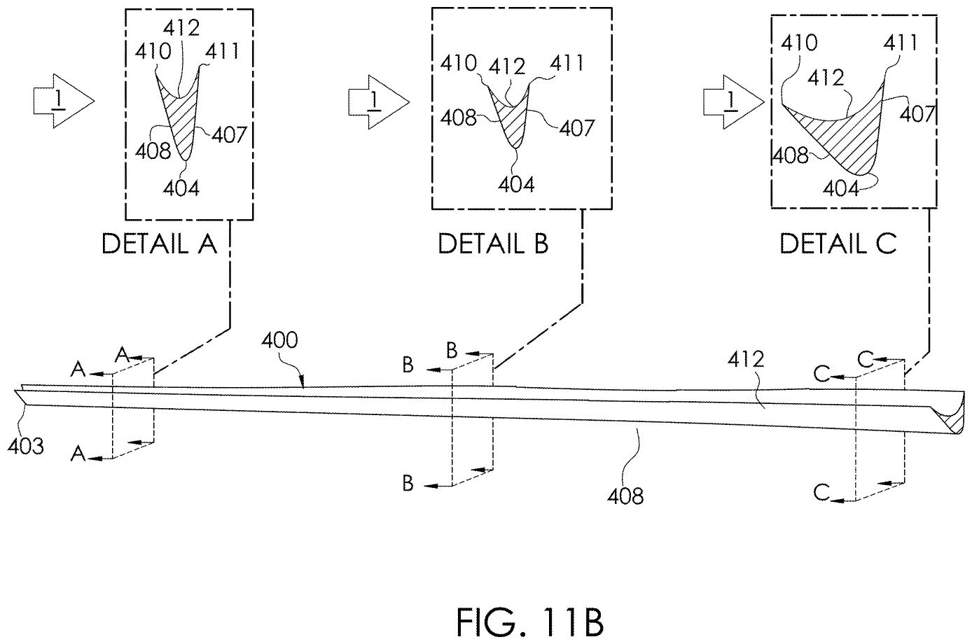

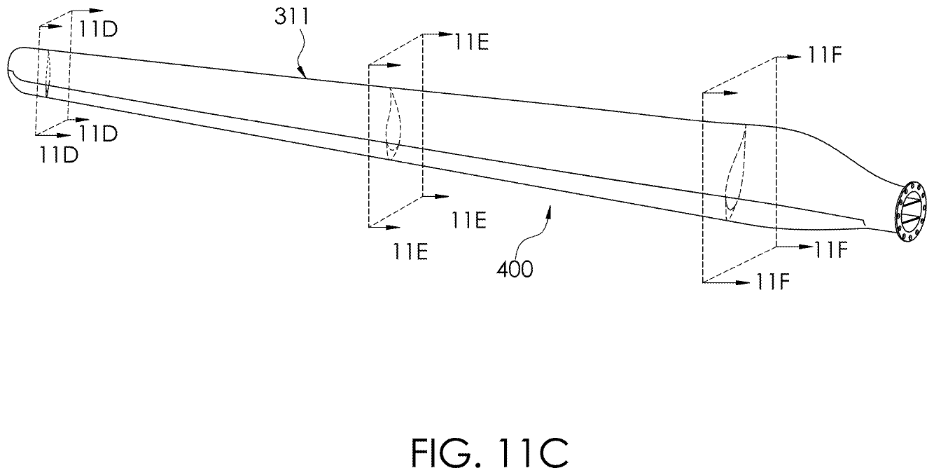

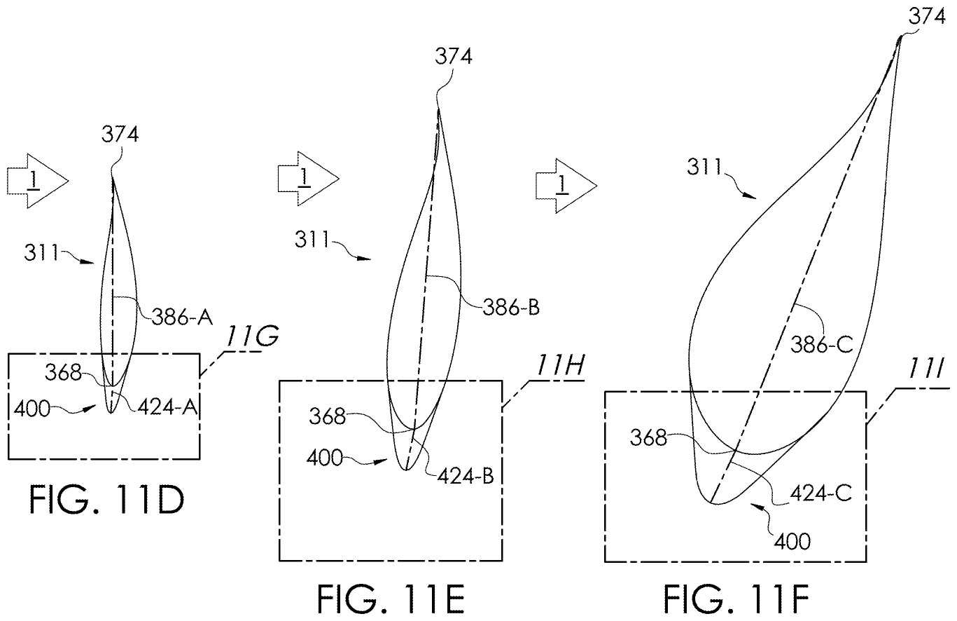

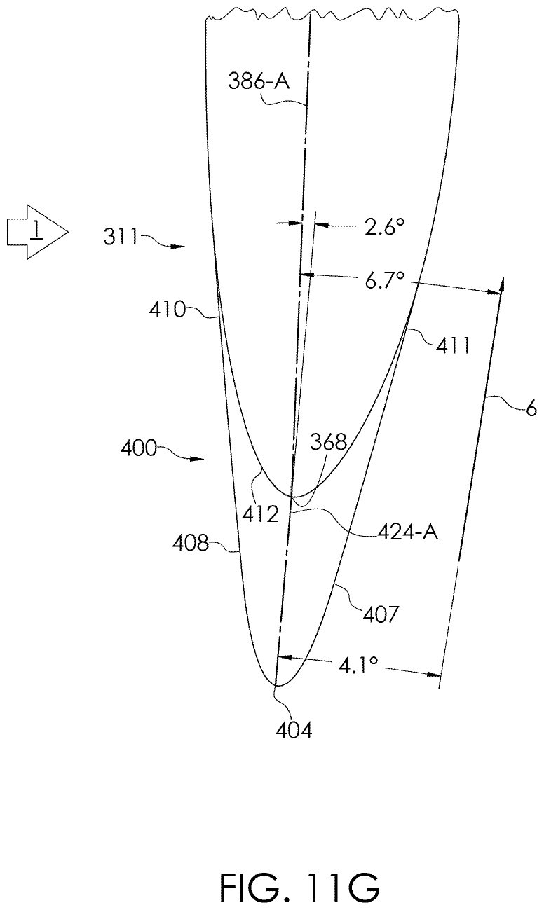

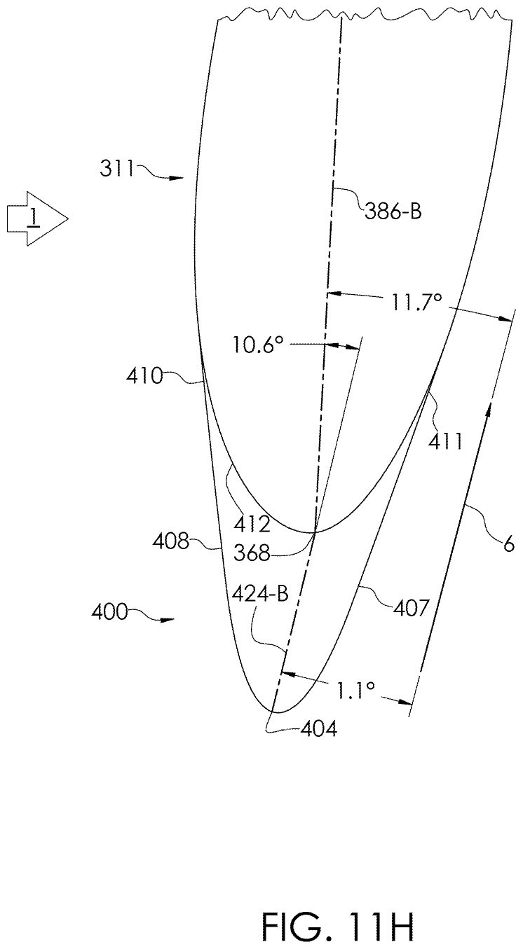

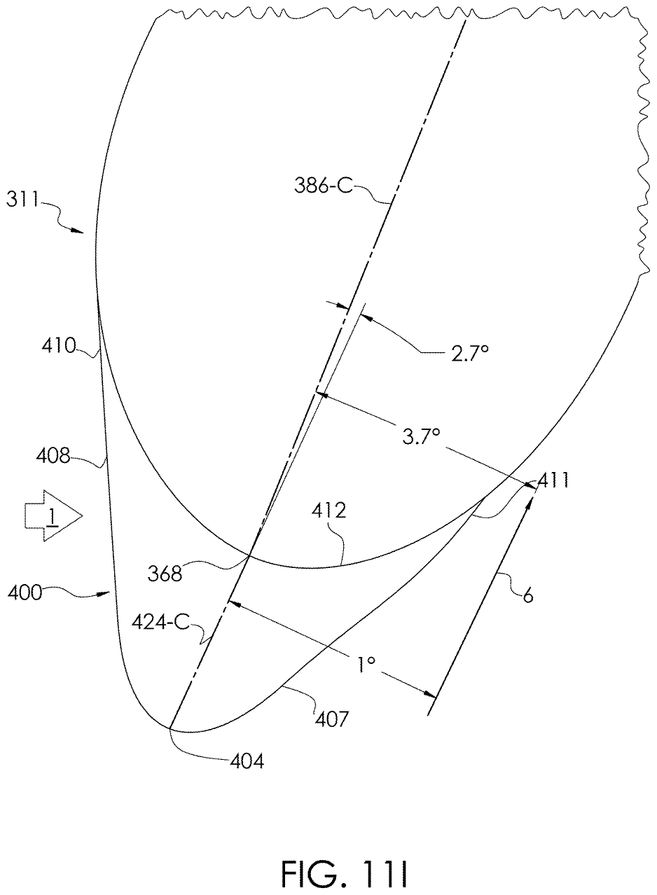

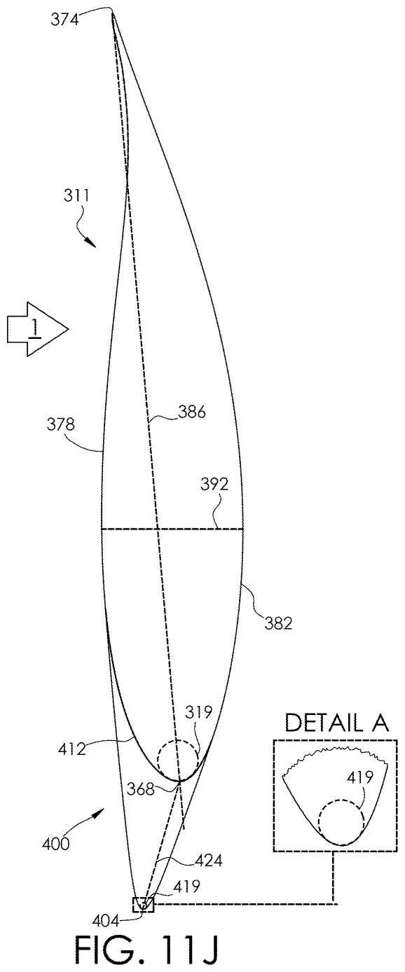

### 2. Flow Transitioner—General Overview—FIG. 3A, FIG. 11A, 16A

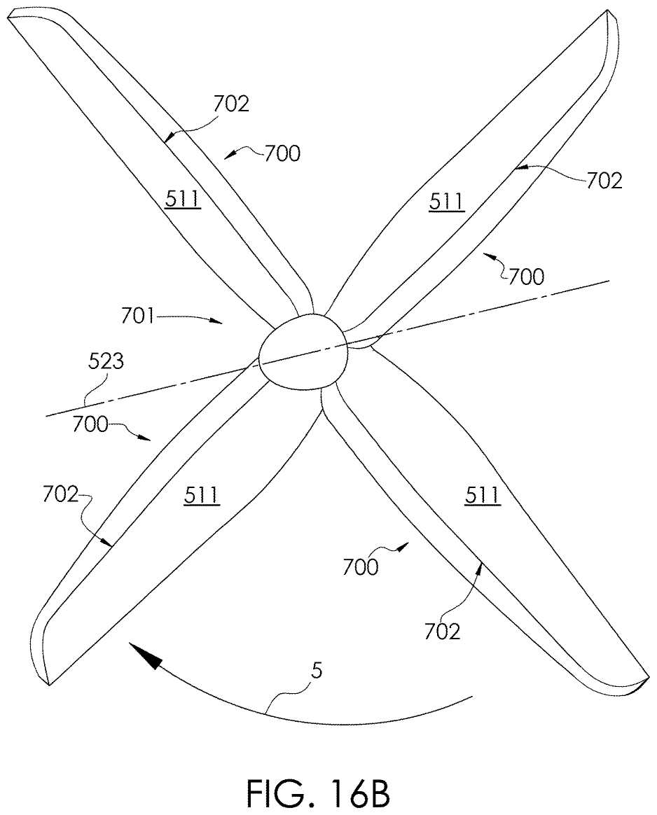

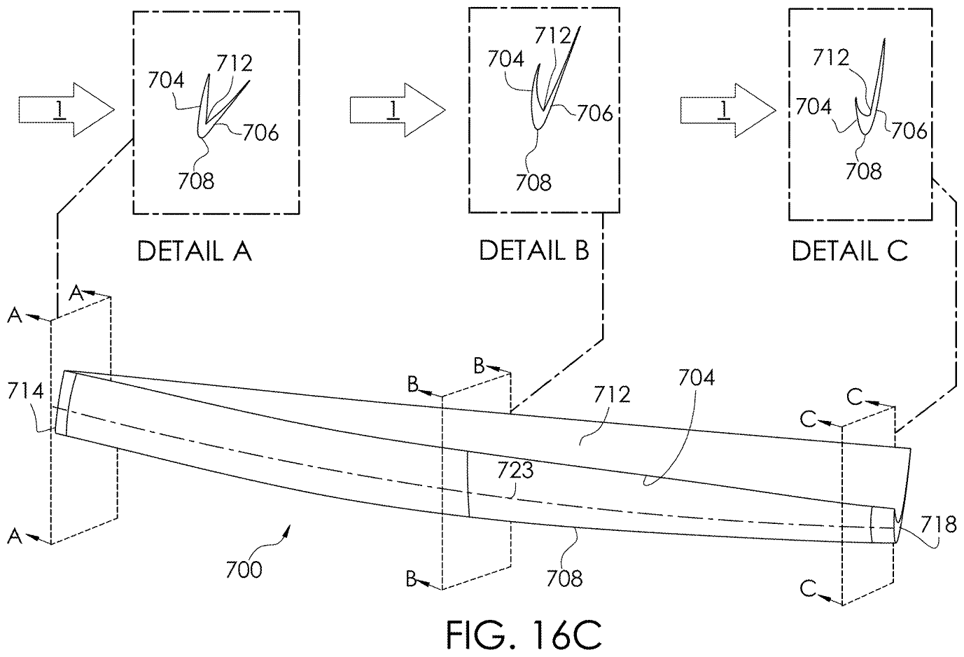

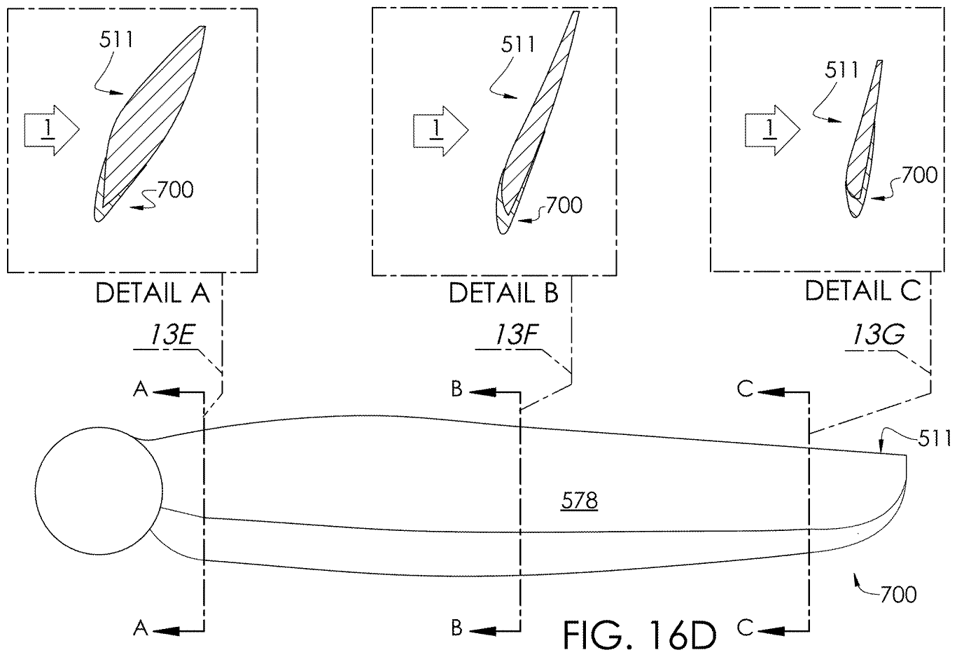

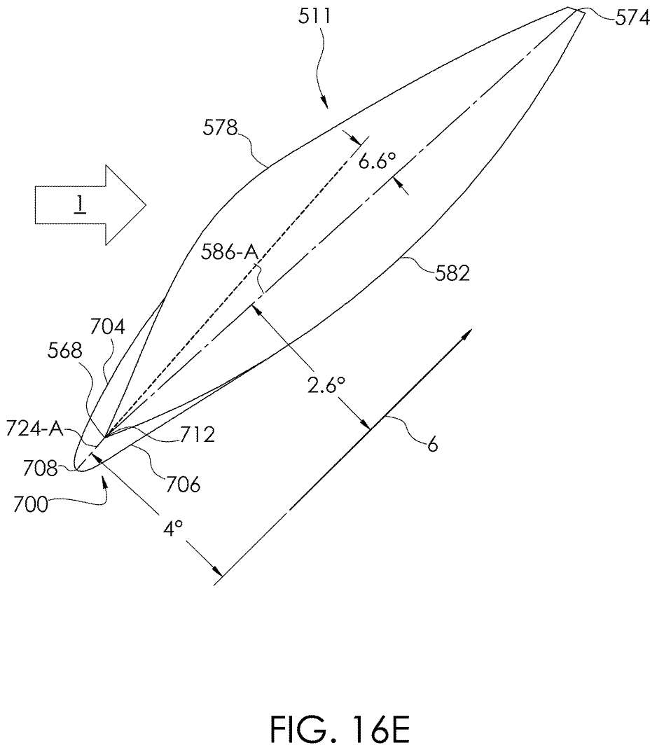

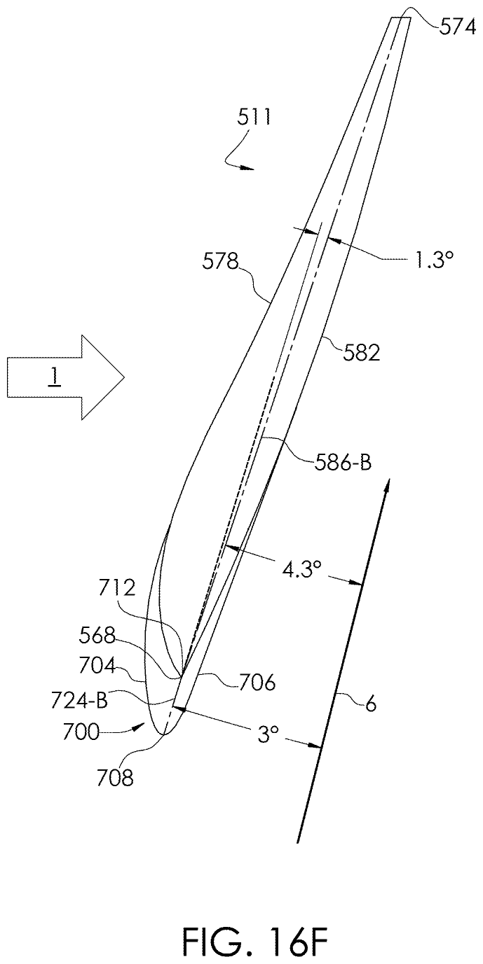

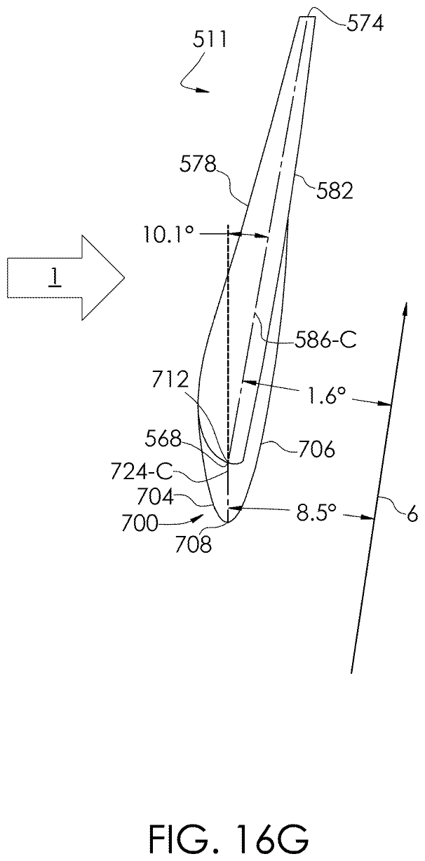

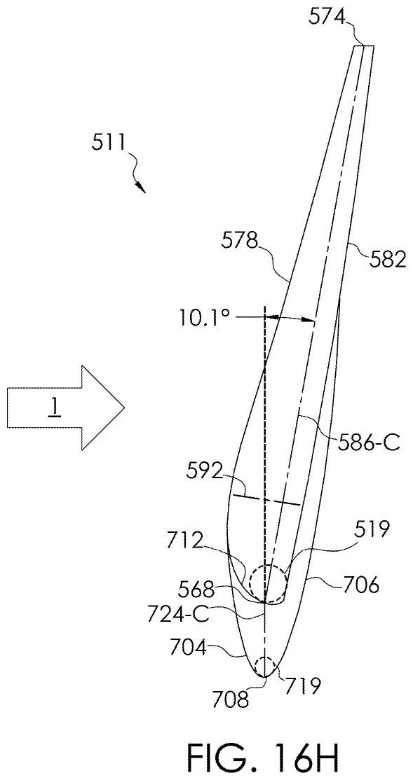

A flow transitioner 200 described herein works similarly, and may be configured similarly, on all foil types, including, without limitation, wings 111 and 112 and stabilizers 169 and 172 (see FIG. 3A), rotor blades 311 (see FIG. 11A), and propellor blades 511 (see FIG. 16A).

Transitioner 200 may be configured as an extension of the foil to which it is linked (see FIG. 3C), variable with variable angles of attack, pressure surface, suction surface, and chord length as described in Section 4.

Transitioner 200 may be configured along the entirety of wing 111 leading edge 168 area, or any portion or component thereof, including without limitation, any leading edge high lift devices i.e. leading-edge cuffs, slats and flaps.

Transitioner 200 may be constructed as a single unit, or be comprised of multiple sections that when assembled, comprise a single unit. Benefits of multiple sections include the ability to replace a damaged transitioner section as opposed to replacing an entire transitioner in the event it is physically damaged in any way thus reducing repair costs.

Referring now to FIG. 3A-3C, wings 111 and 112, and related transitioners 200 and 201, are intended to be mirror images of each respective part. For simplicity, the following descriptions with respect to wings will focus only on wing 111 and transitioner 200.

Unless otherwise stated herein, any combination of the following concepts, configurations and related figures are intended to be equally applicable to any foil type, including without limitation, aircraft and watercraft wings, stabilizers, and propellors, wind and hydro turbine blades, fan blades and compressor blades.

### 2.1 Location, Geometry and Orientation—FIG. 3A-3I

Referring now to FIG. 3A-3C, transitioner 200 is shown configured with its (i) leading edge 204 nearer the oncoming flow 1, then wing 111 leading edge 168, and (ii) trailing end 212 nesting with wing leading edge 168 area.

Referring now to FIG. 3B, transitioner 200 has a leading edge 204, suction surface 207, pressure surface 208, trailing end 212, root end 205 and tip end 203.

Suction surface 207 and pressure surface 208 may each have at least a portion that is straight, convex, concave or a combination thereof, are the working sections of the transitioner 200, and define an airfoil profile with a suction surface (or skyward surface) 207 and a pressure surface (or groundward surface) 208.

Core 217 may be solid as shown, may be open as described in Section 4, or a combination of open and solid at the designer's choice.

Transitioner 200 may have a twist along its spanwise distance 223 (see FIG. 3B) that is the same as or different than the twist, if any, of wing 111 (see FIG. 2A).

In this embodiment, trailing end 212 mirrors the shape of wing leading edge 168, its adjacent pressure surface 182, and suction surface 178.

### 2.2 Transitioner/Wing Assembly—Chord Detail—FIG. 3D-3I

Referring now to FIGS. 3D-3I, showing various profiles of an assembly comprising a flow transitioner 200 attached to a wing (a primary wing or primary foil) 111, improved lift-to-drag ratio of the wing is achieved for flight conditions at which transitioner chord lines 224-A, 224-B and 224-C (from the transitioner leading edge 204 to the wing leading edge 168) are (i) at a lessor angle of attack than the respective wing chord lines 186-A, 186-B and 186-C and/or more aligned with the oncoming fluid flow 1 than are respective wing chord lines 186-A, 186-B and 186-C. For example, referring now to FIG. 3G, wherein the transitioner chord line 224-A deviates from the wing chord line 186-A by 8.5 degrees, the transitioner chord line 224-A is at a 3.26 degree angle below the fluid flow 1, as opposed to the wing chord 186-A, which is at a 5.22 degree angle above the fluid flow 1. Thus, in the flight conditions illustrated in FIG. 3G, the transitioner chord line 224-A is more aligned with the fluid flow than is the wing chord line 186-A.

In cases where an improved lift-to-drag ratio is not desired, for example, to induce drag for rapidly decreasing airspeed, to reduce stopping distance upon landing, or other similar situations, or in other configurations or embodiments, transitioner chord lines 224-A, 224-B and 224-C could be (i) at a different angle of attack than the wing chord lines 186-A, 186-B and 186-C, where the transitioner chord line 224-A, 224-B and 224-C is oriented further above or below the wing chord line 186-A, 186-B and 186-C than is desired for improved lift-to-drag ratio, where the further the transitioner chord line is from the desired orientation, the greater the induced drag (see Section 4 below describing transitioners have a variable angle of attack) or same angle of attack as wing chord lines 186-A, 186-B and 186-C, and/or (ii) less aligned with the oncoming flow 1 than the respective wing chord lines 186-A, 186-B and 186-C.

### 2.3 Transitioner—Leading Edge End Detail—FIG. 3D-3K

Referring now to FIGS. 3J and 3K, while still referring now to FIGS. 3D-3I, the transitioner leading edge 204 end of transitioner 200 has a smaller nose circle 219 than the wing nose circle 119, and smaller angle between pressure surface 182 and suction surface 178 than the leading edge 168 end of wing 111 to which it is attached.

Transitioner 200 has a lessor thickness 272 at its mid-point along its chord line 224 than the wing maximum thickness 192.

### 2.4 Transitioner—Trailing End Detail—FIG. 3C

Referring now to FIG. 3C, in an embodiment, the shape of transitioner trailing end 212 of transitioner 200 mirrors the wing 111 leading-edge area of the wing to which it is attached. In an embodiment shown, an upper trailing edge 210 (i.e., a trailing edge of suction surface 207) and a lower trailing edge 211 (i.e., the trailing edge of pressure surface 208) of transitioner 200 are attached to the suction surface 178 and the pressure surface 182, respectively, of wing 111 to form a smooth transition to the wing 111.

In the embodiment shown, transitioner 200 may be adhered or mechanically fastened to wing 111 using common methods of attachment, including, without limitation, adhesives, and mechanical fasteners such as rivets and bolts.

### 2.5 Transitioner—Orientation and Geometric Relationships—FIGS. 3D-3J

The term “root” with respect to geometric relationships of foils attached to a body, such as a fuselage, means the end of the foil prior to it blending into such body, as shown as root end 158 of wing 111 (see FIG. 2A).

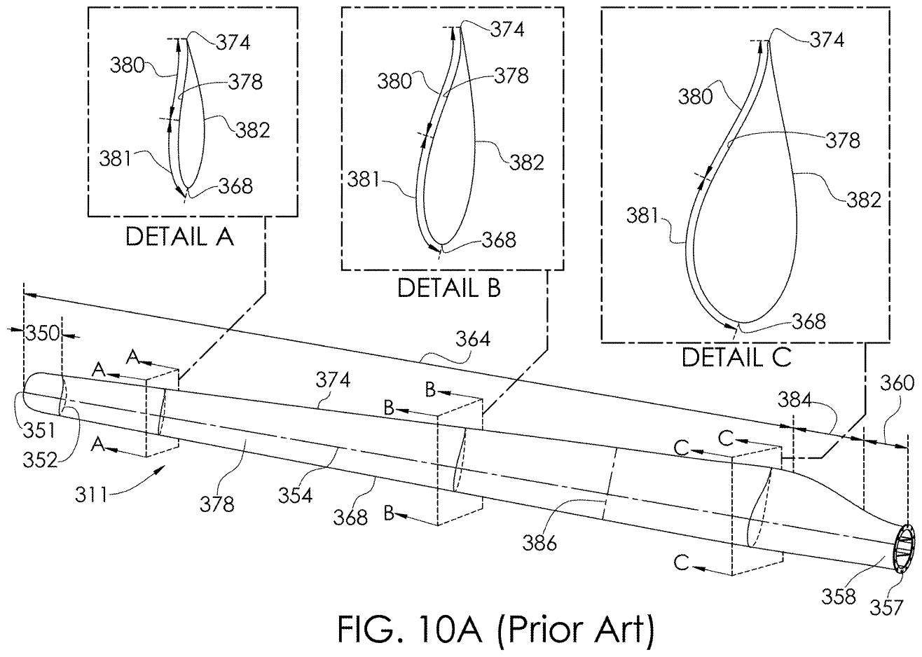

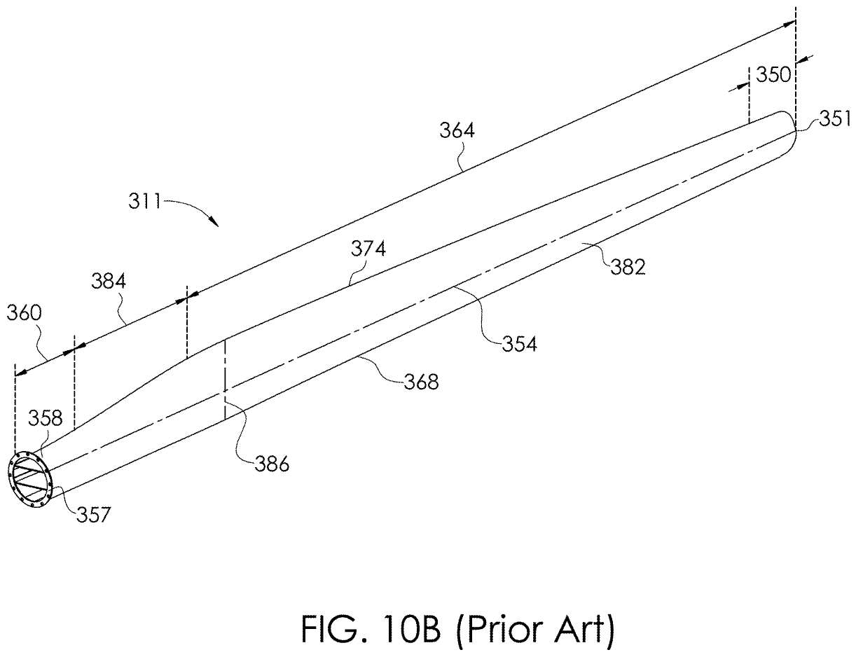

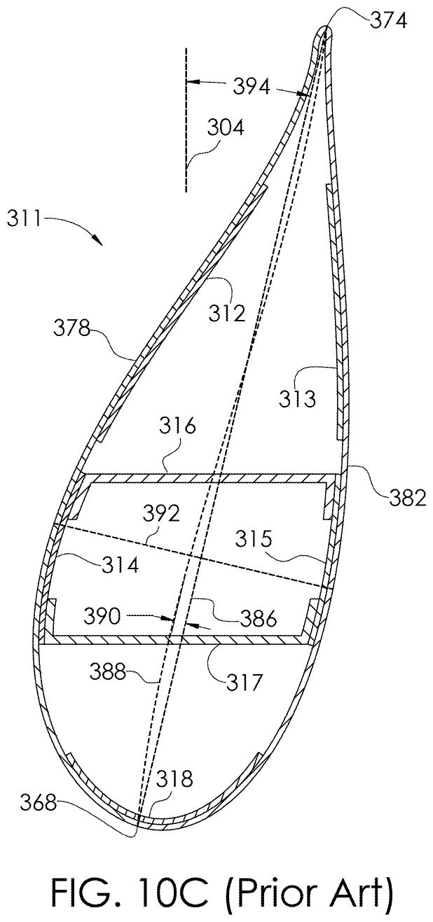

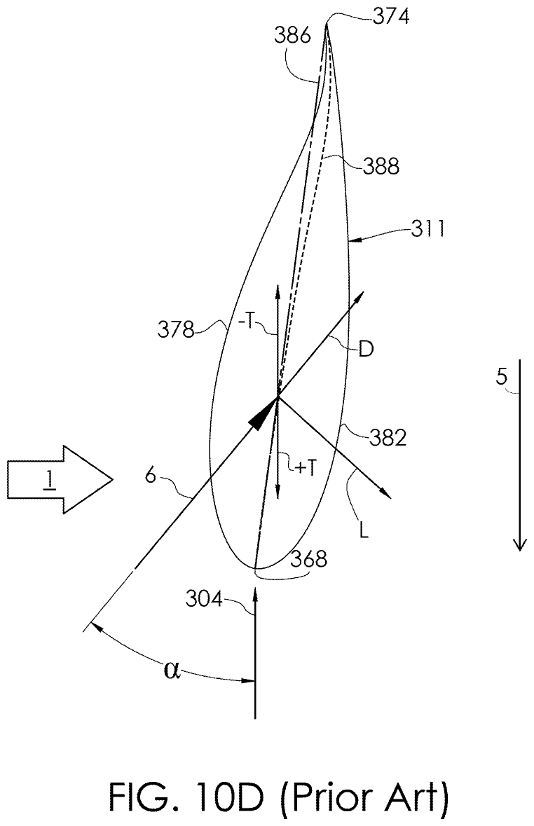

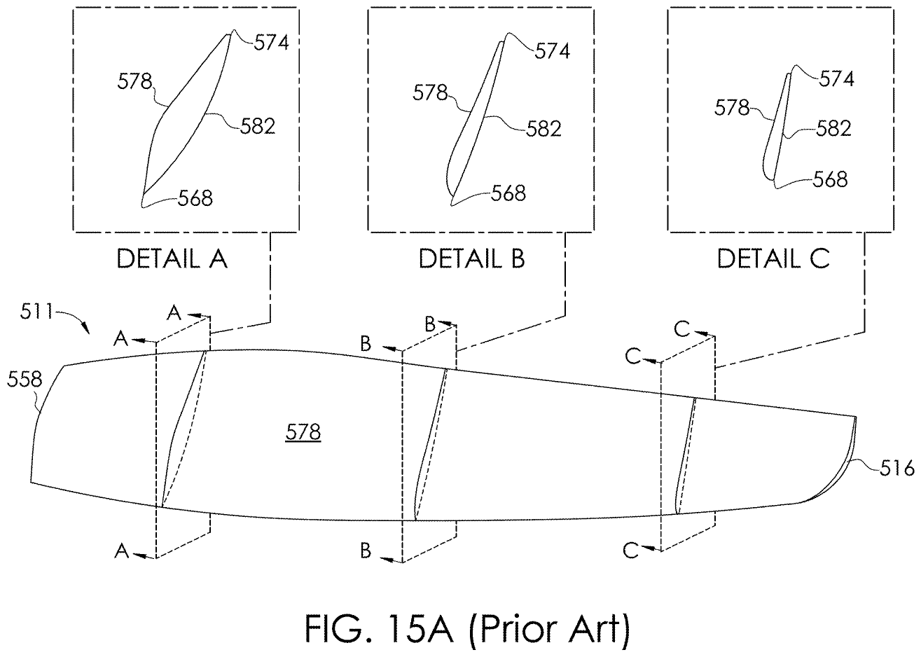

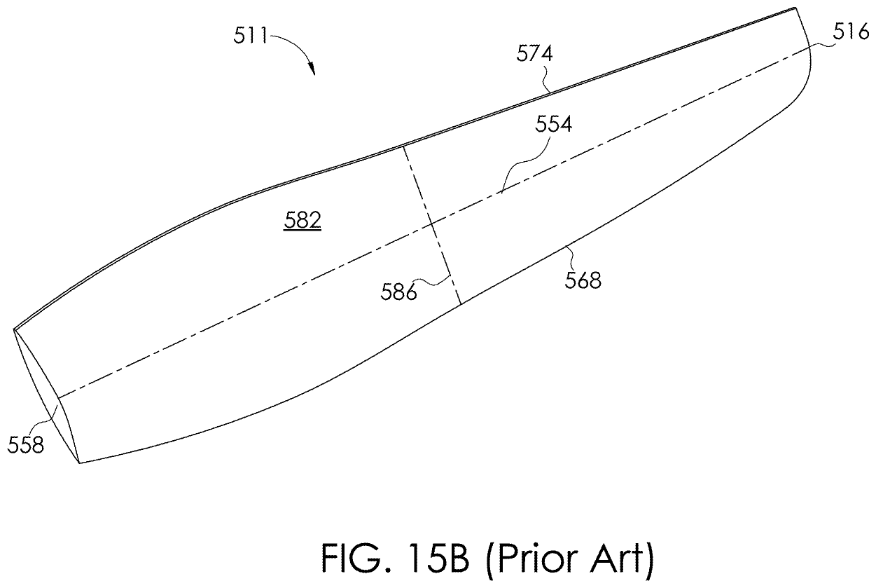

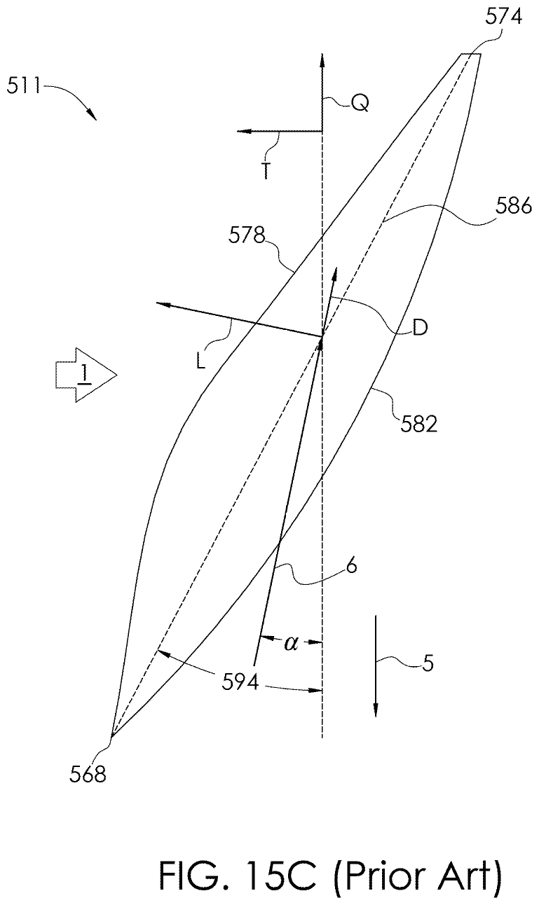

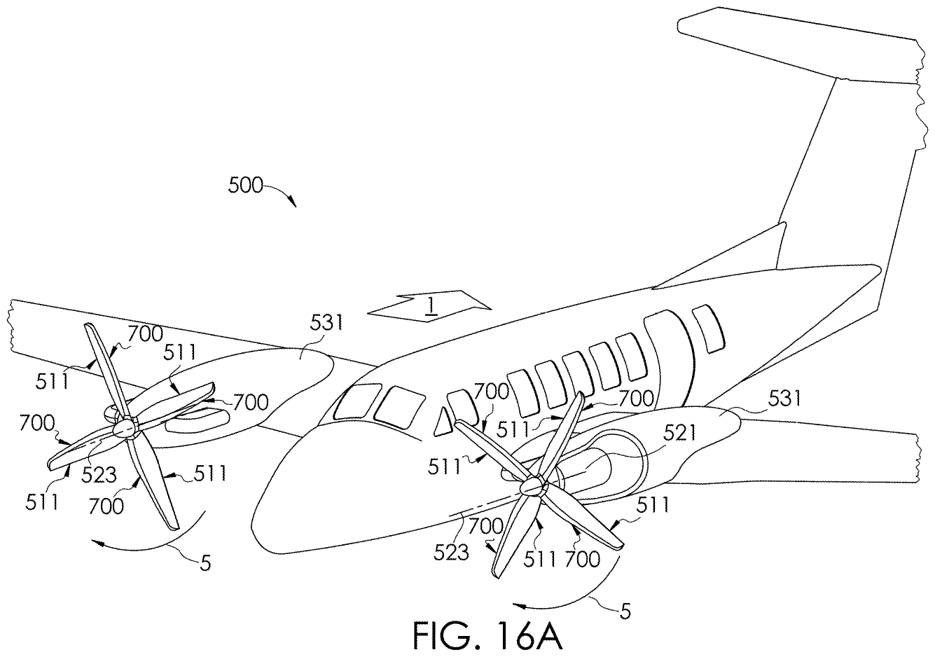

Different transitioner/wing profiles along their respective spanwise lengths are shown within this disclosure. For clarity, transitioner and wing chord line part numbers include a suffix, i.e., transitioner chord lines 224-A nearest the root, 224-B at the midpoint and 224-C at the tip. Likewise, wing chord lines 186-A nearest the root, 186-B at the midpoint and 186-C at the tip. For simplicity, in instances where the chord location along the span can be described generically, the wing chord line and transitioner chord line are identified without a suffix as 186 and 224, respectively. This same nomenclature is used elsewhere in this disclosure in describing the turbine blade chord line 386 (FIGS. 10A-10D), turbine blade transitioner chord line 424 (FIGS. 11D-11J), propellor blade chord line 586 (FIGS. 15B-15C), and propellor transitioner chord line 724 (FIGS. 16E-16G).

Referring now to FIGS. 3D-3I, wing transitioner 200 chord angle is more aligned with the oncoming fluid flow 1 over the spanwise distance 154 (see FIG. 2B) of wing 111 than is the wing chord line 186 (see FIGS. 3G-3I) when an increase in the lift-to-drag ratio is desired. For example, referring to FIG. 3G, wing chord line 186-A is at a 5.22 degree angle above the oncoming fluid flow 1, as compared to transitioner chord line 224-A, which is at a 3.26 degree angle below the oncoming fluid flow 1. The transitioner chord angle may be greater than, less than, or equal to the wing chord angle when additional drag is desired, for example when using a transitioner having a variable angle of attack (see Section 4), for example during braking.

In other embodiments, wing transitioner chord 224 angle may be more aligned with oncoming fluid flow 1 over at least a portion of the spanwise distance 154 (see FIG. 2B) of wing 111 than is the wing chord 186 angle (see FIGS. 3G-3I) when a transitioner is configured over a portion of the wingspan, e.g., the transitioner 200 ending prior to a winglet 117 (See FIG. 2A) or is otherwise positioned over less than the entire wingspan.

FIG. 3J shows reference measurements 119, 219 and 192 that define a configuration of a profile of wing assembly 111 benefitted by a transitioner 200. Reference measurement 219 is a leading edge diameter (or radius) of a nose circle defining a leading edge 204 of transitioner 200, the magnitude of which may be characterized as a fraction or percentage of wing 111 nose circle diameter 119 and wing maximum thickness 192.

CFD analysis to date demonstrates that improvement in the lift-to-drag ratio over wing 111 occurs when a wing benefitted by a transitioner, such as transitioner assembly 200, has a transitioner profile shape located nearest the root 158 (see FIG. 2B) defined by the relationship between the transitioner chord length 224 as a percentage of the wing chord length 186, or transitioner nose circle diameter 219 as percentage of the wing nose circle diameter 119, or the transitioner nose circle diameter 219 as a percentage of the wing maximum thickness 192 falling within the ranges that follow.

Transitioner chord 224 at the wing root 158 (see FIG. 2B) may be 5% to 18%, 6% to 17%, 6.5% to 16% or 7% to 15% of the wing chord 186.

Transitioner nose circle diameter 219 may be 1% to 70%, 3% to 65%, 5% to 60%, or 7% to 55% of wing nose circle 119, or transitioner nose circle diameter 219 may be 5% to 55%, 6% to 52.5%, 6.5% to 50%, or 7% to 47.5% of wing maximum thickness 192.

Ranges of reference measurement values and locations listed herein are for a transitioner 200 profile coupled to a wing 111 profile located at the root 158 of the wing 111 (see FIG. 2B) or any location along the span.

In the embodiment shown in FIG. 3J, the transitioner chord line 224 is more aligned with the oncoming fluid flow 1 than the wing chord line 186 in all instances where an increase in the lift-to-drag ratio is desired.

### 2.6 Transitioner—Air and Watertight Detail

Referring now to FIGS. 3M and 3N, in an embodiment, a seal 247 is located between transitioner skin 245, a wing skin 120 and a wing rib flanges 125. Seal 247 may be continuous and captured between a seal plate 248-A on the suction side, and seal plate 248-B on the pressure side, along the wingspan between adjacent rib flanges 125, thus making an air and watertight seal between any transitioner 200 embodiment, i.e. 200, 200-A, 200-B, etc. and wing 111 along any portion of wing 111 configured with a transitioner 200 embodiment.

It should be noted that the air and watertight sealed design of transitioner 200, alternate embodiments, and the installation of it as described herein result in a shared air space within the transitioner and the foil to which it is attached. This configuration permits any heat within the foil provided by engine bleed air, electric heating elements or other means can be shared with the transitioner internal space, thus reducing icing concerns. Additionally, the open internal space design of the transitioner (skin over ribs or similar structures) accommodates additional heating components commonly used in aviation, including, but not limited to, electrical heating elements and Tecalemit-Kilfrost-Sheepbridge Stokes technology (TKS system).

### 3. Transitioner/Wing Assembly—Working Principals and Flow Simulation Results

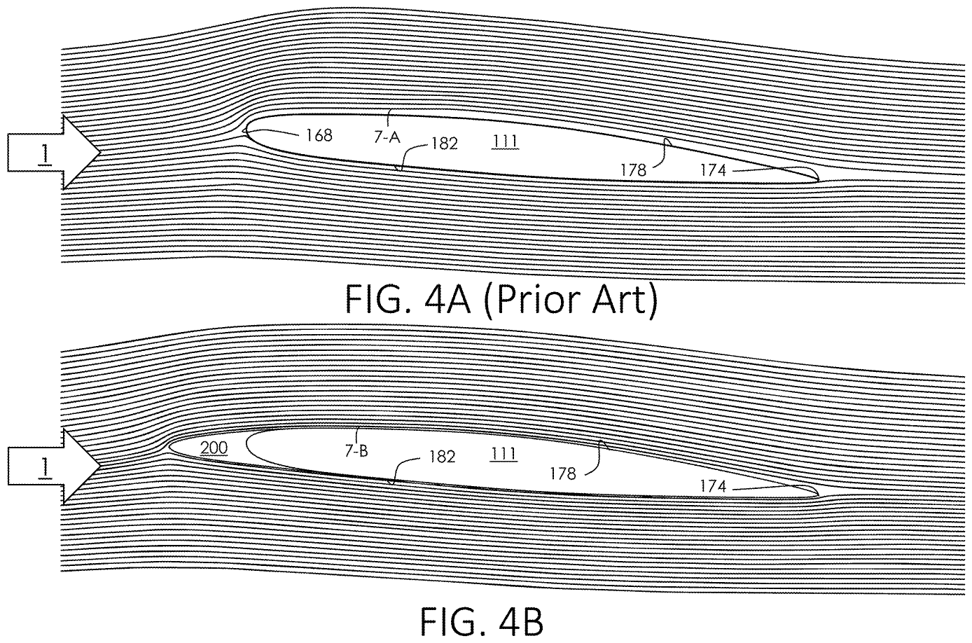

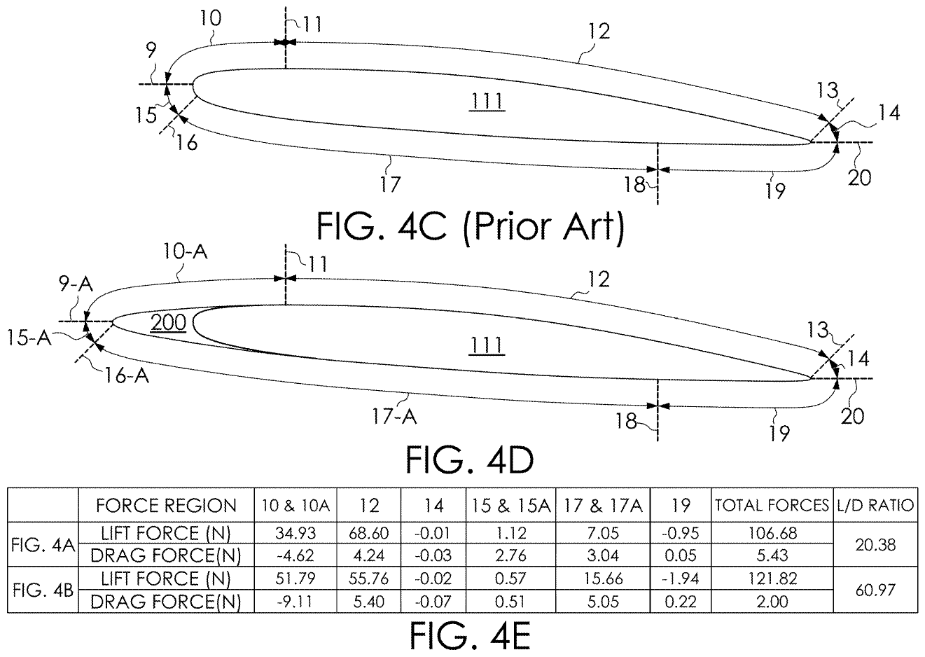

Referring now to FIGS. 4A and 4B, flow transitioner 200 works by transitioning the oncoming fluid flow 1, from its initial trajectory that is misaligned with the wing chord line 186 by angle α (see FIG. 2C), to a local flow trajectory over the wing 111 that is more aligned with the wing 111. CFD analysis shows a relationship exists between the more closely aligned the local fluid flow trajectory is to the wing chord line 186, the less drag is induced on the majority of the wing 111 surfaces, including the leading edge 168 area, pressure surface 182, and suction surface 178.

### 3.1 Fluid Flow and Forces at Mach 0.7—FIGS. 4A-4E

FIG. 4A shows a wing 111 in straight and level flight at Mach 0.7. CFD analysis shows the wing 111 without the benefit of a transitioner 200, flying at Mach 0.70 exhibits separation along the majority of the suction surface 178 as seen by distance 7-A between suction surface 178 and the nearest flow trajectory line.

Referring now to FIG. 4B while still referring to FIG. 4A, CFD analysis shows the same wing 111 in straight and level flight at Mach 0.7 with the benefit of flow transitioner 200 has a reduction of separation over the majority of suction surface 178, as seen by the smaller distance 7-B between suction surface 178 and the nearest flow trajectory line, as compared to the larger distance 7-A between suction surface 178 and the nearest flow trajectory line of the wing 111 that is not benefited by transitioner 200 (see FIG. 4A).

Referring now to FIGS. 4C, 4D and 4E, while still referring to FIGS. 4A and 4B, CFD analysis results of lift and drag forces on the beneficial areas 10, 12, 14, 15, 17, 19 (see Subsections 1.1-1.2) on a profile near the root are shown in the table data. An overall increase in the L/D ratio of wing 111 profile benefitted by the transitioner of 300% is observed running SolidWorks Flow Simulation CFD software and was verified by an independent CFD expert running Ansys Fluent software. An increase in performance (increased lift and/or reduced drag) is observed in most of the beneficial areas of the wing 111 benefited by the transitioner 200 (FIG. 4D) as compared to the wing 111 that is not benefitted by the transitioner (FIG. 4C). For example, in beneficial area 10 of the wing 111 not benefitted by flow transitioner 200 (FIG. 4C), the drag force FD (see FIG. 2F) is −2.90 N, and in beneficial area 10-A of the wing benefited by flow transitioner 200 (FIG. 4D) the drag force FD (see FIG. 2F) is −4.15 N. The greater negative drag force FD (relative to the “D” axis in FIG. 2C) in beneficial area 10-A as compared to beneficial area 10 corresponds to a greater force assisting forward movement of the wing 111 with flow transitioner 200 than without the flow transitioner.

### ALTERNATE EMBODIMENTS

All possible combinations of elements and components of alternate embodiments are contemplated and considered to be part of this disclosure. It should be appreciated that all combinations of the concepts and additional concepts discussed in greater detail herein (provided such concepts are not mutually inconsistent) are contemplated as being part of the inventive subject matter described herein.

### 4. Variable Transitioner—Wing Assembly

Alternate embodiments described herein may be used in any (i) fluid type, i.e., air and water, and (ii) combination with any foil type or alternate embodiments thereof, i.e., a wing with a transitioner that includes variable pressure and suction surfaces combined with a variable diameter nose circle on any foil type irrespective of the drawing or text that describes such alternate embodiment.

Transitioners may embody components that enable (i) changing the transitioner angle of attack relative to the wing angle of attack and/or oncoming fluid flow, (ii) changing the curvature of the transitioner pressure and suction surfaces whereby the surface curvatures are changed inversely to each other, i.e., as the pressure surface curvature increases, the suction surface curvature decreases, (iii) independently changing the pressure and suction surface curvature irrespective of the curvature of the opposite surface, (iv) varying the chord length, and (v) varying the nose circle diameter, all as further described below.

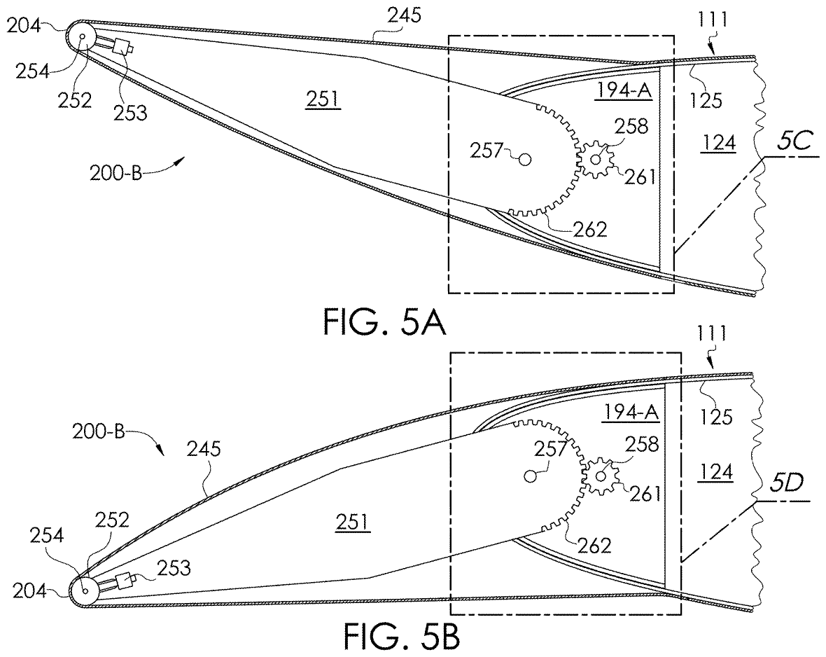

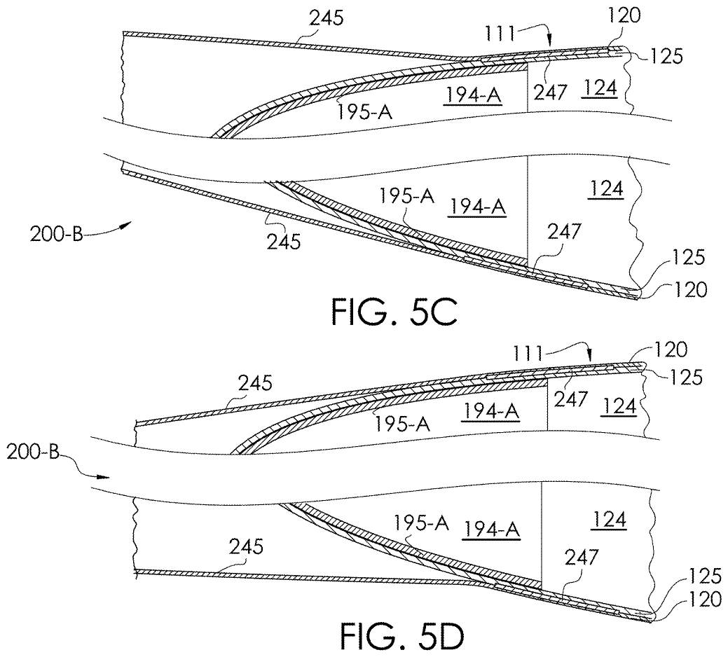

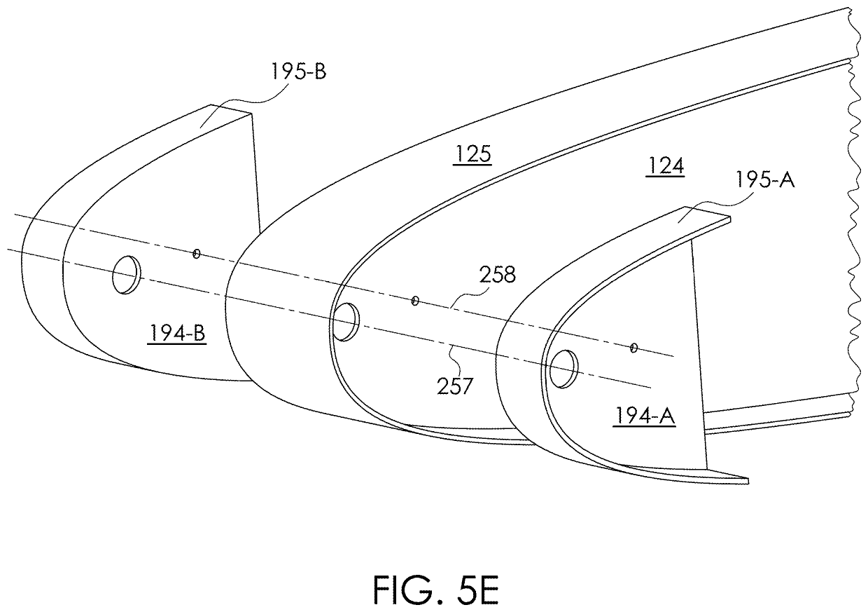

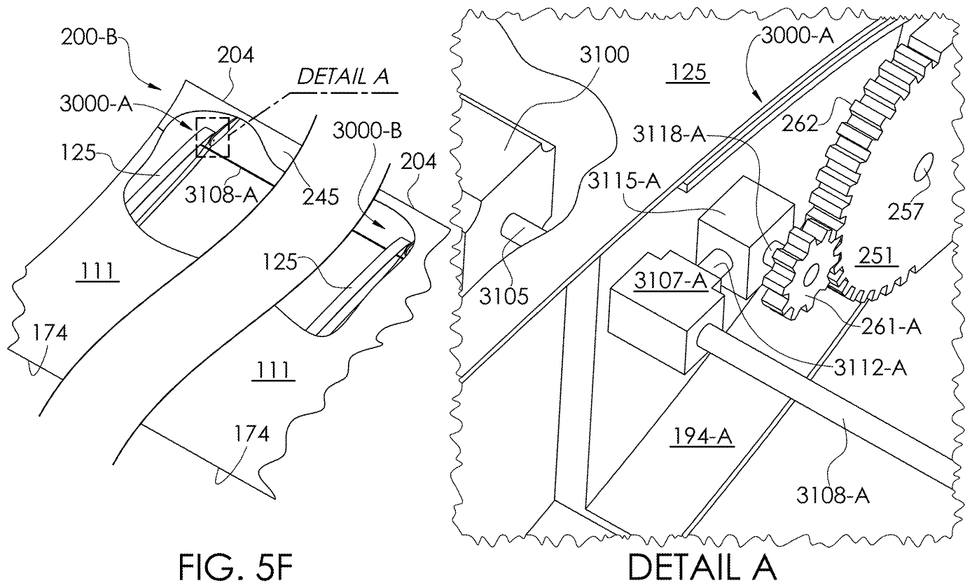

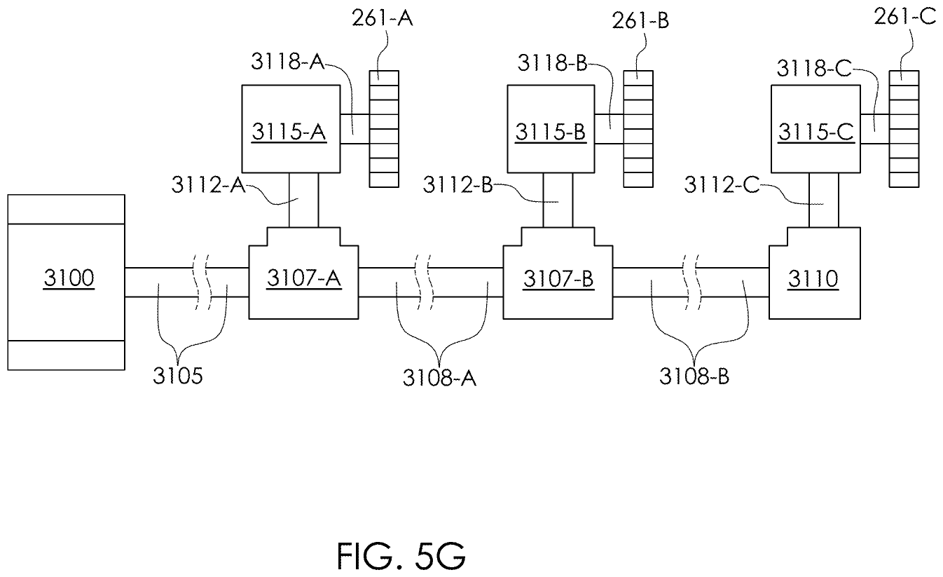

### 4.1 Variable Angle of Attack—FIGS. 5A-5G

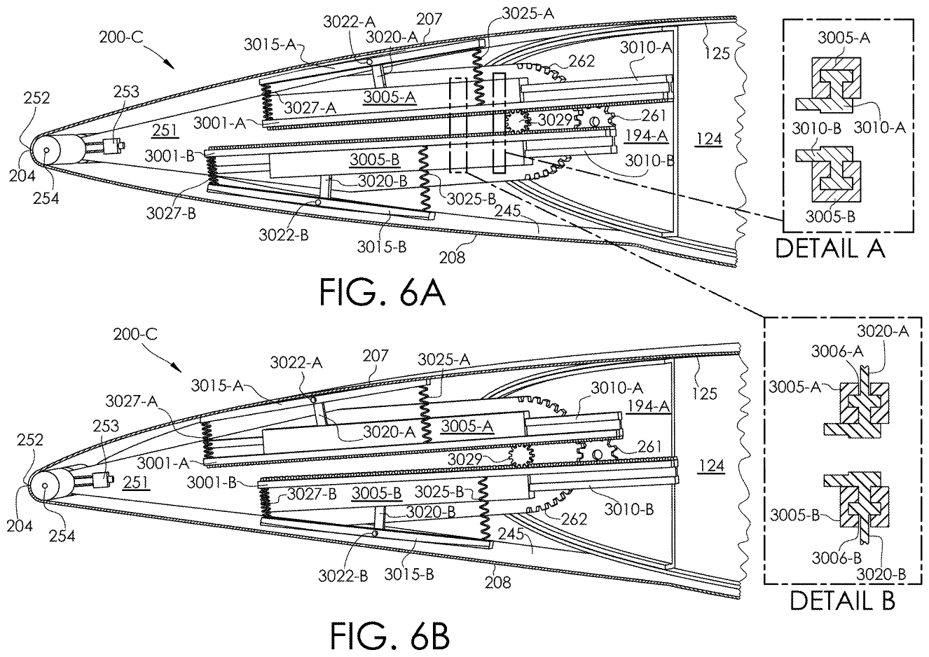

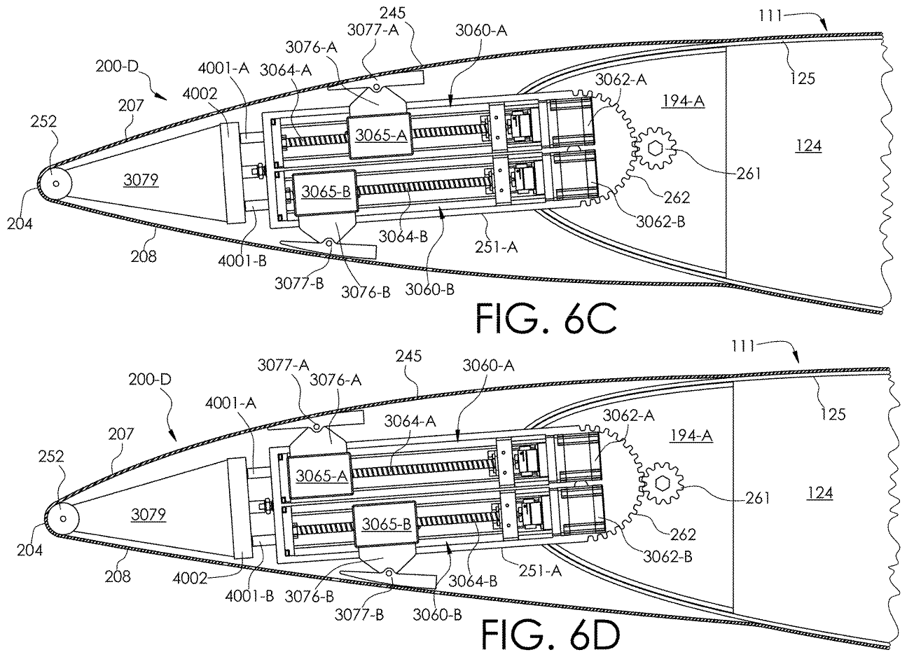

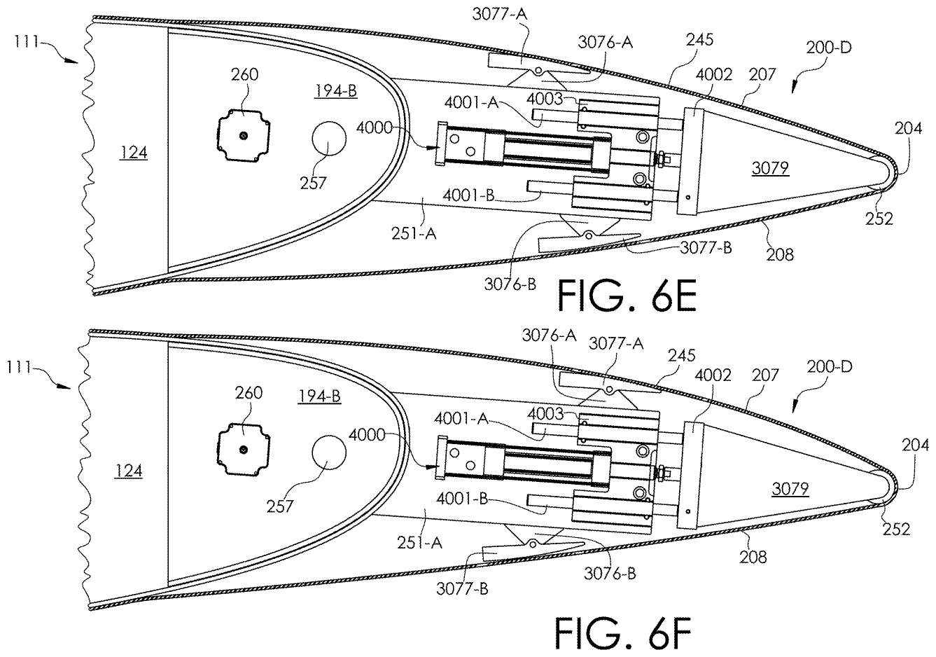

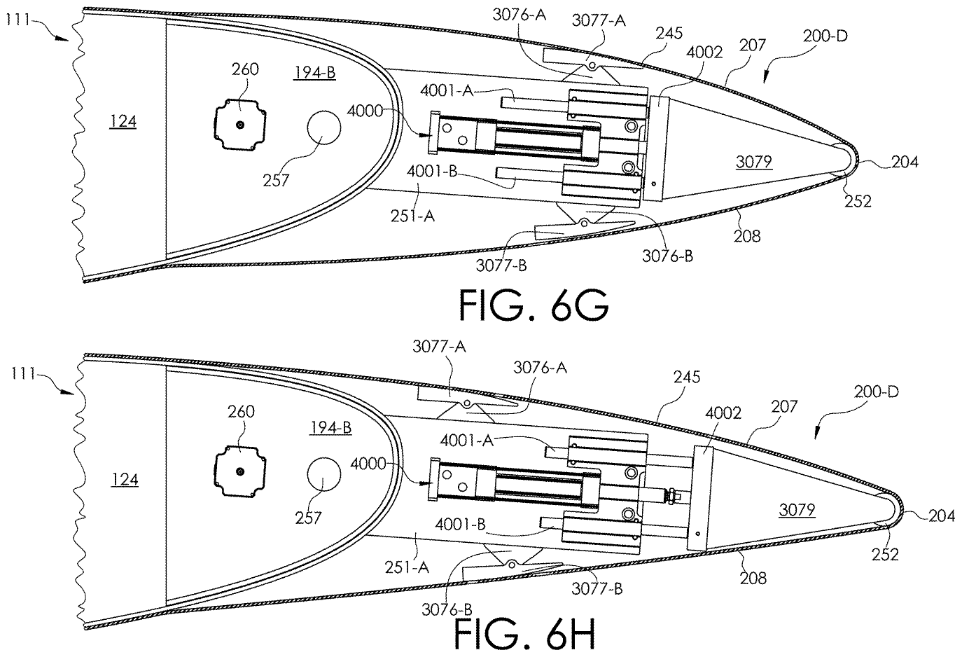

FIGS. 5A and 5B show an embodiment of a variable angle flow transitioner 200-B for which an angle of attack of the transitioner 200-B relative to the wing 111 angle of attack is variable. The transitioner is shown in FIG. 5A in its fully retracted position, with its leading edge 204 angled above the transitioner pivot point 258. The transitioner is shown in FIG. 5B in its fully extended position, with its leading edge 204 angled below the transitioner pivot point 258. The assembly of transitioner 200-B shown in FIGS. 5A and 5B may be repeated at multiple locations along the spanwise distance 223 (see FIG. 3B) of the transitioner. Multiple variable angle flow transitioners may be operably coupled to and driven by a single motor as described below. Powered movement of variable angle flow transitioner 200-B is driven by a variable transitioner angle system (“VTAS”) including a motor 260 (see FIG. 6E), a motor gear 261 powered by motor 260, a support 251 pivotably coupled to the wing, a gear section 262 on an end of support 251, a roller 252, and a tensioner 253.

Motor 260 rotates motor gear 261, which meshes with gear section 262 to rotate support 251, which is pivotably coupled to the wing, e.g., to a wing rib 124, about pivot point 257. In one example, pivot point 257 comprises a shaft that penetrates a reinforcement 194-A (see FIG. 5E) within the wing, as further described below. As support 251 moves through its range of motion, thus changing the angle of attack of transitioner 200-B relative to the wing or other foil, tensioner 253 may be provided to maintain pressure against roller 252 which rotates about axis 254 to maintain a desired tension in a skin 245 extending from the suction side of the transitioner, around the roller 252, and to the pressure surface of the transitioner. A line connecting pivot point 257 and roller axis 254 defines a chord line of the transitioner 200-B. In other embodiments, alternative mechanisms may be provided to effect powered rotation (pivoting) of the support 251.

Pivot point 257, gear 261, and motor 260 may also be configured to be supported by a structure coupled to any other support structure within wing 111, including spars, stringers and reinforcements or combination thereof that will be readily apparent to a person of ordinary skill.

Tensioner 253 is fixedly linked to support 251 and maintains outward pressure against roller 252, which rotates about axis 254. Axis 254 may be configured to slide within a lateral slot (not shown) in support 251 and may be coupled to the slot by a pin, bolt or similar mechanical fastener (not shown) extending through the roller 252 and supported on opposite ends within the slot. Tensioner 253 may be configured to maintain pressure against roller 252 by internal springs (not shown) under compression located within tensioner 253.

It should be appreciated that pivot point 257 may be generally centered in the area near the wing leading edge 168. This central pivot point location enables transitioner 200-B to have equal freedom of movement up and down to benefit braking scenarios, including shortening landing distance. When transitioner 200-B is angled up in addition to drag being induced, flow over the suction side of the wing is reduced thus making the aircraft heaver sooner, and brakes more effective, than when transitioner 200-B is angled down.

Referring now to FIGS. 5C and 5D while still referring to FIGS. 5A and 5B, in an embodiment, skin 245 may be made of a flexible, inelastic, semi-rigid material, such as spring steel. The material of skin 245 preferably permits the skin to flex where it is attached to wing 111 and throughout the suction surface 207 and pressure surface 208 of the transitioner 200-B. Skin 245 of the transitioner 200-B may be affixed to an outer skin 120 of the wing 111 by any means used in wing manufacturing, e.g. mechanical fasteners, interlocking components, adhesives, and bonding.

CFD analysis shows that varying the transitioner 200-B angle of attack to keep the transitioner chord line more aligned with oncoming fluid flow 1 than the wing chord line further improves the lift-to-drag ratio of a transitioner/wing assembly as the transitioner/wing assembly attitude changes from straight and level cruising attitude.

Any variable angle of attack transitioner 200-B may be attached to wing 111 rib 124 and rib flange 125 by conventional methods, including by adhesives and mechanical fasteners.

Referring now to FIG. 5E while still referring to FIGS. 5A-5D, wing rib 124 and rib flange 125 may be strengthened and reinforced by rib supports 194-A and 194-B, to provide support for variable angle flow transitioner 200-B and the VTAS. In one example, rib supports 194-A and 194-B include integral flanges 195-A and 195-B, respectively, and penetrations for support 251 (see FIGS. 5A and 5B) and gear 261 shaft axis 258. The wing rib supports 194-A, 194-B may be attached to the rib 124 via any method of the designer's choice, including, without limitation, adhesives and mechanical fasteners e.g. pin(s), rivet(s), or bolt(s) (not shown).

Motor 260 may be computer controlled, as described below, to achieve a desired transitioner angle of attack based on ambient conditions, such as airspeed, wing attitude, etc.

Referring now to FIGS. 5F and 5G while still referring to FIGS. 5A and 5B, a three-way angle-drive and drive shaft assembly illustrated may be operably coupled to other three-way angle-drive and drive shaft assemblies and repeated along the length of the transitioner span 223 (see FIG. 3B) and drive each VTAS 3000.

In the illustrated embodiment, drive train components are located within wing 111. Motor 3100 drives shaft 3105, which drives three-way angle-drive 3107-A, which drives shaft 3112-A, which drives right-angle drive 3115-A, which drives shaft 3118-A, which drives gear 261-A, and which drives gear section 262 on an end of support 251 (see FIGS. 5A and 5B).

Three-way angle-drive 3107-A also drives shaft 3108-A, which drives three-way right-angle drive 3107-B, which drives shaft 3108-B, and which drives right-angle drive 3110.

Three-way right-angle drive 3107-B also drives shaft 3112-B, which drives right angle drive 3115-B, which drives shaft 3118-B, which drives gear 261-B, and which drives gear section 262 on an end of its respective support 251 (see FIGS. 5A and 5B).

Right angle drive 3110 drives shaft 3112-C, which drives right-angle drive 3115-C, which drives shaft 3118-C, which drives gear 261-C, and which drives gear section 262 on an end of support 251 (see FIGS. 5A and 5B).

In other multiple VTAS embodiments driven by a single motor 3100, a motor similar to motor 3100 could be located anywhere along wing span 154 (see FIG. 2A), e.g., near the middle of the wing span 154 Likewise, a computer that controls motor 3100 may be located anywhere within wing 111 or aircraft 100 (see FIG. 1).

### 4.2 Variable Pressure and Suction Surface Control—FIGS. 6A-6B

Referring now to FIGS. 6A and 6B while still referring to FIG. 5A and FIG. 5B, in an embodiment, transitioner 200-C includes a transitioner curvature actuator system, including motorized components that enable the curvatures of suction surface 207 and pressure surface 208 of transitioner 200-C to change in a synchronized fashion. In one example, the movements of the suction and pressure surfaces are synchronized whereby as the surface curvature of one surface becomes steeper closer to the leading edge 204 of transitioner 200-C the surface curvature of the opposite surface becomes less steep closer to the leading edge 204.

In the embodiment illustrated in FIG. 6A, the curvatures of suction surface 207 and pressure surface 208 of transitioner 200-C are determined by the positions of an upper skin support 3015-A and a lower skin support 3015-B, respectively. Upper skin support 3015-A may comprise a rigid or semi-rigid beam or plate which may have a convexly curved outer surface and which pivots about a point 3022-A and is selectively moved toward or away the leading edge 204 by means of a linear actuator. In one example, upper skin support 3015-A is operably coupled to an upper support 3020-A, which is fixedly linked to an upper I beam 3010-A, which is fixedly linked to an upper rack 3001-A, which meshes with a gear 3029. Gear 3029 is rotatably attached to support 251 by a mechanical fastener, e.g., a shaft, a pin, or a bolt (not shown).

Upper support 3020-A travels through an upper slide beam support slot 3006-A formed in an upper I beam support 3005-A through which upper I beam 3010-A slides (see Details A, B). Upper I beam support 3005-A is fixedly linked to support 251.

Lower skin support 3015-B may comprise a rigid or semi-rigid beam or plate which may have a convexly curved outer surface and which pivots about a point 3022-B and is selectively moved toward or away the leading edge 204 by means of a linear actuator. In one example, upper skin support 3015-B is operably coupled to a lower support 3020-B, which is fixedly linked to a lower I beam 3010-B, which is fixedly linked to a lower rack 3001-B, which meshes with gear 3029.

Lower support 3020-B travels through an upper slide beam support slot 3006-B formed in a lower I beam support 3005-B through which lower I beam 3010-B slides (see Details A, B). Lower I beam support 3005-B is fixedly linked to support 251.

Gear 3029 is operably coupled to, and rotated by a motor 260 located on the opposite side of, and fixedly linked to, support 251 (see FIGS. 6E and 6F).

The clockwise rotation of gear 3029 results in the lateral movement of upper rack 3001-A toward the wing rib 124 (away from leading edge 204 to the right in FIGS. 6A, 6B) with an equal movement in the opposite direction (toward leading edge 204 to the left in FIGS. 6A, 6B) of lower rack 3001-B. Conversely, the counterclockwise rotation of gear 3029 results in the lateral movement of upper rack 3001-A toward the leading edge 204 (toward leading edge 204 to the left in FIGS. 6A, 6B) with an equal lateral movement in the opposite direction of lower rack 3001-B (away from leading edge 204 to the right in FIGS. 6A, 6B).

Springs 3027-A and 3025-A between upper skin support 3015-A and upper rack 3001-A and springs 3027-B and 3025-B between lower skin support 3015-B and lower rack 3001-B maintain pressure against suction surface 207 and pressure surface 208, respectively, throughout the length of travel of upper skin support 3015-A and lower skin support 3015-B.

Nose roller 252 maintains pressure against skin 245 (as described in Subsection 4.1) and enables the length of transitioner chord 224 (see FIG. 3J) to vary due to the (i) change in suction and/or pressure surface curvature that may occur as a result of the position of upper skin support 3015-A and/or pressure support 3015-B along their respective lengths of travel and/or (ii) change in angle of attack.

Lower skin support 3015-B, lower support 3020-B, lower I beam support 3005-B, lower I beam 3010-B and lower rack 3001-B operate as do the corresponding parts described above that control the suction surface curvature.

It should be noted that the nose roller tensioner 253, suction surface springs 3027-A and 3025-A, and pressure surface springs 3027-B and 3025-B could be replaced with other biasing mechanisms configured to maintain pressure and tension that will be readily apparent to a person of ordinary skill.

It should also be noted that the upper skin support 3015-A and lower skin support 3015-B could have a different length and/or curvature than shown and also a variable length and adjustable curvature. In other embodiments the length and curvature of upper skin support 3015-A and lower skin support 3015-B can be varied by computer-controlled actuators.

In the foregoing embodiment, the synchronized movements of the upper skin support 3015-A and lower skin support 3015-B are adjusted in equal and opposite increments. However, the movement could be asynchronous by adding additional meshed gears of different diameters (not shown) between rack 3001-A and 3001-B. For example, adding two meshed gears, each one-half of the diameter of gear 3029, meshed between gear 3029 and lower rack 3001-B, would cause lower rack 3001-B to move linearly at one half the distance of travel of upper rack 3005-A for each rotation of gear 3029.

Motor 260 may be computer controlled, as described below, to achieve a desired transitioner suction surface and pressure surface curvatures based on ambient conditions, such as airspeed, wing attitude, etc.

### 4.3 Independent Pressure and Suction Surface Control—FIGS. 6C-6H

The illustrations in FIGS. 6A-6D are views from the root-side of transitioner 200-D, and the illustrations in FIGS. 6E-6H are views from the tip-side of transitioner 200-D.

Referring now to FIGS. 6C and 6D, while still referring to FIG. 5A and FIG. 5B, an embodiment of a transitioner 200-D includes (i) linear actuators that enable varying the curvatures of suction surface 207 and pressure surface 208 (see FIGS. 3D-3F) of transitioner 200-D independently of each other, (ii) a linear actuator enabling a variable transitioner chord length 224-A-224-C (see FIGS. 3G-3I), and (iii) a linear actuator to maintain a consistent skin tension regardless of the transitioner profile that results from the operations of varying the skin curvatures and chord length.

The curvature of suction surface 207 may be changed by moving an upper skin support 3077-A beneath the skin 245 of the transitioner 200-D. Upper skin support 3077-A may be moved by a linear actuator, such as, for example, a ball screw assembly 3060-A. In such an embodiment, the curvature of suction surface 207 is changed when a ball screw motor 3062-A of an upper ball screw assembly 3060-A rotates a ball screw 3064-A of assembly 3060-A, which causes a ball screw carriage 3065-A, an extension 3076-A, and an upper skin support to move laterally beneath the skin 245. Roller 252 maintains positive pressure against skin 245 and is tensioned by extension 3079, which is fixedly linked to an actuator plate 4002 and is movable toward or away from the leading edge of the wing 111 in a direction parallel to a transitioner chord line connecting an axis of roller 252 and a center of curvature of gear section 262. Actuator plate 4002 is supported by rods 4001-A and 4001-B extending through fixed guide block 4003 and extended and retracted by an actuator 4000 (see FIGS. 6E and 6F).

The curvature of pressure surface 208 may be changed by moving a lower skin support 3077-B beneath the skin 245 of the transitioner 200-D. Lower skin support 3077-B may be moved by a linear actuator, such as, for example, a ball screw assembly 3060-B. In such an embodiment, the curvature of suction surface 207 is changed when a ball screw motor 3062-B of a lower ball screw assembly 3060-B, rotates ball screw 3064-B of assembly 3060-B, which causes a ball screw carriage 3065B, an extension 3076-B, and a lower skin support 3077-B to move laterally beneath the skin 245. Roller 252 maintains positive pressure against skin 245 as described above.

Upper skin support 3077-A and lower skin support 3077-B may be pivotably coupled to upper ball screw carriage 3065-A and lower ball screw carriage 3065-B, respectively, such that they rotate about the respective pivot points shown.

Referring now to FIG. 6E, upper skin support 3077-A is positioned further from leading edge 204 of transitioner 200-D and lower skin support 3077-B is positioned nearer leading edge 204, due to actuator 4000 being partially extended toward the maximum transitioner chord length. Conversely, referring to FIG. 6F, upper skin support 3077-A is positioned nearer to leading edge 204 and lower skin support 3077-B is positioned further from leading edge 204, due to 4000 remaining in the same position as in FIG. 6E.

Referring now to FIGS. 6G and 6H, positions of upper skin support 3077-A and lower skin support 3077-B differ such that extension 3079 is shown at its limits of travel for the transitioner angle of attack shown. Extension 3079 is shown in its fully retracted position shown in FIG. 6G and in its fully extended position in FIG. 6H. As each skin support 3077-A and 3077-B is advanced toward leading edge 204, the thickness of transitioner 200-D (distance between the transitioner 200-D pressure and suction surfaces 207, 208) increases, and thus extension 3079 is retracted to shorten transitioner chord length to accommodate the fixed length of skin 245. Similarly, as each skin support 3077-A and 3077-B is moved away from leading edge 204, the thickness of transitioner 200-D (distance between the transitioner 200-D pressure and suction surfaces 207, 208) decreases, and thus extension 3079 is extended to increase transitioner chord length to accommodate the fixed length of skin 245.

Motors 3062-A and 3062-B and actuator 4000 may be computer controlled, as described below, to achieve desired transitioner suction surface and pressure surface curvatures, transitioner thickness, and/or transitioner chord length based on ambient conditions and/or flight conditions, such as airspeed, altitude, wing attitude, etc.

It should be noted that the illustrated skin supports 3077-A, 3077-B, and 3015-A and 3015-B are only two examples of many possible skin support configurations, including supports comprised of multiple actuator or spring tensioned elements (not shown) that would enable different adjustable skin support curvatures.

It should be noted that upper skin support 3077-A and lower skin support 3077-B could have different lengths and/or curvatures than shown. In some examples, one or both surface supports 3077-A and 3077-B could have a variable length, for example by incorporating telescoping beams and/or plates. In other embodiments the length and/or curvature upper skin support 3077-A, lower skin support 3077-B can be adjusted by computer-controlled actuators in response to one or more sensors generating signals based on ambient conditions and/or flight conditions, such as airspeed, altitude, wing attitude, etc.

It should be noted that the above skin supports and tensioner could be operably coupled to any linear actuator type, irrespective of if it is ball-screw actuated, including without limitation pneumatic or hydraulic cylinders.

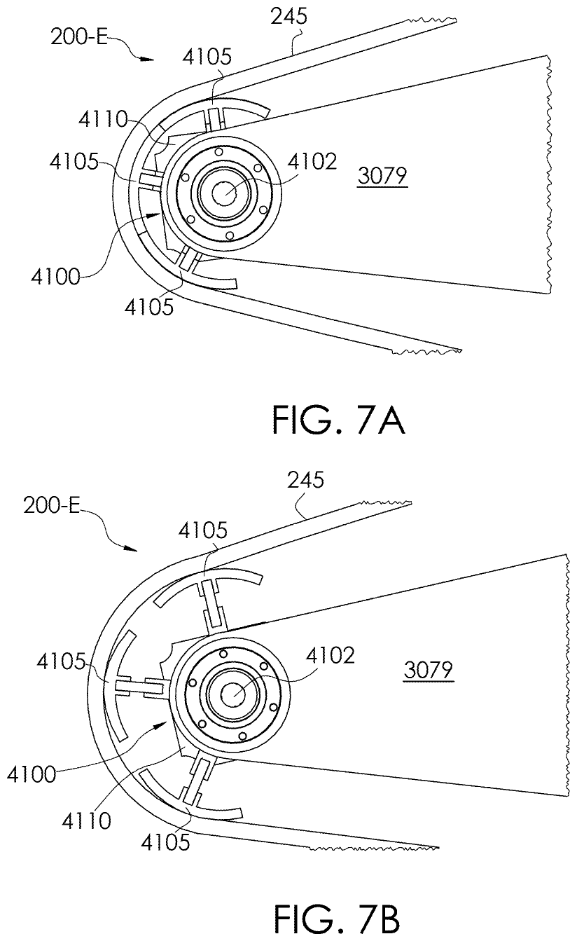

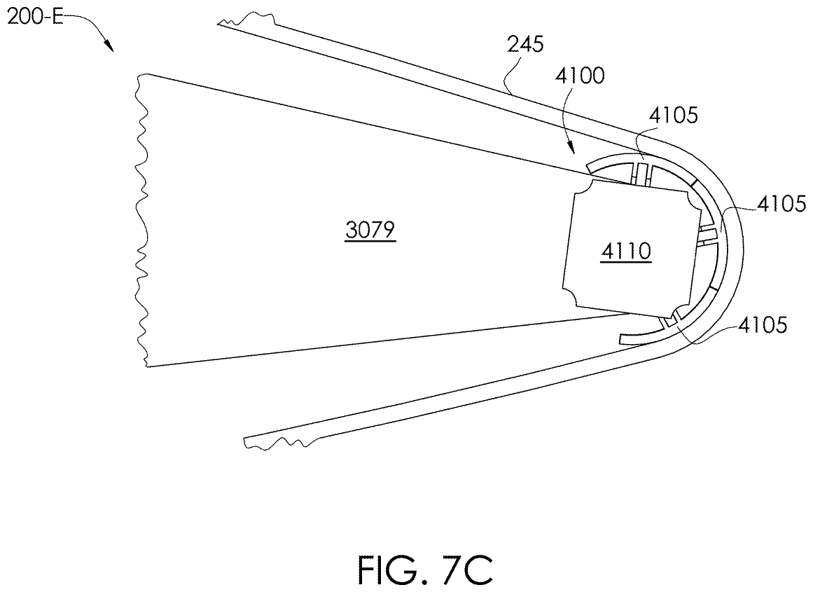

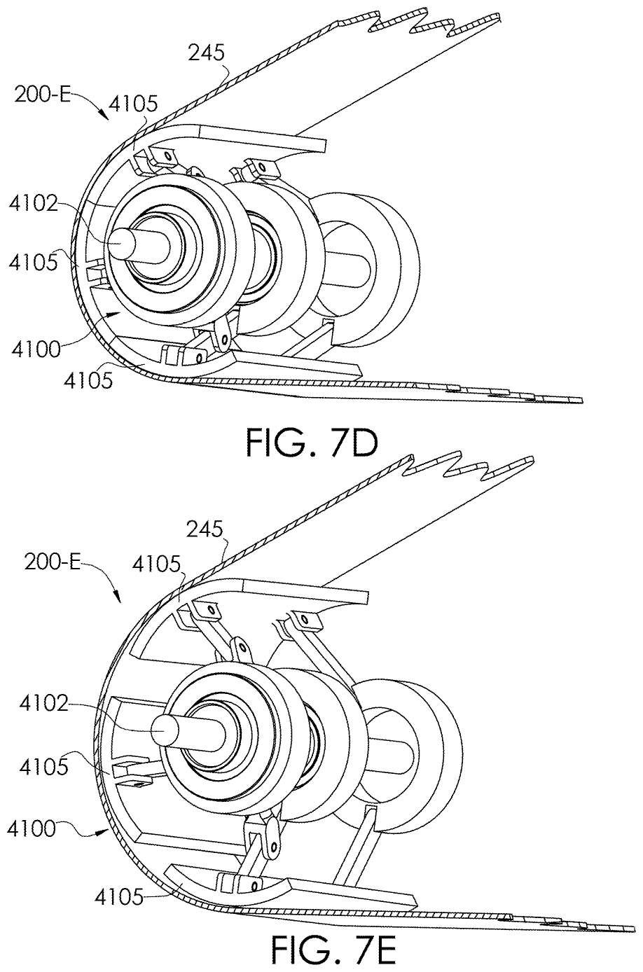

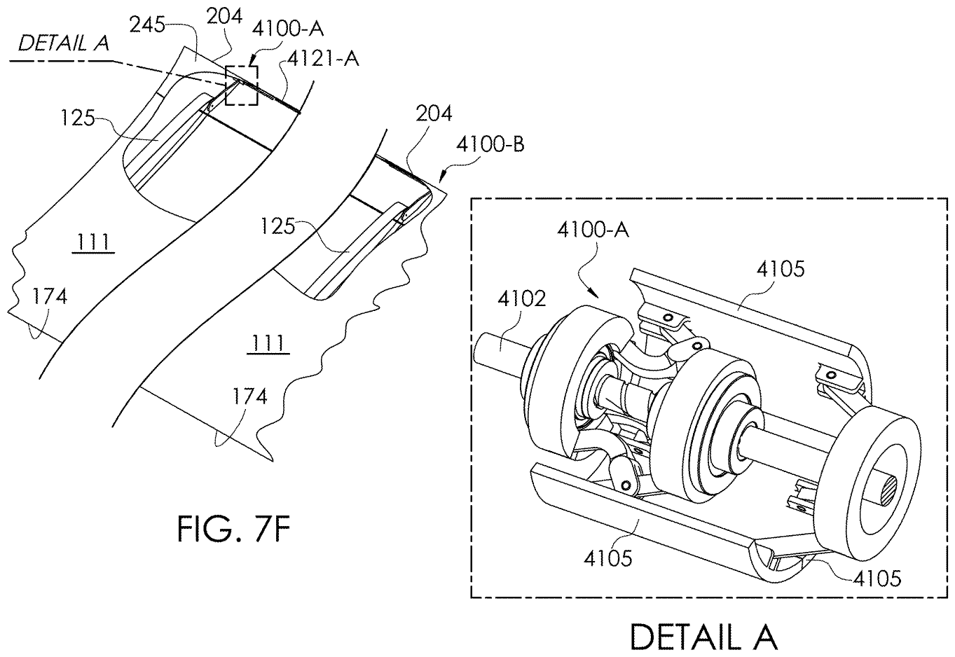

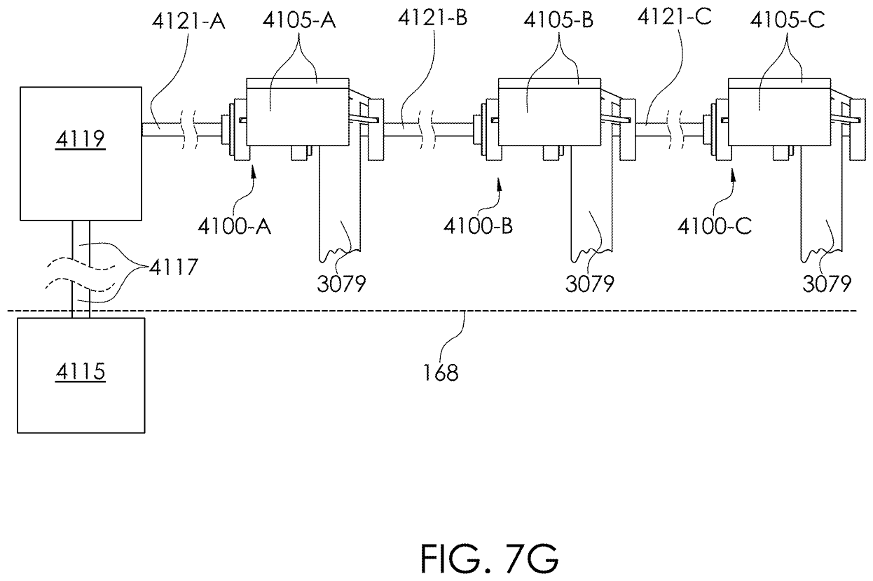

### 4.4 Variable Diameter Nose Circle Assembly—FIGS. 7A-7G

Referring now to FIGS. 7A-7C, an embodiment of a transitioner 200-E includes a variable nose circle assembly (“VNCA) 4100 comprised of motorized components that enable the transitioner nose circle 219 diameter (see FIG. 3J Detail A) to vary to alter transitioner performance characteristics as needed or desired. Each VNCA 4100 may be actuated by a dedicated motor 4110 or, alternatively, VNCA's 4100 may be repeated at multiple locations along the spanwise distance 223 (see FIG. 3B) of the transitioner 200-E and driven by a single motor 4115 as described below. In the embodiment shown a typical screw-type expander is a component within VNCA 4100 and expands as screw shaft 4102 is rotated in one direction, and retracts when screw shaft 4102 is rotated in the opposite direction. A line connecting an axis of screw shaft 4102 (i.e., the center of a nose circle defined by VNCA 4100) and pivot point 257 (see FIGS. 6E-6H) defines a transitioner chord line.

In the embodiment shown, skin supports 4105 are moved outwardly against skin 245 as the expander opens, and skin supports 4105 are moved inwardly as the expander retracts. The VNCA 4100 is operably coupled to extender 3079 and skin 245 tension is maintained as described in Section 4.3.

FIGS. 7A, 7C and 7D show a VNCA 4100 in its fully retracted position, resulting in the smallest-diameter nose circle 219 (see FIG. 3J Detail A). FIGS. 7B and 7E show a VNCA 4100 in its fully expanded position, resulting in the largest-diameter nose circle 219 (see FIG. 3J Detail A). FIG. 7C shows the opposite side of extender 3079 with fixedly linked motor 4110. In one embodiment, skin supports are expanded or retracted by linkages extending from one or more followers coupled to the screw shaft 4102.

FIGS. 7F and 7G show an embodiment of multiple VNCA's 4100 driven by a single motor 4115 located aft of wing leading edge 168, shown as a dashed phantom line. For clarity, part numbers include letter suffix A-C appended, whereby “A” represents the first occurrence of the assembly or part, “B” represents the second occurrence of the assembly or part, and “C” represents the third occurrence of the assembly or part.

In the illustrated embodiment, motor 4115 drives shaft 4117, which drives right angle drive 4119, which drives shaft 4121-A, which drives VNCA 4100-A, which drives shaft 4121-B, which drives VNCA 4100-B, which drives shaft 4121-C, and which drives VNCA 4100-C.

In other multiple VNCA embodiments, one or more motors similar to motor 4115 could be located anywhere along wing span 154 (see FIG. 2A), e.g., near the middle of the wing span 154, and operably coupled to multiple VNCAs similarly as shown herein. Likewise, a computer that controls motor 4115 may be located anywhere within wing 111 or aircraft 100 (see FIG. 1).

### 4.5 Computer

The computer described herein (not shown) relies upon sensors and/or encoders (not shown) capable of monitoring and varying the (i) transitioner angle of attack, (ii) pressure and suction surface curvature, (iii) chord length, (iv) nose circle diameter and (v) skin tension (collectively “Variable Parameters”) of the transitioner embodiments described in Section 4 and incorporated into other embodiments, including without limitation, those used with turbine blades.

For simplicity, the computer functions described below relate to an aircraft wing, however similar functions could be used for other embodiments.

The computer may rely upon stored data collected from studies of the transitioner under simulated flight conditions and/or test flight conditions to determine optimum Variable Parameter values for a given air speed and attitude, and store associated optimum parameter values for controlling them (“Optimum Parameters”). This is analogous to autopilots using known parameters for flap settings.

During operation, the computer would (i) receive real-time airspeed and attitude data, (ii) use the received data to look up or otherwise and access the Optimum Parameters, and (iii) output the Optimum Parameters to the motors and/or actuators that control the Variable Parameters.

The computer would receive input from sensors and encoders used to determine the physical position of Variable Parameters and compare the input with the Optimum Parameters. In the event that the physical position of any Variable Parameter was out of a predetermined acceptable tolerance for its position as compared to its Optimum Parameter, an error condition would occur.

In the event of an error condition, any number of predetermined actions could occur, including but not limited to the computer (i) outputting data to the cockpit, (ii) outputting control signals to one or more Variable Parameters to cause them to return to the position used for cruising attitude at the normal cruising speed, or other known position, (iii) outputting no further Optimum Parameters (data) to the motors and/or actuators that control the Variable Parameters until the error condition was resolved, or (iv) recognizing manual override.

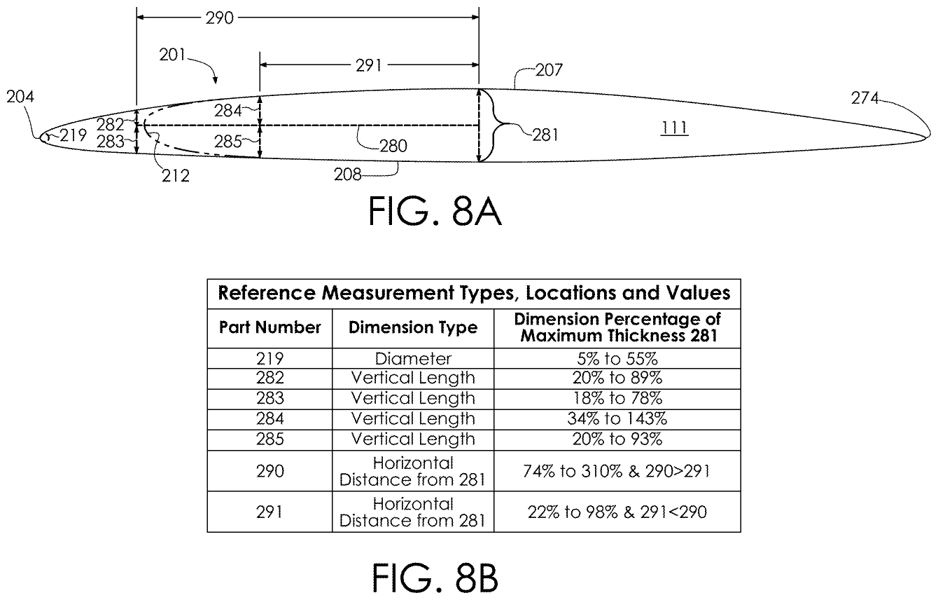

### 4.6 Integrated Transitioner—Wing—FIGS. 8A-8B

In an embodiment, any flow transitioner may be integrated into the design of a blade or other foil (“integrated transitioner”), as opposed to being fixedly linked to an existing blade or foil. An integrated transitioner may retain any aspects of a fixedly linked transitioner, including, without limitation, its geometry and geometric relationships as described in Section 2, and alternate embodiments described in Subsections 4.1-4.4. This Subsection describes integrating a fixed (non-variable) flow transitioner into a wing design at the time of design and/or manufacture.

FIG. 8A shows a profile of a wing 111 superimposed within a wing assembly 201 having a leading edge 204, a trailing edge 274, a suction (upper) surface 207 and a pressure (lower) surface 208. A phantom line 212 depicts where transitioner trailing end 212 would have been if the transitioner was fixedly linked to, rather than integrated with, the leading edge area of wing 111, for example, as shown in FIG. 3G. That is, phantom line 212 shows the profile of wing 111 without a transitioner.

FIG. 8A also shows reference measurements 219, 282, 284, 283, 285 that define a configuration of a profile of wing assembly 201. Reference measurement 219 is a leading edge diameter (or radius) of a nose circle defining a leading edge 204 of wing assembly 201, the magnitude of which may be characterized as a fraction or percentage of a maximum thickness 281 between suction surface 207 and pressure surface 208. Reference measurement 284 is a length between suction surface 207 and a datum line 280 at a horizontal location 291 relative to maximum thickness line 281. Datum line 280 is perpendicular to maximum thickness line 281 and intersects line 281 at its midpoint. Reference measurement 282 is a length between suction surface 207 and datum line 280 at a horizontal location 290 relative to maximum thickness line 281. Reference measurement 285 is a length between pressure surface 208 and datum line 280 at horizontal location 291 relative to maximum thickness line 281. Reference measurement 283 is a length between pressure surface 208 and datum line 280 at horizontal location 290 relative to maximum thickness line 281. Reference measurements 282, 284, 283, 285 and locations 290 and 291 may be characterized as fractions or percentages of maximum thickness 281.

FIG. 8B is a table listing ranges of values of reference measurements 219, 282, 284, 283, 285 and locations 290 and 291. CFD analysis to date demonstrates that improvement in the lift-to-drag ratio over wing 111 occurs when a wing with an integrated transitioner, such as wing assembly 201, has a profile shape defined by reference measurements 219, 282, 284, 283, 285 falling within the ranges listed in FIG. 8B.

Leading edge diameter 219 may be 5% to 55%, 6% to 52.5%, 6.5% to 50%, or 7% to 47.5% of maximum thickness 281. Location 291 may be 22% to 98%, 32% to 88%, 42% to 83%, or 52% to 78% of maximum thickness 281. Location 290 may be 74% to 310%, 84% to 300%, 94% to 295%, or 104% to 290% of maximum thickness 281. Reference measurement 282 may be 20% to 89%, 22% to 84%, 24% to 79%, or 26% to 74% of maximum thickness 281. Reference measurement 283 may be 18% to 78%, 20% to 73%, 22% to 68%, or 24% to 63% of maximum thickness 281. Reference measurement 284 may be 34% to 143%, 36% to 138%, 38% to 133%, or 40% to 128% of maximum thickness 281. Reference measurement 285 may be 20% to 93%, 22% to 88%, 24% to 83%, or 26% to 78 of maximum thickness 281.

Ranges of reference measurement values and locations listed herein are for a wing assembly profile at the root 158 of the wing 111 (see FIG. 2B).

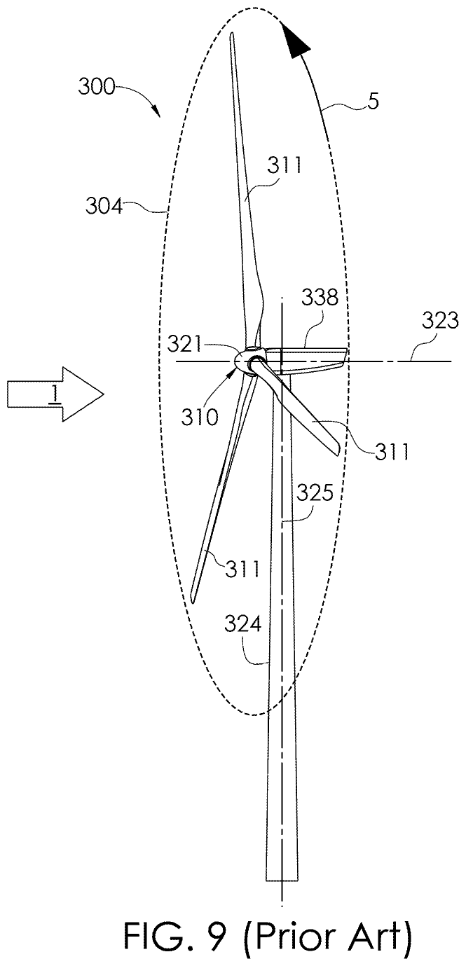

### 5. Turbine Blade—Prior Art—FIG. 9, FIGS. 10A-D

Referring now to FIG. 9, a fluid flow turbine 300 is exemplary of an embodiment disclosed herein. Fluid flow turbine 300 may comprise a horizontal axis wind turbine (“HAWT”). Fluid flow turbine 300 includes a rotor 310 comprising a plurality of rotor blades 311 (e.g., three) mounted to and extending radially from a hub 321 defining the rotor axis or rotor axis of rotation 323 (also referred to herein as the hub axis or hub axis of rotation) about which the rotor 310 rotates in direction 5 (counterclockwise in the illustrated embodiment). In an alternative embodiment, rotor 310 includes more or less than three rotor blades 311 and/or rotates clockwise.

Referring now to FIG. 10A while still referring to FIG. 9, a typical fluid flow turbine 300 may include rotor-driven components, such as a gearbox and generator (not shown) located within a nacelle 338, operatively coupled with or defining the axis of rotation 323 of the rotor 310, which converts the kinetic energy of oncoming fluid flow (wind stream) 1 via the rotor blades 311 into a rotational energy harnessed within the gearbox. The gearbox is rotated by rotor 310 and may be coupled to a device that converts the rotational energy such as electrical generator or a fluid pump (not shown).

Turbine 300, i.e., rotor 310 and nacelle 338, may be mounted atop a tower 324 defining a tower axis 325.

Referring now to FIG. 10A and FIG. 10B, each rotor blade 311 includes a blade root 358 at an inboard end with respect to the hub 321 (see FIG. 9), and may include connecting structure 357 (e.g., an annular mounting flange) for securing the rotor blade 311 with respect to the hub 321, and a blade tip 351 at a radially outboard end of the rotor blade 311 with respect to the hub 321 and defining a span 354 from the blade root 358 to the blade tip 351. Rotor blade 311 may include, progressing from the blade root end 358, a root section 360 that may be generally circular, elliptical, oval, or egg-shaped in cross-sectional profile at the far root end 358 of the blade and an airfoil section 364 having a leading edge 368 and a trailing edge 374, which is the working section of the rotor blade 311 and which defines an airfoil profile between the leading edge 368 and blade trailing edge 374 that forms a pressure surface (or upstream surface) 378 generally facing the oncoming fluid flow 1 (see FIG. 9) and a suction surface (or downstream surface) 382.

Each rotor blade 311 also includes a tip section 350 that overlaps a portion of the airfoil section 364 and a leading edge 368 and blade trailing edge 374 which defines the boundaries of the pressure surface 378 and the suction surface 382. Referring to Details A, B, and C of FIG. 10A, pressure surface 378 may include a leading convexity 381 and a trailing concavity 380. Blade 311 may include a transition section 384 at which the cross-sectional shape of the rotor blade 311 transitions from the circular, elliptical, or other shape of the blade root 358 and root section 360 to the shape of the airfoil section 364. In an alternate embodiment, a transition section is omitted and the blade 311 includes an abrupt, generally instantaneous transition between the profile of the root section 360 and the profile of the airfoil section 364.

Airfoil section 364 is defined by a chord 386 between the blade leading edge 368 and the blade trailing edge 374. The length of chord 386 may be variable along the span 354 of the blade 311 (e.g., with the chord length decreasing with increasing span distance from the blade root 358, as shown), or the chord length may be constant along some or all of the span 354 within the airfoil section 364.

Referring now to FIG. 10C and FIG. 10D while still referring to FIG. 10A and FIG. 10B, the airfoil section 364 may have an aerodynamic profile defined by the pressure surface 378 and the suction surface 382 defining a mean camber line 388 having a maximum camber 390 and a maximum thickness 392 (i.e., maximum distance between pressure surface 378 and suction surface 382 on a line that is perpendicular to chord line 386). The maximum thickness 392, the maximum camber 390, and the mean camber line 388 may vary with spanwise distance from the hub 321 (see FIG. 9). Chord line 386 may be arranged at a blade chord angle (or angle of attack) 394 relative to the plane of rotation 304 of the rotor 310 (see FIG. 9), and the blade chord angle 394 may also vary with spanwise distance from hub 321 (see FIG. 9).

Referring now to FIG. 10C, the blade 311 may have internal support structures including, (i) supporting the pressure surface 378 a spar 314 and reinforcement 312, (ii) supporting the suction surface 382 a spar 315 and reinforcement 313, and (iii) at and near the leading edge 368, reinforcement 318 (collectively “blade reinforcements”).

Blade 311 may also have a u-shaped shear web 316 near the center of the blade 311 and u-shaped shear web 317 near the blade leading edge 368 (collectively “shear webs”). The reinforcements and shear webs provide additional structural support to blade 311.

### 5.1 Apparent Velocity

Referring to FIG. 10D, as the rotor 110 rotates (see FIG. 9), each rotor blade 111 is exposed to flow due to movement of the rotor blade 111 in rotational direction 5 (see FIG. 9) within the rotor plane 304, as well as the oncoming fluid flow 1. The resultant of the flow due to rotational movement 5 and the oncoming fluid flow 1 is the apparent velocity (“AV”), or apparent fluid flow. A portion of the apparent velocity AV flows over the pressure surface 378 of the blade 311, and a portion of the apparent velocity AV flows over the suction surface 382 of the blade 311. Due to the differential curvatures of the pressure surface 378 and suction surface 382 and/or the angle of attack of the blade 311 (i.e., the angle between apparent velocity AV and the rotor plane 304), fluid flows more quickly over the suction surface 382 than over the pressure surface 378, thereby creating a pressure differential between the suction surface 382 and pressure surface 378 resulting in a lift force FL acting in direction L generally perpendicular to the direction of the apparent velocity AV. In addition, flow over the blade 311 generates a drag force F_{D} acting in a direction D parallel to the apparent velocity AV. A component of the lift force F_{L} produces a positive torque F_{T}+ acting in direction +T on the blade 311 and a component of the drag force F_{D} results in a negative torque F_{T}− acting in direction −T on the blade 311. An F_{T+} that is greater than F_{T-} causes the rotor to rotate.

### 6. Turbine Blade—Transitioner—General Overview—FIGS. 11A-11L

The transitioner embodiments described in Sections 2-4 may be configured on multiple blade types, including, without limitation, wind and water turbine blades.

### 6.1 Transitioner/Turbine Blade Assembly—FIGS. 11A-11I

Referring now to FIG. 11A, transitioner 400 may be configured as a fixed extension of the blade 311 to which it is attached or linked, variable extension with variable angles of attack, and/or variable pressure surface curvature, suction surface curvature, and chord length as described in Section 4.

Transitioner 400 may extend along the entirety of blade 311, or any portion thereof.

Transitioner 400 may be installed on an existing turbine blade by adhering, bonding or mechanically fastening it to at least a portion of an existing turbine blade, or integrated into the construction of a new turbine blade as described in Section 6.7.

Unless otherwise stated herein, any combination of the following concepts, configurations and related figures are intended to be equally applicable to any foil type, including without limitation, aircraft and watercraft wings, stabilizers, propellors, and wind and hydro turbine blades.

### 6.2 Geometry, Location and Orientation—FIG. 11B-11C

Referring now to FIGS. 11B and 11C, transitioner 400 has a leading edge 404, suction surface 407, pressure surface 408, and trailing end 412.

Suction surface 407 and pressure surface 408 may each have at least a portion that is straight, convex, concave or a combination thereof.

Transitioner 400 may have a twist that is the same as or different than the twist, if any, of blade 311.

In this embodiment, the area near leading edge 368 of blade 311 and related transitioner trailing end 412 have identical curvature. In other embodiments the leading edge 368 area of blade 311 and related transitioner trailing end 412 do not have identical curvature.

### 6.3 Transitioner/Blade Assembly—Chord Detail—FIG. 11D-11I

Referring now to FIGS. 11D-11I showing various profiles of an assembly comprising a flow transitioner 400 attached to a turbine blade (a primary turbine blade or primary foil) 311, in cases where an improved lift-to-drag ratio of the blade is desired, transitioner chord lines 424-A, 424-B and 424-C are angled nearer to the fluid flow 1, or closer to the apparent velocity 6 (see FIGS. 11G-11I), than the respective blade chord lines 386-A, 386-B and 386-C. In cases where an improved lift-to-drag ratio is not desired, or in other configurations or embodiments, transitioner chord lines 424-A, 424-B and 424-C may have an angle of attack that is not angled nearer to the fluid flow 1, or closer to the apparent velocity 6 (see FIGS. 11G-11I), than the respective blade chord lines 386-A, 386-B and 386-C or the same angle of attack as blade chord lines 386-A, 386-B and 386-C.

### 6.4 Transitioner—Leading Edge Detail—FIG. 11J-11K

Referring now to FIGS. 11J and 11K, while still referring now to FIGS. 11D-11I, in an embodiment, the transitioner leading edge 404 end of the transitioner has a smaller nose circle 419 than the blade nose circle 319, a smaller thickness 420 at the aft end of the transitioner nose circle 419 than the thickness 320 at the aft end of the blade nose circle 319, and a less steep suction and surface slope than the area of leading edge 368 end of the blade 311 to which it is attached. In embodiment illustrated in FIG. 11J, the transitioner/blade assembly profile is shown at a distance along blade span 354 of twenty-five percent from the tip 351 (see FIG. 10B).

In an embodiment, transitioner 400 also has a thickness 472 (perpendicular to chord line 386 of blade 311) at its mid-point along its chord 424 that is less than blade 311 maximum thickness 392. Values and ratios of the radius of blade nose circle 319 and the radius of transitioner nose circle 419 are listed in the table of FIG. 11K. Values of nose circle aft thickness 420, transitioner mid chord thickness 472, blade circle aft thickness 320, and blade maximum thickness 392 as a percentage of blade maximum thickness 392 are listed in the table of FIG. 11L.

### 6.5 Transitioner—Trailing End Detail—FIG. 11B

Referring now to FIG. 11B, in an embodiment, the shape of blade transitioner trailing end 412 has the same curvature as the blade 311 leading-edge 368 area of the blade to which the transitioner is attached and includes an upper trailing edge 410 and lower trailing edge 411.

In the embodiment shown, transitioner 400 may be (i) adhered or mechanically fastened to blade 311 using common methods of attachment, including, without limitation, adhesives and mechanical fasteners, or (ii) incorporated into the manufacturing process of the blade as further described below.

### 6.6 Transitioner—Orientation and Geometric Relationships—FIGS. 11D-11J

The term “tip end” with respect to geometric relationships of rotating foils, such as turbine blades and propellors, means the foil profile such as 352 nearest the tip 351 prior to the point that leading edge 368, trailing edge 374, pressure surface 380 or suction surface 382 (see FIG. 10A) begins its curvature to meet the opposite edge, such as for a tip-end domed feature, other curved tip, or winglet.

Referring now to FIG. 11D-11I, blade transitioner chord line 424 angle is more aligned with the apparent velocity 6 over at least a portion of the spanwise distance 354 (see FIG. 10B) of blade 311 than is the blade chord line 386 (see FIGS. 11G-11I) (less angle of attack between the transitioner chord line 424 and the apparent velocity vector 6 than between the blade chord line 386 and the apparent velocity vector 6) when an increase in the lift-to-drag ratio is desired. For example, referring to FIG. 11H, blade chord line 386-B is at a 11.7 degree angle relative to apparent velocity 6, as compared to transitioner chord line 424-B, which is at a 1.1 degree angle relative to apparent velocity 6. As noted above, where decreased lift-to-drag ratio is desired, the transitioner chord line is oriented to be less aligned with the apparent velocity than the blade chord line or the transitioner chord line may be aligned with the blade chord line.

In other embodiments, blade transitioner chord 424 angle may be more aligned with apparent velocity 6 over at least a portion of the spanwise distance 354 (see FIG. 11G) of blade 311 than is the blade chord 386 angle (see FIGS. 11G-11I) when a transitioner is positioned over a portion of the blade's span, e.g., the transitioner 400 ending prior to a tip 351 (See FIG. 10A) or is otherwise positioned over less than the entire blade's span.

FIG. 11J shows reference measurements 319, 419 and 392 that define a configuration of a profile of blade assembly 311 benefitted by a transitioner 400. Reference measurement 419 is a leading edge diameter (or radius) of a nose circle defining a leading edge 404 of transitioner 400, the magnitude of which may be characterized as a fraction or percentage of blade 311 nose circle diameter 319 and blade maximum thickness 392.

CFD analysis to date demonstrates that improvement in the lift-to-drag ratio over blade 311 occurs when a blade benefitted by a transitioner, such as transitioner assembly 400, has a transitioner profile shape located nearest the root 358 (see FIG. 10B) defined by the relationship between the transitioner chord length 424 as a percentage of the blade chord length 386, or transitioner nose circle diameter 419 as percentage of the blade nose circle diameter 319, or the transitioner nose circle diameter 419 as a percentage of the blade maximum thickness 392 falling within the ranges that follow.

Transitioner chord 424 at the blade root end 358 (see FIG. 10B) may be 2% to 18%, 3% to 17%, 3.5% to 16%, or 4% to 15% percent of the blade chord 386.

Transitioner nose circle diameter 419 may be 1% to 50%, 3% to 45%, 5% to 40%, or 7% to 35% of blade nose circle diameter 319, or transitioner nose circle diameter 419 may be 5% to 55%, 6% to 52.5%, 6.5% to 50%, or 7% to 47.5% of blade maximum thickness 392.

Ranges of reference measurement values and locations listed herein are for a transitioner 400 profile coupled to a blade 311 profile located at the root 358 of the blade 311 (see FIG. 10B) or any location along the span.

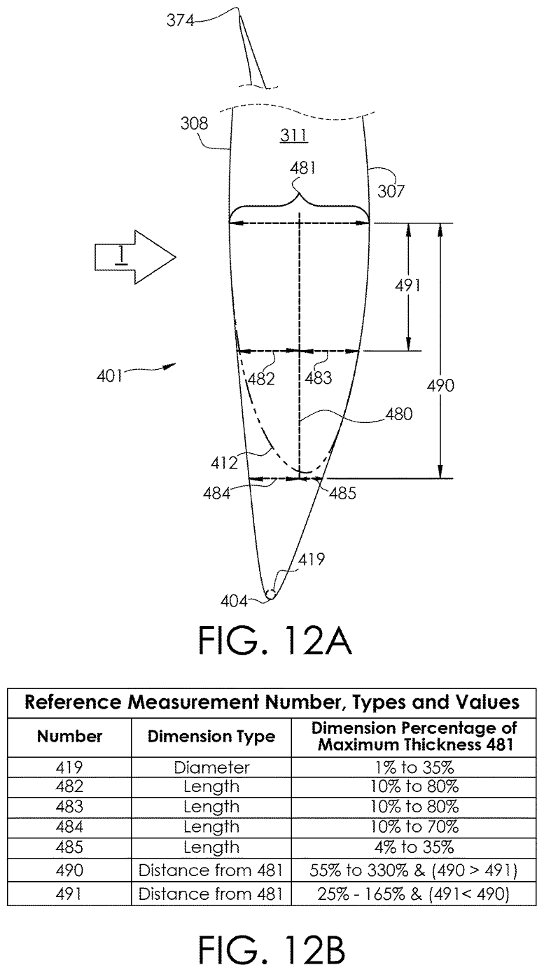

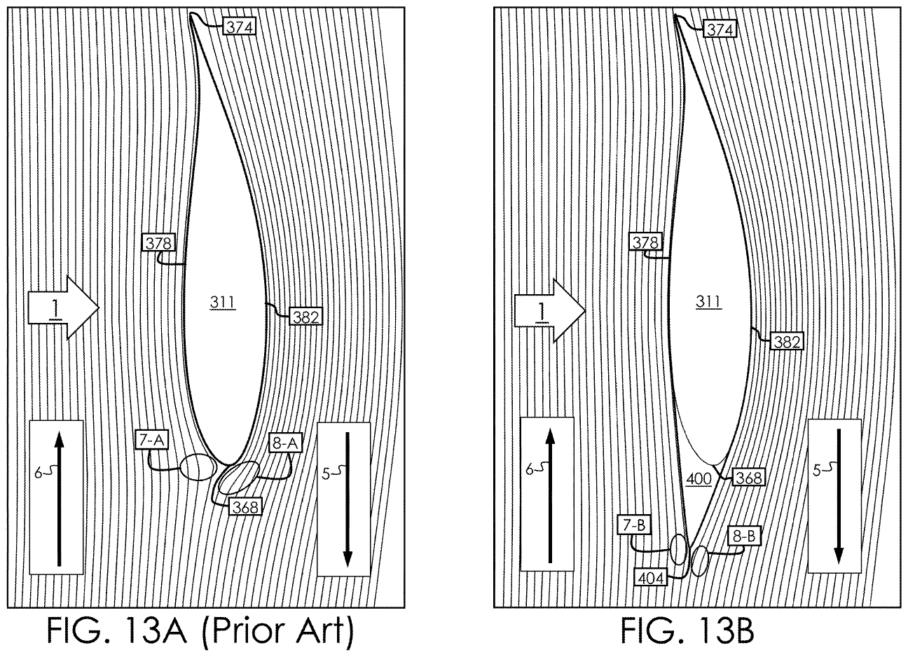

### 6.7 Integrated Blade Transitioner—FIGS. 12A-12B

In an embodiment, any flow transitioner may be integrated into the design of a blade or other foil (“integrated transitioner”), as opposed to being fixedly linked to an existing blade or foil. An integrated transitioner may include any aspects of a fixedly linked transitioner, including, without limitation, its geometry and geometric relationships as described in Section 2, and alternate embodiments described in Subsections 4.1-4.5. This Subsection describes integrating a fixed (non-variable) flow transitioner into a blade design at the time of design and/or manufacture.

FIG. 12A shows a profile of a blade 311 superimposed within a blade assembly 401 having a leading edge 404, a trailing edge 374, a suction (downstream) surface 307 and a pressure (upstream) surface 308. A phantom line 412 depicts where transitioner trailing end 412 would have been if the transitioner was fixedly linked to, rather than integrated with, the leading edge area of blade 311, for example, as shown in FIG. 11G. That is, phantom line 412 shows the profile of blade 311 without a transitioner.

FIG. 12A also shows reference measurements 419, 482, 483, 484, 485 that define a configuration of a profile of blade assembly 401. Reference measurement 419 is a leading edge diameter (or radius) of a nose circle defining a leading edge 404 of blade assembly 401, the magnitude of which may be characterized as a fraction or percentage of a maximum thickness 481 between suction surface 307 and pressure surface 308. Reference measurement 483 is a length between suction surface 307 and a datum line 480 at a horizontal location 491 relative to maximum thickness line 481. Datum line 480 is perpendicular to maximum thickness line 481 and intersects line 481 at its midpoint. Reference measurement 485 is a length between suction surface 307 and datum line 480 at a horizontal location 490 relative to maximum thickness line 481. Reference measurement 482 is a length between pressure surface 308 and datum line 480 at horizontal location 491 relative to maximum thickness line 481. Reference measurement 484 is a length between pressure surface 308 and datum line 480 at vertical location 490 relative to maximum thickness line 481. Reference measurements 482, 483, 484, 485 and locations 490 and 491 may be characterized as fractions or percentages of maximum thickness 481.

FIG. 12B is a table listing ranges of values of reference measurements 419, 482, 483, 484, 485 and locations 490 and 491. CFD analysis to date demonstrates that improvement in the lift-to-drag ratio over blade 311 occurs when a blade with an integrated transitioner, such as blade assembly 401, has a profile shape defined by reference measurements 419, 482, 483, 484, 485 falling within the ranges listed in FIG. 12B.

Leading edge diameter 419 may be 1% to 35%, 1.5% to 32.5%, 2% to 30%, or 2.5% to 27.5% of maximum thickness 481. Location 491 may be 55% to 330%, 65% to 320%, 75% to 315%, or 85% to 310% of maximum thickness 481. Location 490 may be 25% to 165%, 35% to 155%, 45% to 150%, or 55% to 145% of maximum thickness 481. Reference measurement 482 may be 10% to 80%, 12% to 75%, 14% to 70%, or 16% to 65% of maximum thickness 481. Reference measurement 483 may be 10% to 80%, 12% to 75%, 14% to 70%, or 16% to 65% of maximum thickness 481. Reference measurement 484 may be 10% to 70%, 12% to 65%, 14% to 60%, or 16% to 55% of maximum thickness 481. Reference measurement 485 may be 4% to 35%, 6% to 30%, 8% to 25%, or 10% to 20% of maximum thickness 481.

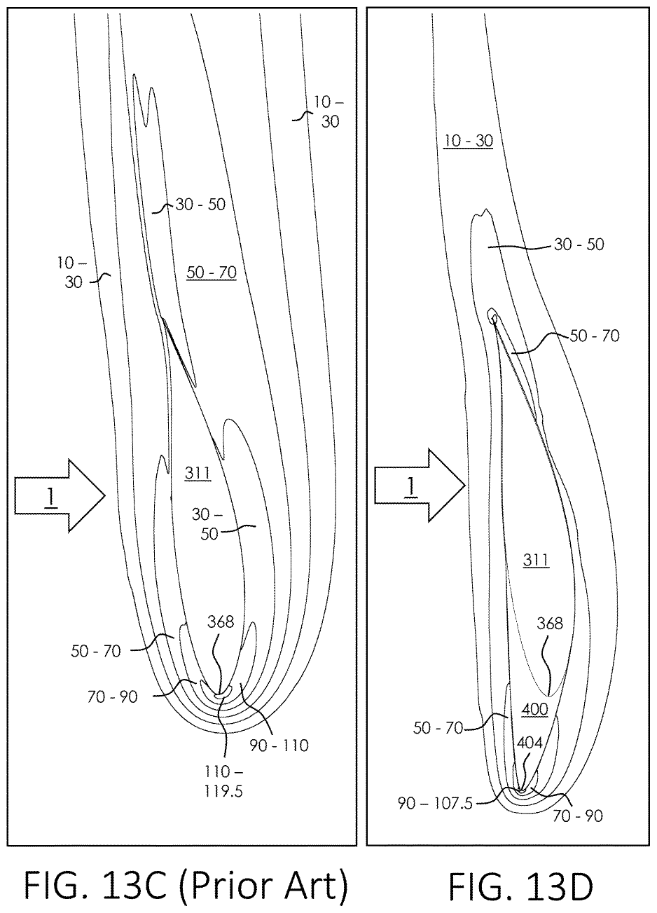

### 6.8 Fluid Flow—Pressures and Decibels FIGS. 13A-13D

All blade and transitioner profiles in FIGS. 13A-13D are near the tip 351 (see FIG. 10B). The rotor diameter of 93.5 meters was studied and, unless otherwise noted, rotating in an oncoming fluid flow 1 speed of 13 m/s, rotating at 17.35 RPM in the desired counterclockwise rotation 5 (down in the illustration) about the rotor axis of rotation 323 (see FIG. 9). with a tip speed of 82.76 m/s (185.13 mph).

Referring now to FIG. 13A, the fluid flow from apparent velocity 6 separates abruptly as it nears the blade leading edge 368, as compared to transitioner 400 leading edge 404 (see FIG. 13B), with fluid flow 7-A passing adjacent to the pressure surface 378 of blade 311, and fluid flow 8-A accelerating adjacent to the suction surface 382 of blade 311. Note the area on the blade not benefited by the transitioner (FIG. 13A) within and adjacent to the 7A and 7B ovals. The space between the flow pipes and the pressure surface are wide, indicating separation and increased drag.

Referring now to FIG. 13B, while still referring to FIG. 10A, as apparent velocity 6 nears the leading edge 468 at areas 7-B and 8-B, the flow trajectory changes more gradually than it does nearing leading edge 368 at areas 7-A and 8-A without the benefit of a transitioner 400 (see FIG. 10A). The reduction in drag in the area adjacent to leading edge 404 as compared to leading edge 368 is of such magnitude that it results in a more than 10 percent increase in the lift-to-drag ratio as compared to blade 311 without the benefit of a transitioner (see FIG. 13A).

Incorporation of flow transitioners 400 with blades 311 in the transitioner/turbine blade assemblies of a turbine can also reduce the noise generated by the turbine. Referring now to FIG. 13C, while still referring to FIG. 13A and FIG. 13B, CFD simulations show the reduction in separation on the pressure surface 378 and within oval 7B as compared to 7A on the blade without a transitioner—as described above, results in 119.5 decibels as compared to 107.5 decibels at the transitioner leading edge 404 (see FIG. 13D).

Using the inverse square law to calculate the sound attenuation over the industry standard 300-meter distance from a point source, and using a distance of 0.0254 meter (1 inch) from the point source, the attenuated sound pressure levels are listed in Table III as follows:

TABLE III

| | | | Blade 311with | |
|---|---|---|---|---|
| | Prior Art - Blade 311 | | Transitioner 400 | |
| | Point Source | dB @ | Point Source | dB @ |
| Wind Speed | dB | 300 m | dB | 300 m |
| 13 m/s (29.08 MPH) | 119.3 | 37.9 | 107.5 | 26.1 |
| 7 m/s (15.66 MPH) | 97.8 | 16.4 | 81.6 | 0.2 |

Consequently, the CFD analysis shows the attenuated pressure level for blade 311 benefited by a transitioner 400 rotating in a 13 m/s wind (see FIG. 13D) at a distance of 300 m from the point source drops to a level of 26.1 dB, which is comparable to the level of human whispering from 5 feet away.

CFD analysis shows the attenuated pressure level for the same blade rotating in a 7 m/s wind (0.2 dB) is nearly imperceivable to a human at a distance of 300 meters.

### 7. Aircraft Propellor Blade Transitioner

The transitioner embodiments described in prior Sections may be configured with aircraft blades, watercraft blades, and other blades that are powered by an engine or motor. Transitioner 700 may be installed on an existing propellor blade by adhering, bonding or mechanically fastening it to at least a portion of an existing propellor, or integrated into the construction of a new propellor blade.

### 7.1 Aircraft Propellor Blade—Prior Art_FIG. 14, FIGS. 15A-15C

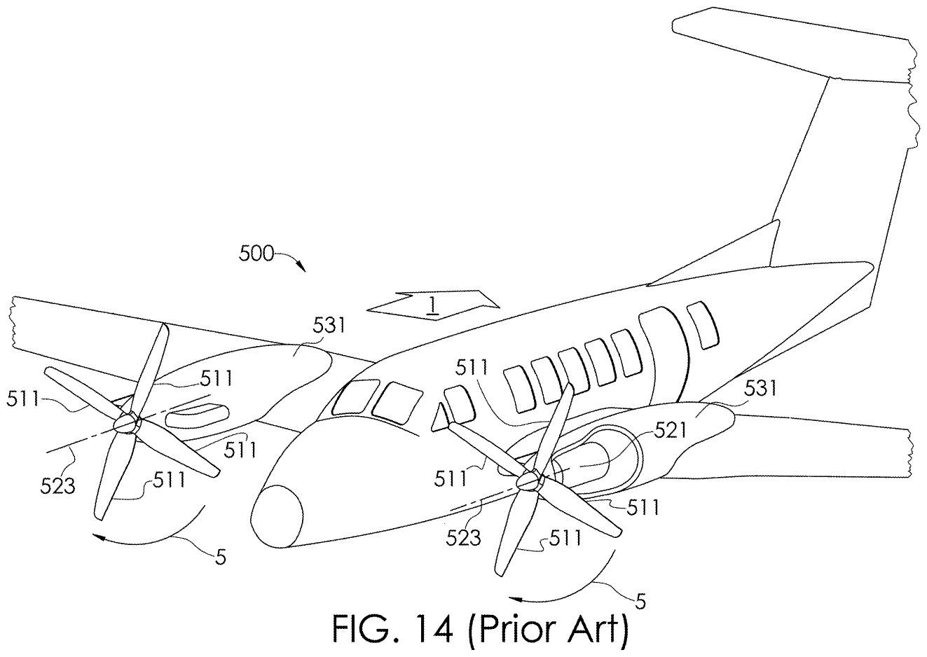

Referring now to FIG. 14, airplane 500 includes twin engines 521, each with propellor blades 511 which rotate about axis 523 in direction 5.

Referring now to FIG. 15A, propellor blade 511 includes a root 558 located nearest the hub axis 523 (see FIG. 14), and a tip 516 at the circumferential end of the propellor blade 511 with respect to hub axis 523 and defining an airfoil span 554 (see FIG. 15B) from the propellor blade root 558 to the propellor blade tip 516.

Referring now to FIG. 15B while still referring to FIG. 15A, propellor blade 511 includes airfoil sections progressing from the propellor blade root end 558, having a leading edge 568 and a trailing edge 574 which are the working sections of the propellor blade 511 and which define an airfoil profile with a suction surface (or surface facing towards intended direction of travel) 578 generally running perpendicular to the oncoming fluid flow 1 (see FIG. 14) and a pressure surface 582 facing away from fluid flow 1. Propellor blade chord 586 varies between root 558 and tip 516.

Propellor blade 511 is defined by a chord line 586 between propellor blade leading edge 568 and propellor blade trailing edge 574. The length of chord 586 may be variable along the propellor span 554 (e.g., with the chord length decreasing with increasing span distance from the propellor blade root 558) or the chord length 586 may be constant or variable along some or all of span 554.

Referring now to FIG. 15C, chord 586 may be oriented at a propellor blade chord angle α (or angle of attack) relative to the oncoming fluid flow 1 over the airplane 500 (see FIG. 14). Axis T is a thrust axis and axis Q is a torque axis. Propellor blade chord angle α may vary with spanwise distance from root 558. When apparent velocity 6 (the vector sum of fluid flow 1 and rotational flow due to rotation in direction 5) passes over pressure surface 582 and suction surface 578, positive lift L is generated perpendicularly to apparent velocity 6, and positive drag D is generated by resistance in a perpendicular direction to lift L as airplane 500 moves through fluid flow 1.

Propellor blade 511 includes a design feature whereby the angle of incidence (or angle of attack) decreases from the root 558 to the tip 516 resulting in the chord 586 at the tip 516 being twisted downwards relative to the chord 586 at the root 558.

### 7.2 Propellor Transitioner—Location, Geometry and Orientation FIG. 16A-16G

Referring now to FIGS. 16A and 16B, in an embodiment, a transitioner 700 is located on and adjacent to the leading edge 568 of each blade 511 and extends over at least a part of the span of the blade 511.

Referring now to FIG. 16C, in an embodiment, transitioner 700 has a leading edge 708, trailing edge 712, suction surface 704, pressure surface 706, hub end 714 and tip end 718 and which define an airfoil profile with the suction surface 704 (or surface facing towards the intended direction of travel) generally oriented perpendicular to the oncoming fluid flow 1 and the pressure surface 706 facing away from fluid flow 1.

Tip end 718 of transitioner 700 may have a different shape than propellor tip 516 to which it is adjacent as shown in FIG. 16D, or have a different shape, including, without limitation, as shown in FIG. 15A.

Suction surface 704 and pressure surface 706 of transitioner 700 may each have at least a portion with a straight, convex, concave, or a combination thereof shape in a chordwise direction.

Referring now to FIG. 16D, transitioner 700 may have a twist along its spanwise length 554 (see FIG. 15B) that is the same as or different than the twist, if any, of propellor blade 511.

Referring now to FIGS. 16E-16G showing various profiles of an assembly comprising a flow transitioner 700 attached to a propellor blade (a primary propellor blade or primary foil) 511, in an embodiment, trailing end 712 of transitioner 700 is V-shaped to conform to a V-shaped leading edge area of the propellor blade. Trailing end 712 may have any other shape conforming to a shape of the leading edge area of the propellor blade, or may have other shapes not conforming to the leading edge area of the propellor blade.

In other embodiments, propellor blade transitioner chord 724 angle may be more aligned with apparent velocity 6 over at least a portion of the spanwise distance 554 (see FIG. 15B) of propellor blade 511 than is the propellor blade chord 586 angle (see FIGS. 16E-16G) when a transitioner is positioned over a portion of the propellor blade's span, e.g., the transitioner 700 ending prior to a tip 516 (See FIG. 15A) or is otherwise positioned over less than the entire propellor blade's span.

FIG. 16H shows reference measurements 519, 719 and 592 that define a configuration of a profile of propellor blade assembly 511 benefitted by a transitioner 700. Reference measurement 719 is a leading edge diameter (or radius) of a nose circle defining a leading edge 704 of transitioner 700, the magnitude of which may be characterized as a fraction or percentage of propellor blade 511 nose circle diameter 519 and propellor blade maximum thickness 592.

CFD analysis to date demonstrates that improvement in the lift-to-drag ratio over propellor blade 511 occurs when a propellor blade benefitted by a transitioner, such as transitioner assembly 700, has a transitioner profile shape located nearest the root 558 (see FIG. 16G) defined by the relationship between the transitioner chord length 724 as a percentage of the propellor blade chord length 586, or transitioner nose circle diameter 719 as percentage of the propellor blade nose circle diameter 519, or the transitioner nose circle diameter 719 as a percentage of the propellor blade maximum thickness 592 falling within the ranges that follow.

Transitioner chord 724 at the propellor blade root end 558 (see FIG. 15B) may be 2% to 18%, 3% to 17%, 3.5% to 16%, or 4% to 15% percent of the propellor blade chord 586.

Transitioner nose circle diameter 719 may be 1% to 50%, 3% to 45%, 5% to 40%, or 7% to 35% of propellor blade nose circle diameter 519, or transitioner nose circle diameter 719 may be 5% to 55%, 6% to 52.5%, 6.5% to 50%, or 7% to 47.5% of propellor blade maximum thickness 592.

Ranges of reference measurement values and locations listed herein are for a transitioner 700 profile coupled to a propellor blade 511 profile located at the tip end 558 (as defined in Subsection 6.6) of the propellor blade 511 (see FIG. 15B) or any location along the span.

Transitioner chord lines 724-A, 724-B, 724-C are more aligned with the apparent velocity 6 than propellor chord lines 586-A, 586-B, 586-C, respectively. For example, the propellor chord 586-C is at a 1.6 degree angle relative to apparent velocity 6, as compared to transitioner chord 724-C which is at a 8.5 degree angular difference relative to apparent velocity 6 (see FIG. 16G).

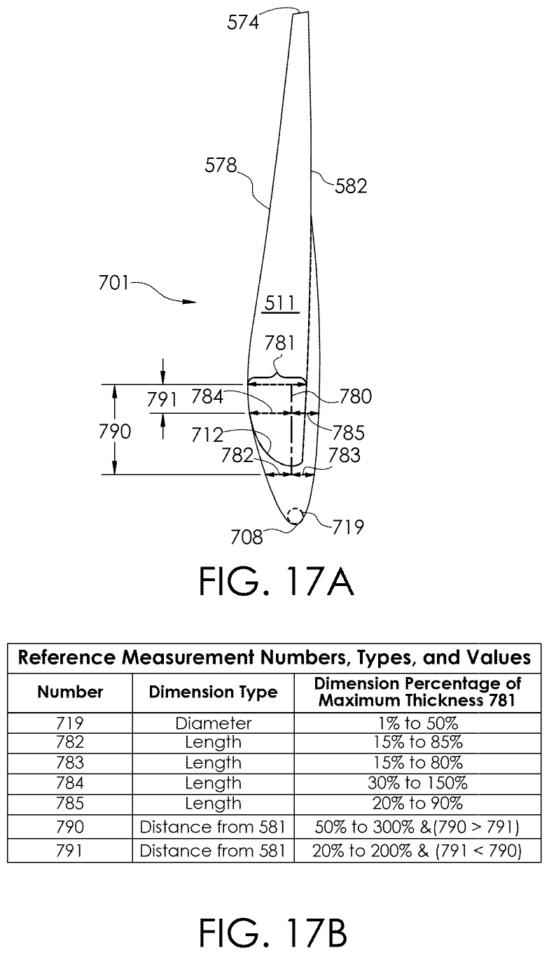

### 7.3 Integrated Propellor Transitioner—FIGS. 17A-17-B

In an embodiment, any flow transitioner may be integrated into the design of a propellor blade or other foil (“integrated transitioner”), as opposed to being fixedly linked to an existing propellor blade or foil. An integrated transitioner may include any aspects of a fixedly linked transitioner, including, without limitation, its geometry and geometric relationships as described in Section 2, and alternate embodiments described in Subsections 4.1-4.5. This Subsection describes integrating a fixed (non-variable) flow transitioner into a propellor blade design at the time of design and/or manufacture.

FIG. 17A shows a profile of a propellor blade 511 superimposed within a propellor blade assembly 701 having a leading edge 708, a trailing edge 574, a suction (upstream) surface 578 and a pressure (downstream) surface 582. A phantom line 712 depicts where transitioner trailing end 712 would have been if the transitioner was fixedly linked to, rather than integrated with, the leading edge area of propellor blade 511, for example, as shown in FIG. 16G. That is, phantom line 712 shows the profile of propellor blade 511 without a transitioner.

FIG. 17A also shows reference measurements 719, 782, 784, 783, 785 that define a configuration of a profile of propellor blade assembly 701. Reference measurement 719 is a leading edge diameter (or radius) of a nose circle defining a leading edge 708 of propellor blade assembly 701, the magnitude of which may be characterized as a fraction or percentage of a maximum thickness 781 between suction surface 578 and pressure surface 582. Reference measurement 784 is a length between suction surface 578 and a datum line 780 at a vertical location 791 relative to maximum thickness line 781. Datum line 780 is perpendicular to maximum thickness line 781 and intersects line 781 at its midpoint. Reference measurement 782 is a length between suction surface 578 and datum line 780 at a vertical location 790 relative to maximum thickness line 781. Reference measurement 785 is a length between pressure surface 582 and datum line 780 at horizontal location 791 relative to maximum thickness line 781. Reference measurement 783 is a length between pressure surface 582 and datum line 780 at vertical location 790 relative to maximum thickness line 781. Reference measurements 782, 784, 783, 785 and locations 790 and 791 may be characterized as fractions or percentages of maximum thickness 781.

FIG. 17B is a table listing ranges of values of reference measurements 719, 782, 784, 783, 785 and locations 790 and 791. CFD analysis to date demonstrates that improvement in the lift-to-drag ratio over propellor blade 511 occurs when a propellor blade with an integrated transitioner, such as propellor blade assembly 701, has a profile shape defined by reference measurements 719, 782, 784, 783, 785 falling within the ranges listed in FIG. 17B.

Leading edge diameter 719 may be 1% to 50%, 3% to 45%, 5% to 40%, or 7% to 35% of maximum thickness 781. Location 791 may be 20% to 200%, 30% to 190%, 40% to 185%, or 50% to 180% of maximum thickness 781. Location 790 may be 50% to 300%, 60% to 290%, 70% to 285%, or 80% to 280% of maximum thickness 781. Reference measurement 782 may be 15% to 85%, 17% to 80%, 19% to 75%, or 21% to 70% of maximum thickness 781. Reference measurement 783 may be 15% to 80%, 17% to 75%, 19% to 70%, or 21% to 65% of maximum thickness 781. Reference measurement 784 may be 30% to 150%, 32% to 145%, 34% to 140%, or 36% to 135% of maximum thickness 781. Reference measurement 785 may be 20% to 90%, 22% to 85%, 24% to 80%, or 26% to 75% of maximum thickness 781.

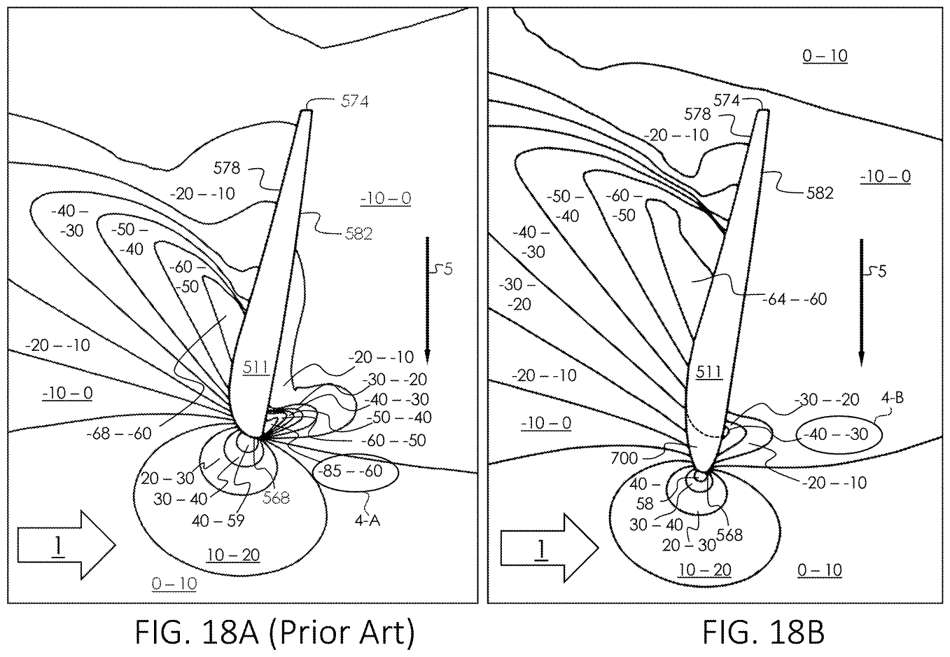

### 7.4 Flow Trajectories and Pressures—FIGS. 18A-18B

The plots shown around blade and transitioner profiles in the Figures referenced in this Subsection are from CFD analysis studies near the blade tip. Pressure measurements are shown in kilopascals around the pressure and suction surfaces of propellor 511 of FIG. 15A-Detail C and transitioner 700 rotating at 4,000 RPM.

Referring now to FIGS. 18A-18B, FIG. 18A is a side view of a pressure plot around the surfaces of the propellor 511 as described above, and FIG. 18B is a side view of a pressure plot around the propellor and transitioner surfaces of the transitioner/blade assembly of FIG. 16G.

Performance improvements are seen when comparing the two pressure plots. For example, FIG. 18A shows a low pressure of −85 kPa in the oval 4A on the blade not benefitted by the transitioner 700, and a low pressure of −40 in the oval 4B on the blade benefitted by transitioner 700, a 53 percent improvement. A similar improvement is seen in the adjacent area on the pressure surface in the adjacent regions and approximately halfway down the chord length. It should be noted that the largest improvement is occurring between the tip and mid-chord where the propeller has the largest moment arm.

### COMBINATIONS OF ELEMENTS AND COMPONENTS

All possible combinations of elements and components described in the specification are contemplated and considered to be part of this disclosure. It should be appreciated that all combinations of the concepts and additional concepts discussed in greater detail herein (provided such concepts are not mutually inconsistent) are contemplated as being part of the inventive subject matter described herein.

1. A wing assembly comprising:
a primary wing, wherein the primary wing has a primary suction surface, a primary pressure surface, a primary leading edge defined by a primary leading edge circle, a primary trailing edge, and a primary chord line extending from the primary leading edge to the primary trailing edge; and
a flow transitioner positioned over the primary leading edge, wherein the flow transitioner comprises:
a transitioner leading edge defined by a transitioner leading edge circle;
a transitioner chord line extending from the transitioner leading edge to the primary leading edge, wherein the primary chord line and the transitioner chord line are oriented at different angles, such that the transitioner chord line has a lower angle of attack than the primary chord line;
a transitioner suction surface extending from the transitioner leading edge to a suction surface trailing edge defining a transition at which the transitioner suction surface is attached to the primary suction surface; and
a transitioner pressure surface extending from the transitioner leading edge to a pressure surface trailing edge defining a transition at which the transitioner pressure surface is attached to the primary pressure surface, wherein the transitioner leading edge is positioned forward of the primary leading edge, and wherein, at a particular spanwise position of the assembly:
(1) a diameter of the transitioner leading edge circle is 1% to 70% of a diameter of the primary leading edge circle, or
(2) the diameter of the transitioner leading edge circle is 5% to 55% of a maximum thickness between the primary suction surface and the primary pressure surface, or
(3) a length of the transitioner chord line is 5% to 18% of a length of the primary chord line.

2. The wing assembly of claim 1, wherein the particular spanwise position is a root of the assembly.

3. The wing assembly of claim 1, wherein the flow transitioner has a trailing end extending between the suction surface trailing edge and the pressure surface trailing edge, wherein a curvature of the trailing end conforms to a curvature of the primary leading edge.

4. The wing assembly of claim 1, wherein the primary wing comprises one of an airfoil and a hydrofoil.

5. The wing assembly of claim 1, wherein the primary wing comprises one of a wing, a stabilizer, and a tail.

6. The wing assembly of claim 1, wherein an angle of the transitioner chord line with respect to the primary chord line is fixed, or the angle of the transitioner chord line with respect to the primary chord line is variable.

7. The wing assembly of claim 1, wherein the flow transitioner is configured to direct additional fluid flow over the primary suction surface or to direct additional fluid flow over the primary pressure surface compared to a primary wing without the flow transitioner.

8. The wing assembly of claim 1, wherein the flow transitioner comprises a transitioner skin attached to the primary suction surface aft of the primary leading edge and attached to the primary pressure surface aft of the primary leading edge.

9. The wing assembly of claim 8, further comprising a seal to provide a water tight and air tight seal between the transitioner skin and the primary suction surface and between the transitioner skin and the primary pressure surface, wherein the seal comprises:
an upper seal located between the transitioner skin and an upper wing rib flange and between a wing skin of the primary suction surface and the upper wing rib flange;
an upper seal plate, wherein the upper seal is captured between the upper seal plate and the transitioner skin and the wing skin of the primary suction surface;
a lower seal located between the transitioner skin and a lower wing rib flange and between a wing skin of the primary pressure surface and the lower wing rib flange; and
a lower seal plate, wherein the lower seal is captured between the lower seal plate and the transitioner skin and the wing skin of the primary pressure surface.

10. A flow transitioner configured to be coupled with a primary wing, wherein the primary wing has a primary suction surface, a primary pressure surface, a primary leading edge defined by a primary leading edge circle, a primary trailing edge, and a primary chord line extending from the primary leading edge to the primary trailing edge, wherein the flow transitioner comprises:
a transitioner leading edge defined by a transitioner leading edge circle;
a transitioner chord line extending from the transitioner leading edge to the primary leading edge, wherein the primary chord line and the transitioner chord line are oriented at different angles, such that the transitioner chord line has a lower angle of attack than the primary chord line;
a transitioner suction surface extending from the transitioner leading edge to a suction surface trailing edge defining a transition at which the transitioner suction surface is attached to the primary suction surface; and
a transitioner pressure surface extending from the transitioner leading edge to a pressure surface trailing edge defining a transition at which the transitioner pressure surface is attached to the primary pressure surface, wherein the transitioner leading edge is positioned forward of the primary leading edge, and wherein, at a particular spanwise position of the flow transitioner:
(1) a diameter of the transitioner leading edge circle is 1% to 70% of a diameter of the primary leading edge circle, or
(2) the diameter of the transitioner leading edge circle is 5% to 55% of a maximum thickness between the primary suction surface and the primary pressure surface, or
(3) a length of the transitioner chord line is 5% to 18% of a length of the primary chord line.

11. The flow transitioner of claim 10, wherein the particular spanwise position is a root of the flow transitioner.

12. The flow transitioner of claim 10, wherein the flow transitioner has a concave trailing end extending between the suction surface trailing edge and the pressure surface trailing edge, wherein a curvature of the trailing end conforms to a curvature of the primary leading edge.

13. The flow transitioner of claim 10, wherein the primary wing comprises one of an airfoil and a hydrofoil.

14. The flow transitioner of claim 10, wherein the primary wing comprises one of a wing, a stabilizer, a tail, an aircraft propellor blade, a watercraft propellor blade, a wind turbine blade, a hydro turbine blade, a fan blade, and a compressor blade.

15. The flow transitioner of claim 10, wherein an angle of the transitioner chord line with respect to the primary chord line is fixed, or the angle of the transitioner chord line with respect to the primary chord line is variable.

16. The flow transitioner of claim 10, wherein the flow transitioner is configured to direct additional fluid flow over the primary suction surface or direct additional fluid flow over the primary pressure surface compared to a primary wing without the flow transitioner.

17. The flow transitioner of claim 10, further comprising a transitioner skin attached to the primary suction surface aft of the primary leading edge and attached to the primary pressure surface aft of the primary leading edge.

18. The flow transitioner of claim 17, further comprising a seal to provide a water tight and air tight seal between the transitioner skin and the primary suction surface and between the transitioner skin and the primary pressure surface, wherein the seal comprises:
an upper seal located between the transitioner skin and an upper wing rib flange and between a wing skin of the primary suction surface and the upper wing rib flange;
an upper seal plate, wherein the upper seal is captured between the upper seal plate and the transitioner skin and the wing skin of the primary suction surface;
a lower seal located between the transitioner skin and a lower wing rib flange and between a wing skin of the primary pressure surface and the lower wing rib flange; and
a lower seal plate, wherein the lower seal is captured between the lower seal plate and the transitioner skin and the wing skin of the primary pressure surface.
